(19) United States
(12) Patent Application Publication
(10) Pub. No.: US 2025/0303702 A1
(43) Pub. Date: Oct. 2, 2025

(54) Head Unit And Liquid Ejection Apparatus

(71) Applicant: SEIKO EPSON CORPORATION, Tokyo (JP)

(72) Inventors: Ryuji FUJITA, Shiojiri (JP); Toru KASHIMURA, Shiojiri (JP)

(21) Appl. No.: 19/091,987

(22) Filed: Mar. 27, 2025

(30) Foreign Application Priority Data
Mar. 28, 2024 (JP) 2024-053375

(51) Int. Cl. B41J 2/045; B41J 2/155

(52) U.S. Cl. CPC B41J 2/0457; B41J 2/04548; B41J 2/0455; B41J 2/04573; B41J 2/04581; B41J 2/04588; B41J 2/155; B41J 2202/21

(57) ABSTRACT

A head unit includes an ejection unit configured to eject a liquid in accordance with a drive signal, and a drive unit supplied with a power supply voltage from outside and configured to output the drive signal, wherein the drive unit includes a first step-down circuit configured to step down the power supply voltage to output a first drive voltage, a second step-down circuit configured to step down the power supply voltage to output a second drive voltage, an output circuit supplied with the first drive voltage and configured to output the drive signal according to the first drive voltage, and a drive control circuit supplied with the second drive voltage and configured to control drive of the output circuit in accordance with the second drive voltage.

The present application is based on, and claims priority from JP Application Serial Number 2024-053375, filed Mar. 28, 2024, the disclosure of which is hereby incorporated by reference herein in its entirety.

### BACKGROUND

### 1. Technical Field

The present disclosure relates to a head unit and a liquid ejection apparatus.

### 2. Related Art

As a liquid ejection apparatus that ejects a liquid to form a document or an image on a medium, there is known a liquid ejection apparatus using a piezoelectric element. The piezoelectric element is provided so as to correspond to each of a plurality of ejection parts in a print head. Further, by the piezoelectric element being driven in accordance with a drive signal, a corresponding amount of liquid to drive of the piezoelectric element is ejected from the ejection part corresponding thereto, and a dot is formed on the medium.

For example, JP-A-2022-087511 discloses a liquid ejection apparatus that ejects a liquid by driving a piezoelectric element.

JP-A-2022-087511 is an example of the related art.

However, in the liquid ejection apparatus described in JP-A-2022-087511, there is a possibility that the ejection accuracy of the liquid deteriorates with growth in size of the apparatus, and there is room for improvement.

### SUMMARY

An aspect of a head unit according to the present disclosure includes:
an ejection unit configured to eject a liquid in accordance with a drive signal; and
a drive unit supplied with a power supply voltage from outside and configured to output the drive signal, wherein
the drive unit includes
a first step-down circuit configured to step down the power supply voltage to output a first drive voltage,
a second step-down circuit configured to step down the power supply voltage to output a second drive voltage,
an output circuit supplied with the first drive voltage and configured to output the drive signal according to the first drive voltage, and
a drive control circuit supplied with the second drive voltage and configured to control drive of the output circuit in accordance with the second drive voltage.

A liquid ejection apparatus according to the present disclosure includes:
a conveyance unit configured to convey a medium;
an ejection unit configured to eject a liquid to the medium in accordance with a drive signal; and
a drive unit supplied with a power supply voltage generated from a commercial AC voltage signal and configured to output the drive signal, wherein
the drive unit includes
a first step-down circuit configured to step down the power supply voltage to output a first drive voltage,
a second step-down circuit configured to step down the power supply voltage to output a second drive voltage,
an output circuit supplied with the first drive voltage and configured to output the drive signal according to the first drive voltage, and
a drive control circuit supplied with the second drive voltage and configured to control drive of the output circuit in accordance with the second drive voltage.

### BRIEF DESCRIPTION OF THE DRAWINGS

FIG. 1 is a diagram showing a schematic configuration of a liquid ejection apparatus.

FIG. 2 is a diagram illustrating a schematic configuration of a head unit.

FIG. 3 is a diagram showing an example of signal waveforms of drive signals COMA, COMB, and COMC.

FIG. 4 is a diagram showing a functional configuration of a drive signal selection circuit.

FIG. 5 is a diagram illustrating an example of decoded contents in a decoder.

FIG. 6 is a diagram illustrating an example of a configuration of a selection circuit corresponding to one ejection part.

FIG. 7 is a diagram illustrating an operation of the drive signal selection circuit.

FIG. 8 is a diagram showing an example of a configuration of a drive circuit.

FIG. 9 is a diagram illustrating an example of a configuration of a drive signal discharge circuit.

FIG. 10 is a diagram illustrating an example of a configuration of a reference voltage signal output circuit.

FIG. 11 is a diagram showing an example of a configuration of a VHV control signal output circuit.

FIG. 12 is a diagram illustrating a configuration of a state signal input-output circuit.

FIG. 13 is a diagram illustrating a configuration of an abnormality signal input-output circuit.

FIG. 14 is a diagram showing an example of a configuration of a step-down circuit.

FIG. 15 is a diagram showing an example of a configuration of a first step-down circuit.

FIG. 16 is a diagram illustrating a structure of an ejection unit.

FIG. 17 is a diagram showing an example of a structure of a print head.

FIG. 18 is a diagram showing an example of a cross-sectional surface of the print head.

FIG. 19 is a diagram showing a structure of a drive unit.

FIG. 20 is a diagram illustrating an example of a structure of a drive circuit module.

FIG. 21 is a diagram showing an example of a cross-sectional structure of a head substrate.

FIG. 22 is a diagram illustrating an example of an arrangement of a plurality of electronic components mounted on the head substrate.

FIG. 23 is a diagram showing an example of wiring patterns which propagate drive signals COMA1 to COMA6, and are formed on the head substrate.

FIG. 24 is a diagram showing an example of wiring patterns which propagate drive signals COMB1 to COMB6, and are formed on the head substrate.

FIG. 25 is a diagram showing an example of wiring patterns which propagate drive signals COMC1 to COMC6 and reference voltage signals VBS1 to VBS3, and are formed on the head substrate.

FIG. 26 is a diagram showing an example of wiring patterns which propagate reference voltage signals VBS4 to VBS6, and are formed on the head substrate.

### DESCRIPTION OF EMBODIMENTS

A preferred embodiment of the present disclosure will hereinafter be described using the drawings. The drawings to be used are for the sake of convenience of explanation. Note that the embodiment described below does not unreasonably limit the content of the present disclosure set forth in the appended claims. Further, it is not necessarily true that all the configurations to be described below are essential elements of the present disclosure.

### 1. Configuration Of Liquid Ejection Apparatus

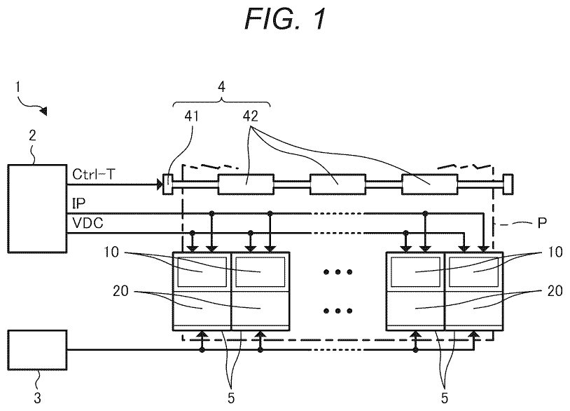

FIG. 1 is a diagram showing a schematic configuration of a liquid ejection apparatus 1. As shown in FIG. 1, the liquid ejection apparatus 1 is a so-called line type inkjet printer that ejects ink at desired timings to a medium P conveyed by a conveyance unit 4 to thereby form a desired image on the medium P. Here, in the following description, the direction in which the medium P is conveyed is referred to as a conveyance direction, and the width direction of the medium P thus conveyed is referred to as a main scanning direction in some cases.

As shown in FIG. 1, the liquid ejection apparatus 1 includes a control unit 2, a liquid container 3, the conveyance unit 4, and a plurality of head units 5.

The control unit 2 includes an AC-to-DC converter, and a commercial AC voltage signal is input thereto from the outside of the liquid ejection apparatus 1. Then the AC-to-DC converter provided to the control unit 2 converts the commercial AC voltage signal input thereto to generate a voltage signal VDC as a DC voltage signal having a predetermined voltage value such as 48 V, and then supplies the voltage signal VDC to each element provided to the liquid ejection apparatus 1. Further, the control unit 2 includes a processing circuit such as a central processing unit (CPU) or a field programmable gate array (FPGA), and a storage circuit such as a semiconductor memory device. Further, the processing circuit provided to the control unit 2 outputs a control signal for controlling each element of the liquid ejection apparatus 1 based on image data input from an external apparatus such as a host computer not shown disposed outside the liquid ejection apparatus 1.

The liquid container 3 retains ink as an example of a liquid supplied to the head units 5. Specifically, the liquid container 3 retains a plurality of colors of ink to be ejected to the medium P, such as black ink, cyan ink, magenta ink, yellow ink, red ink, and gray ink.

The conveyance unit 4 includes a conveyance motor 41 and conveyance rollers 42. A conveyance control signal Ctrl-T output by the control unit 2 is input to the conveyance unit 4. The conveyance motor 41 is driven based on the conveyance control signal Ctrl-T input thereto, and the conveyance rollers 42 rotate due to the drive of the conveyance motor 41. Due to the rotation of the conveyance rollers 42, the medium P is conveyed along a conveyance direction.

The plurality of head units 5 is electrically coupled to the control unit 2 via cables having flexibility such as a flexible flat cable (FFC). Such cables having flexibility such as the FFC for electrically coupling the control unit 2 and the head units 5 may be 2 m or more. Further, each of the plurality of head units 5 includes a drive unit 10 and an ejection unit 20. The voltage signal VDC and an image information signal IP output by the control unit 2 are input to the head unit 5 via the FFC described above, and the ink retained in the liquid container 3 is supplied to the head unit 5 via an ink tube not shown. The head unit 5 operates with the voltage signal VDC as drive power. Then, the drive unit 10 controls the operation of the ejection unit 20 based on the image information signal IP, and the ejection unit 20 ejects the ink supplied from the liquid container 3 to the medium P in accordance with the control of the drive unit 10.

Here, in the liquid ejection apparatus 1 according to the present embodiment, the ejection units 20 respectively provided to the plurality of head units 5 are arranged side by side along the main scanning direction so as to be equal to or longer than the width of the medium P. Thus, it becomes possible for the ejection unit 20 to eject the ink to the entire area in the width direction of the medium P conveyed. That is, the liquid ejection apparatus 1 according to the present embodiment constitutes a so-called line type inkjet printer that forms a desired image on the medium P by each of the plurality of ejection units 20 arranged side by side so as to be equal to or longer than the width of the medium P ejecting the ink along with the conveyance of the medium P. Note that the liquid ejection apparatus 1 is not limited to the line type inkjet printer, and may be a so-called serial type inkjet printer in which a desired image is formed on the medium P by the ejection units 20 reciprocating along the main scanning direction as the width direction of the medium P, and ejecting the ink onto the medium P conveyed in synchronization with the reciprocation.

### 2. Functional Configuration of Head Unit

### 2.1 Functional Configuration of Head Unit

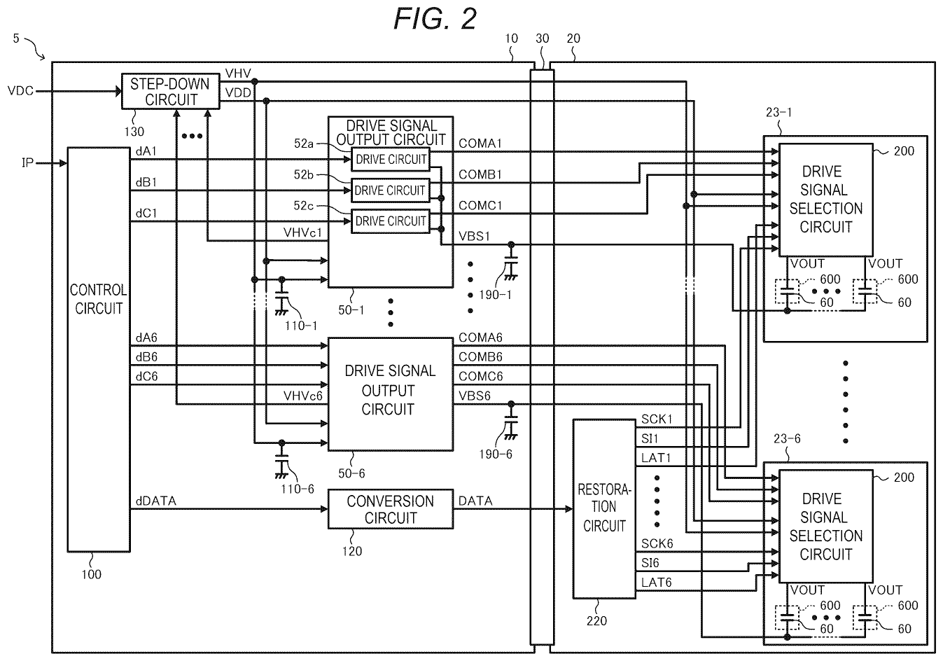

Then, a schematic configuration of the head unit 5 will be described. Here, the plurality of head units 5 provided to the liquid ejection apparatus 1 is substantially the same in configuration. Therefore, in the following description, only the configuration of one of the head units 5 will be described. FIG. 2 is a diagram illustrating a schematic configuration of the head unit 5. As shown in FIG. 2, the head unit 5 includes the drive unit 10 and the ejection unit 20. Further, in the head unit 5, the drive unit 10 and the ejection unit 20 are electrically coupled via a coupling member 30.

The coupling member 30 is a member for electrically coupling the drive unit 10 and the ejection unit 20 to each other, and flexible printed circuits (FPC) or an FFC can be used as the coupling member 30. Note that as the coupling member 30, a BtoB (Board to Board) connector may be used instead of the FPC or the FFC, or a configuration in which both the BtoB connector and the FPC or the FFC are used in combination may be adopted.

The drive unit 10 includes a control circuit 100, drive signal output circuits 50-1 to 50-6, a conversion circuit 120, a step-down circuit 130, and capacitors 110-1 to 110-6, 190-1 to 190-6.

The step-down control signals VHVc1 to VHVc6 and the voltage signal VDC are input to the step-down circuit 130. That is, the voltage signal VDC is supplied to the drive unit 10 via a cable electrically coupled to the control unit 2. The step-down circuit 130 steps down a voltage of the voltage signal VDC that is a DC voltage having a voltage value of 48 V and is input to the step-down circuit 130, generates a plurality of DC voltage signals including a voltage signal VHV having a voltage value constant at 42 V and a voltage signal VDD having a voltage value constant at 5 V, and then outputs the DC voltage signals thus generated to the respective components provided to the head unit 5. On this occasion, the step-down circuit 130 operates based on the logic levels of the step-down control signals VHVc1 to VHVc6 to thereby switch whether to output the voltage signal VHV obtained by stepping down the voltage of the voltage signal VDC input thereto. Note that a specific example of the configuration and the operation of the step-down circuit 130 will be described later.

The control circuit 100 includes a processing circuit such as a CPU or an FPGA and a storage circuit such as a semiconductor memory device. The image information signal IP output by the control unit 2 is input to the control circuit 100. The control circuit 100 outputs a signal for controlling each element of the head unit 5 based on the image information signal IP input thereto.

The control circuit 100 generates a base data signal dDATA for controlling the operation of the ejection unit 20 based on the image information signal IP, and then outputs the base data signal dDATA to the conversion circuit 120. The conversion circuit 120 converts the base data signal dDATA into a differential signal such as low voltage differential signaling (LVDS), and then outputs the differential signal as a data signal DATA to the ejection unit 20. Note that the conversion circuit 120 may convert the base data signal dDATA into a differential signal of a high-speed transfer system such as low voltage positive emitter coupled logic (LVPECL) or current mode logic (CML) other than LVDS, and then output the differential signal to the ejection unit 20 as the data signal DATA. Further, the conversion circuit 120 may convert a part or whole of the base data signal dDATA input thereto into a predetermined single-ended signal, and then output the signal to the ejection unit 20 as the data signal DATA.

Further, the control circuit 100 outputs the base drive data signals dA1, dB1, and dC1 to the drive signal output circuit 50-1. Further, the voltage signals VHV, VDD are input to the drive signal output circuit 50-1. The drive signal output circuit 50-1 includes drive circuits 52a, 52b, and 52c. The base drive data signal dA1 is input to the drive circuit 52a provided to the drive signal output circuit 50-1. The drive circuit 52a provided to the drive signal output circuit 50-1 operates based on the voltage signal VDD, performs a digital-to-analog conversion on the base drive data signal dA1 input thereto, then performs D-class amplification on the signal obtained by the conversion based on the voltage signal VHV to thereby generate a drive signal COMA1, and then outputs the drive signal COMA1 to the ejection unit 20. The base drive data signal dB1 is input to the drive circuit 52b provided to the drive signal output circuit 50-1. The drive circuit 52b provided to the drive signal output circuit 50-1 operates based on the voltage signal VDD, performs a digital-to-analog conversion on the base drive data signal dB1 input thereto, then performs the D-class amplification on the signal obtained by the conversion based on the voltage signal VHV to thereby generate a drive signal COMB1, and then outputs the drive signal COMB1 to the ejection unit 20. The base drive data signal dC1 is input to the drive circuit 52c provided to the drive signal output circuit 50-1. The drive circuit 52c provided to the drive signal output circuit 50-1 operates based on the voltage signal VDD, performs a digital-to-analog conversion on the base drive data signal dC1 input thereto, then performs the D-class amplification on the signal obtained by the conversion based on the voltage signal VHV to thereby generate a drive signal COMC1, and then outputs the drive signal COMC1 to the ejection unit 20. That is, the drive signal output circuit 50-1 generates the drive signals COMA1, COMB1, and COMC1 having signal waveforms corresponding to the base drive data signals dA1, dB1, and dC1 input thereto, and then outputs the drive signals COMA1, COMB1, and COMC1 to the ejection unit 20.

Further, each of the drive circuits 52a, 52b, and 52c provided to the drive signal output circuit 50-1 generates a reference voltage signal VBS1 having a voltage value constant at 5.5 V, 6 V, or the like. The reference voltage signal VBS1 generated by each of the drive circuits 52a, 52b, and 52c provided to the drive signal output circuit 50-1 propagates through a common line and is output from the drive signal output circuit 50-1 to the ejection unit 20. Note that the drive signal output circuit 50-1 may output the reference voltage signal VBS1, which is output from any one of the drive circuits 52a, 52b, and 52c, to the ejection unit 20. Further, the reference voltage signal VBS1 may be generated by a power supply circuit (not shown) configured separately from the drive circuits 52a, 52b, and 52c.

Further, the control circuit 100 outputs the drive data signals dAi, dBi, and dCi to the drive signal output circuit 50-i (i is any one of 2 to 6). Further, the voltage signals VHV, VDD are input to the drive signal output circuit 50-i. The drive signal output circuit 50-i includes drive circuits 52a, 52b, and 52c. The base drive data signal dAi is input to the drive circuit 52a provided to the drive signal output circuit 50-i. The drive circuit 52a provided to the drive signal output circuit 50-i operates based on the voltage signal VDD, performs a digital-to-analog conversion on the base drive data signal dai input thereto, then performs D-class amplification on the signal obtained by the conversion based on the voltage signal VHV to thereby generate a drive signal COMAi, and then outputs the drive signal COMAi to the ejection unit 20. The base drive data signal dBi is input to the drive circuit 52b provided to the drive signal output circuit 50-i. The drive circuit 52b provided to the drive signal output circuit 50-i operates based on the voltage signal VDD, performs a digital-to-analog conversion on the base drive data signal dBi input thereto, then performs D-class amplification on the signal obtained by the conversion based on the voltage signal VHV to thereby generate a drive signal COMBi, and then outputs the drive signal COMBi to the ejection unit 20. The drive data signal dCi is input to the drive circuit 52c provided to the drive signal output circuit 50-1. The drive circuit 52c provided to the drive signal output circuit 50-i operates based on the voltage signal VDD, performs a digital-to-analog conversion on the base drive data signal dCi input thereto, then performs D-class amplification on the signal obtained by the conversion based on the voltage signal VHV to thereby generate a drive signal COMCi, and then outputs the drive signal COMCi to the ejection unit 20. That is, the drive signal output circuit 50-i generates the drive signals COMAi, COMBi, and COMCi having signal waveforms corresponding to the base drive data signals dAi, dBi, and dCi input thereto, and then outputs the drive signals COMAi, COMBi, and COMCi to the ejection unit 20.

Further, each of the drive circuits 52a, 52b, and 52c provided to the drive signal output circuit 50-i generates a reference voltage signal VBSi having a voltage value constant at 5.5 V, 6 V, or the like. The reference voltage signal VBSi generated by each of the drive circuits 52a, 52b, and 52c provided to the drive signal output circuit 50-i propagates through a common line and is output from the drive signal output circuit 50-i to the ejection unit 20. Note that the drive signal output circuit 50-i may output the reference voltage signal VBSi, which is output from any one of the drive circuits 52a, 52b, and 52c, to the ejection unit 20. Further, the reference voltage signal VBSi may be generated by a power supply circuit (not shown) configured separately from the drive circuits 52a, 52b, and 52c.

Further, the drive signal output circuit 50-1 generates the step-down control signal VHVc1 and then outputs the step-down control signal VHVc1 to the step-down circuit 130. The step-down control signal VHVc1 is generated by each of the drive circuits 52a, 52b, and 52c provided to the drive signal output circuit 50-1. Then, the drive signal output circuit 50-1 propagates the step-down control signal VHVc1 generated by each of the drive circuits 52a, 52b, and 52c via a common wiring line to supply the step-down control signal VHVc1 to the step-down circuit 130. Note that the drive signal output circuit 50-1 may output the step-down control signal VHVc1 generated by any one of the drive circuits 52a, 52b, and 52c from the drive signal output circuit 50-1 to supply the step-down control signal VHVc1 to the step-down circuit 130. Similarly, the drive signal output circuit 50-i generates the step-down control signal VHVci and then outputs the step-down control signal VHVci to the step-down circuit 130. The step-down control signal VHVci is generated by each of the drive circuits 52a, 52b, and 52c provided to the drive signal output circuit 50-i. Then, the drive signal output circuit 50-i propagates the step-down control signal VHVci generated by each of the drive circuits 52a, 52b, and 52c via a common wiring line to supply the step-down control signal VHVci to the step-down circuit 130. Note that the drive signal output circuit 50-i may output the step-down control signal VHVci generated by any one of the drive circuits 52a, 52b, and 52c from the drive signal output circuit 50-i to supply the step-down control signal VHVc1 to the step-down circuit 130.

Here, the drive signal output circuit 50-1 and the drive signal output circuits 50-2 to 50-6 are substantially the same in configuration, and may be simply referred to as the drive signal output circuit 50 in some cases when there is no need to distinguish the drive signal output circuits from each other. In this case, the description will be presented assuming that the drive signal output circuit 50 includes the drive circuits 52a, 52b, and 52c, the drive circuit 52a outputs the drive signal COMA, the drive circuit 52b outputs the drive signal COMB, and the drive circuit 52c outputs the drive signal COMC. Further, the drive circuits 52a, 52b, and 52c provided to the drive signal output circuit 50 are substantially the same in configuration, and may simply be referred to as the drive circuit 52 in some cases when there is no need to distinguish the drive circuits from each other. In this case, the description will be presented assuming that the drive circuit 52 generates the drive signal COM based on the base drive data signal do, and outputs the drive signal COM thus generated to the ejection unit 20.

On the other hand, when the drive circuits 52a, 52b, and 52c provided to the drive signal output circuit 50-1 and the drive circuits 52a, 52b, and 52c provided to the drive signal output circuit 50-i are distinctly described, the drive circuits 52a, 52b, and 52c provided to the drive signal output circuit 50-1 may respectively be referred to as drive circuits 52a1, 52b1, and 52cl, and the drive circuits 52a, 52b, and 52c provided to the drive signal output circuit 50-i may respectively be referred to as drive circuits 52ai, 52bi, and 52ci in some cases. Note that a specific example of the configuration of the drive circuit 52 will be described later.

One end of the capacitor 110-1 is electrically coupled to a propagation path of the voltage signal VHV supplied to the drive signal output circuit 50-1, and a ground signal at the ground potential is supplied to the other end of the capacitor 110-1. One end of the capacitor 110-i is electrically coupled to a propagation path of the voltage signal VHV supplied to the drive signal output circuit 50-i, and the ground signal is supplied to the other end of the capacitor 110-i. That is, the capacitors 110-1 to 110-6 function as stabilization capacitors that stabilize the voltage value of the voltage signal VHV supplied to the corresponding drive signal output circuits 50-1 to 50-6. Such capacitors 110-1 to 110-6 are elements each having a high capacitance, and electrolytic capacitors, for example, can be used. Note that in the following description, it is assumed that the capacitors 110-1 to 110-6 are electrolytic capacitors, but the capacitors 110-1 to 110-6 are only required to have the capacitances which are capable of stabilizing the voltage value of the voltage signal VHV, and at the same time, supplying sufficient currents to the respective drive signal output circuits 50-1 to 50-6, and may be ceramic capacitors or film capacitors. Further, the electrolytic capacitors as the capacitors 110-1 to 110-6 may be aluminum electrolytic capacitors or may also be tantalum electrolytic capacitors.

One end of the capacitor 190-1 is electrically coupled to a propagation path of the reference voltage signal VBS1 output by the drive signal output circuit 50-1, and the ground signal is supplied to the other end of the capacitor 190-1. One end of the capacitor 190-i is electrically coupled to a propagation path of the reference voltage signal VBSi output by the drive signal output circuit 50-i, and the ground signal is supplied to the other end of the capacitor 190-i. That is, the capacitors 190-1 to 190-6 function as stabilization capacitors that stabilize the voltage values of the reference voltage signals VBS1 to VBS6 output by the corresponding drive signal output circuits 50-1 to 50-6. Such capacitors 190-1 to 190-6 are elements each having a high capacitance, and electrolytic capacitors, for example, can be used. Note that in the following description, it is assumed that the capacitors 190-1 to 190-6 are electrolytic capacitors, but the capacitors 190-1 to 190-6 are only required to have the capacitances which are capable of stabilizing the voltage values of the reference voltage signals VBS1 to VBS6, and at the same time, supplying sufficient currents to piezoelectric elements 60 described later provided to the ejection units 20, and may be ceramic capacitors or film capacitors. Further, the electrolytic capacitors as the capacitors 190-1 to 190-6 may be aluminum electrolytic capacitors or may also be tantalum electrolytic capacitors.

That is, the drive unit 10 includes the capacitor 190-1 having one end as a positive terminal supplied with the reference voltage signal VBS1 and the other end as a negative terminal supplied with the ground signal, the capacitor 190-2 having one end as a positive terminal supplied with the reference voltage signal VBS2 and the other end as a negative terminal supplied with the ground signal, the capacitor 190-3 having one end as a positive terminal supplied with the reference voltage signal VBS3 and the other end as a negative terminal supplied with the ground signal, the capacitor 190-4 having one end as a positive terminal supplied with the reference voltage signal VBS4 and the other end as a negative terminal supplied with the ground signal, the capacitor 190-5 having one end as a positive terminal supplied with the reference voltage signal VBS5 and the other end as a negative terminal supplied with the ground signal, the capacitor 190-6 having one end as a positive terminal supplied with the reference voltage signal VBS6 and the other end as a negative terminal supplied with the ground signal, and the capacitors 110-1 to 110-6 each having one end as a positive terminal supplied with the voltage signal VHV and the other end as a negative terminal supplied with the ground signal.

The ejection unit 20 includes a restoration circuit 220 and print heads 23-1 to 23-6.

The data signal DATA is input to the restoration circuit 220. The restoration circuit 220 restores the data signal DATA as the differential signal input thereto to a single-ended signal, converts the single-ended signal thus restored into parallel signals corresponding respectively to the print heads 23-1 to 23-6, and then outputs the parallel signals respectively to the corresponding print heads 23-1 to 23-6.

Specifically, the restoration circuit 220 generates a clock signal SCK1, a print data signal SI1, and a latch signal LAT1 by restoring the data signal DATA and converting the data signal DATA into a parallel signal, and then outputs the clock signal SCK1, the print data signal SI1, and the latch signal LAT1 to the print head 23-1. Further, the restoration circuit 220 generates a clock signal SCKi, a print data signal SIi, and a latch signal LATi by restoring the data signal DATA and converting the data signal DATA into a parallel signal, and then outputs the clock signal SCKi, the print data signal SIi, and the latch signal LATi to the print head 23-i. Note that any one of the clock signals SCK1 to SCS6, the print data signals SI1 to SI6, and the latch signals LAT1 to LAT6 corresponding respectively to the print heads 23-1 to 23-6 output by the restoration circuit 220 may commonly be input to the print heads 23-1 to 23-6.

Here, in view of the fact that the restoration circuit 220 generates the clock signals SCK1 to SCK6, the print data signals SI1 to SI6, and the latch signals LAT1 to LAT6 by restoring the data signal DATA and converting the data signal DATA to the parallel signals, the data signal DATA output by the conversion circuit 120 is a differential signal serially including signals corresponding to the clock signals SCK1 to SCK6, the print data signals SI1 to SI6, and the latch signals LAT1 to LAT6. Therefore, the base data signal dDATA output by the control circuit 100 includes single-ended signals corresponding respectively to the clock signals SCK1 to SCK6, the print data signals SI1 to SI6, and the latch signals LAT1 to LAT6. That is, the control circuit 100 outputs the base data signal dDATA as a signal for controlling the operations of the print heads 23-1 to 23-6 provided to the ejection unit 20.

The print head 23-1 includes a drive signal selection circuit 200 and a plurality of ejection parts 600. Further, each of the plurality of ejection parts 600 includes the piezoelectric element 60. That is, the print head 23-1 includes the same number of piezoelectric elements 60 as the number of ejection parts 600. The voltage signals VHV, VDD, the drive signals COMA1, COMB1, and COMC1, the reference voltage signal VBS1, the clock signal SCK1, the print data signal SI1, and the latch signal LAT1 are input to the print head 23-1. The voltage signals VHV, VDD, the drive signals COMA1, COMB1, and COMC1, the clock signal SCK1, the print data signal SI1, and the latch signal LAT1 are input to the drive signal selection circuit 200 provided to the print head 23-1. The drive signal selection circuit 200 generates drive signals VOUT by selecting or deselecting each of the drive signals COMA1, COMB1, and COMC1 based on the voltage signal VHV, the clock signal SCK1, the print data signal SI1, and the latch signal LAT1 input thereto using the voltage signal VDD as the drive power. Then, the drive signal selection circuit 200 supplies the drive signals VOUT thus generated to one ends of the piezoelectric elements 60 provided to the corresponding ejection part 600. On this occasion, the reference voltage signal VBS1 is supplied to the other ends of the piezoelectric elements 60. The piezoelectric elements 60 are each driven by a potential difference between the drive signal VOUT supplied to the one end and the reference voltage signal VBS1 supplied to the other end. The ink corresponding to the driving amount of the piezoelectric element 60 is ejected from the corresponding ejection part 600.

Similarly, the print head 23-i includes the drive signal selection circuit 200 and the plurality of ejection parts 600. Further, each of the plurality of ejection parts 600 includes the piezoelectric element 60. That is, the print head 23-i includes the same number of piezoelectric elements 60 as the number of ejection parts 600. The voltage signals VHV, VDD, the drive signals COMAi, COMBi, and COMCi, the reference voltage signal VBSi, the clock signal SCKi, the print data signal SIi, and the latch signal LATi are input to the print head 23-i. The voltage signals VHV, VDD, the drive signals COMAi, COMBi, and COMCi, the clock signal SCKi, the print data signal SIi, and the latch signal LATi are input to the drive signal selection circuit 200 provided to the print head 23-i. The drive signal selection circuit 200 generates drive signals VOUT by selecting or deselecting each of the drive signals COMAi, COMBi, and COMCi based on the voltage signal VHV, the clock signal SCKi, the print data signal SIi, and the latch signal LATi input thereto using the voltage signal VDD as the drive power. Then, the drive signal selection circuit 200 supplies the drive signals VOUT thus generated to one ends f the piezoelectric elements 60 provided to the corresponding ejection part 600. On this occasion, the reference voltage signal VBSi is supplied to the other ends of the piezoelectric elements 60. The piezoelectric elements 60 are each driven by a potential difference between the drive signal VOUT supplied to the one end and the reference voltage signal VBSi supplied to the other end. The ink corresponding to the driving amount of the piezoelectric element 60 is ejected from the corresponding ejection part 600.

As described above, the head unit 5 provided to the liquid ejection apparatus 1 includes the drive unit 10 and the ejection unit 20, the drive unit 10 controls the operation of the ejection unit 20 based on the image information signal IP output by the control unit 2, and the ejection unit 20 ejects the ink supplied from the liquid container 3 to the medium P in accordance with the control of the drive unit 10. Thus, the head unit 5 ejects a predetermined amount of ink toward the medium P at a predetermined timing based on the image information signal IP. As a result, the liquid ejection apparatus 1 forms the desired image on the medium P.

That is, the head unit 5 includes the drive unit 10 to which the voltage signal VDC is supplied from the outside and which outputs the drive signals COMA1 to COMA6, COMB1 to COMB6, COMC1 to COMC6, and the reference voltage signals VBS1 to VBS6, and the ejection unit 20 which ejects the ink in accordance with the drive signals COMA1 to COMA6, COMB1 to COMB6, and COMC1 to COMC6. In other words, the drive unit 10 outputs the drive signals COMA1 to COMA6, COMB1 to COMB6, COMC1 to COMC6, and the reference voltage signals VBS1 to VBS6 to the corresponding print heads 23-1 to 23-6.

Here, the print heads 23-1 to 23-6 provided to the ejection unit 20 are only different in the signals input thereto and have substantially the same configuration. Therefore, in the following description, when there is no need to distinguish the print heads 23-1 to 23-6 from each other, the print heads 23-1 to 23-6 may simply be referred to as print heads 23 in some cases. In this case, the drive signals COMA1 to COMA6 input to the print head 23 may be referred to as drive signals COMA, the drive signals COMB1 to COMB6 may be referred to as drive signals COMB, the drive signals COMC1 to COMC6 may be referred to as drive signals COMC, the clock signals SCK1 to SCS6 may be referred to as clock signals SCK, the print data signals SI1 to SI6 may be referred to as print data signals SI, and the latch signals LAT1 to LAT6 may be referred to as latch signals LAT in some cases.

### 2.2 Configuration and Operation of Drive Signal Selection Circuit

Then, a configuration and an operation of the drive signal selection circuit 200 provided to the print head 23 will be described. As a preparation for the description of the configuration and the operation of the drive signal selection circuit 200 provided to the print head 23, first, an example of signal waveforms provided to the drive signals COMA, COMB, and COMC input to the drive signal selection circuit 200 will be described.

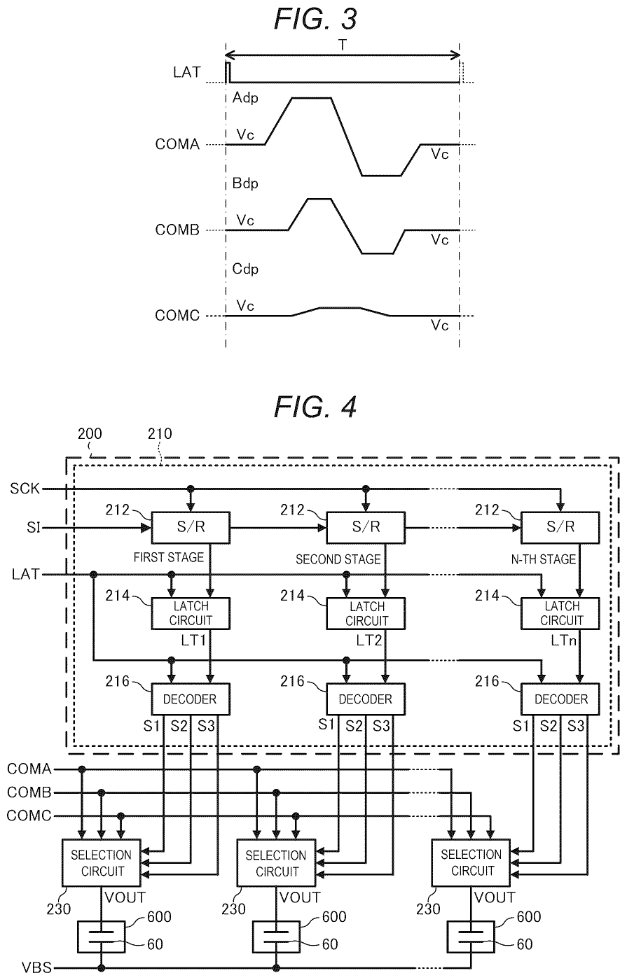

FIG. 3 is a diagram showing an example of the signal waveforms of the drive signals COMA, COMB, and COMC. As shown in FIG. 3, the drive signal COMA includes a trapezoidal waveform Adp arranged in a period T from when the latch signal LAT rises to when the latch signal LAT subsequently rises. The trapezoidal waveform Adp is a signal waveform for driving the piezoelectric element 60 so that a predetermined amount of ink is ejected from the corresponding ejection part 600 by being supplied to the one end of the piezoelectric element 60.

The drive signal COMB includes a trapezoidal waveform Bdp arranged in the period T. The trapezoidal waveform Bdp is a signal waveform smaller in voltage amplitude than the trapezoidal waveform Adp, and when the trapezoidal waveform Bdp is supplied to the one end of the piezoelectric element 60, a smaller amount of ink than the predetermined amount is ejected from the ejection part 600 corresponding to the piezoelectric element 60. That is, the trapezoidal waveform Bdp is a signal waveform for driving the piezoelectric element 60 so that the smaller amount of ink than the predetermined amount is ejected from the corresponding ejection part 600 by being supplied to the one end of the piezoelectric element 60.

Here, the amount of ink ejected from the ejection part 600 corresponding to when the drive signal COMA is supplied to the piezoelectric element 60 is larger than the amount of ink ejected from the ejection part 600 corresponding to when the drive signal COMB is supplied to the piezoelectric element 60. Therefore, the driving amount of the piezoelectric element 60 when the drive signal COMA is supplied to the piezoelectric element 60 is larger than the driving amount of the piezoelectric element 60 when the drive signal COMB is supplied to the piezoelectric element 60. In other words, the amount of ink ejected from the ejection part 600 corresponding to the piezoelectric element 60 when the drive signal COMA is supplied to the piezoelectric element 60 is different from the amount of ink ejected from the ejection part 600 corresponding to the piezoelectric element 60 when the drive signal COMB is supplied to the piezoelectric element 60, the amount of ink ejected from the ejection part 600 corresponding to the piezoelectric element 60 when the drive signal COMA is supplied to the piezoelectric element 60 is larger than the amount of ink ejected from the ejection part 600 corresponding to the piezoelectric element 60 when the drive signal COMB is supplied to the piezoelectric element 60, and therefore, an amount of current generated due to the propagation of the drive signal COMA is larger than an amount of current generated due to the propagation of the drive signal COMB.

Further, the drive signal COMC includes a trapezoidal waveform Cdp arranged in the period T. The trapezoidal waveform Cdp is a signal waveform smaller in voltage amplitude than the trapezoidal waveforms Adp, Bdp, and when the trapezoidal waveform Cdp is supplied to the one end of the piezoelectric element 60, the ink around a nozzle opening portion is vibrated to the extent that the ink is not ejected from the ejection part 600 corresponding to that piezoelectric element 60. That is, the trapezoidal waveform Cdp is a signal waveform that drives the piezoelectric element 60 to the extent that the ink is not ejected from the ejection part 600 corresponding thereto by being supplied to the one end of the piezoelectric element 60. Due to the trapezoidal waveform Cdp, the ink in the vicinity of the nozzle opening portion of the ejection part 600 including the piezoelectric element 60 is vibrated. As a result, the possibility that the viscosity of the ink increases in the vicinity of the corresponding nozzle opening portion is reduced.

As described above, the drive signals COMA, COMB drives the corresponding piezoelectric element 60 so that the ink is ejected from the ejection part 600, and the drive signal COMC drives the corresponding piezoelectric element 60 so that the ink is not ejected from the ejection part 600. That is, the driving amount of the piezoelectric element 60 when the drive signal COMA, COMB is supplied to the piezoelectric element 60 is larger than the driving amount of the piezoelectric element 60 when the drive signal COMC is supplied to the piezoelectric element 60. Therefore, the voltage amplitude of the drive signal COMA, COMB is larger than the voltage amplitude of the drive signal COMC, and the amount of the current generated due to the propagation of the drive signal COMA, COMB is larger than the amount of the current generated due to the propagation of the drive signal COMC.

Further, the voltage values of the trapezoidal waveforms Adp, Bdp, and Cdp at the start timing and the end timing of the respective trapezoidal waveforms Adp, Bdp, and Cdp are all common at a voltage Vc. That is, each of the trapezoidal waveforms Adp, Bdp, and Cdp is a signal waveform that starts at the voltage Vc and ends at the voltage Vc.

Here, in the following description, the amount of ink ejected from the ejection part 600 corresponding to the piezoelectric element 60 when the trapezoidal waveform Adp is supplied to the one end of the piezoelectric element 60 may be referred to as a high-degree amount, and the amount of ink ejected from the ejection part 600 corresponding to the piezoelectric element 60 when the trapezoidal waveform Bdp is supplied to the one end of the piezoelectric element 60 may be referred to as a low-degree amount different from the high-degree amount in some cases. Further, the operation of vibrating the ink in the vicinity of the nozzle opening portion to the extent that ink is not ejected from the ejection part 600 corresponding to the piezoelectric element 60 when the trapezoidal waveform Cdp is supplied to the one end of the piezoelectric element 60 may be referred to as a micro vibration BSD in some cases.

That is, in the liquid ejection apparatus 1 according to the present embodiment, the drive circuit 52a outputs the drive signal COMA for driving the piezoelectric element 60 so that the ejection part 600 provided to the print head 23 ejects the high-degree amount of ink as a predetermined amount of ink, the drive circuit 52b outputs the drive signal COMB for driving the piezoelectric element 60 so that the ejection part 600 provided to the print head 23 ejects a low-degree amount of ink as a smaller amount of ink than the predetermined amount, and the drive circuit 52c outputs the drive signal COMC for driving the piezoelectric element 60 so that the ejection part 600 provided to the print head 23 does not eject the ink.

Note that the signal waveforms of the drive signals COMA, COMB, and COMC are not limited to the shapes illustrated in FIG. 3, and various shapes of signal waveforms may be used in accordance with the type of the ink ejected from the ejection part 600, the number of piezoelectric elements 60 driven by the drive signals COMA, COMB, and COMC, the length of wiring lines through which the drive signals COMA, COMB, and COMC propagate, and so on. Therefore, the drive signals COMA1 to COMA6 may have respective waveforms different in shape from each other, and the amount of ink ejected from the corresponding ejection part 600 by the drive signal COMA1 may be different from the amount of ink ejected from the corresponding ejection part 600 by the drive signal COMAi. Similarly, the drive signals COMB1 to COMB6 may have respective waveforms different in shape from each other, and the amount of ink ejected from the corresponding ejection part 600 by the drive signal COMB1 may be different from the amount of ink ejected from the corresponding ejection part 600 by the drive signal COMBi. Similarly, the drive signals COMC1 to COMC6 may have respective waveforms different in shape from each other, and the displacement amount of the piezoelectric element 60 generated by the drive signal COMC1 and the displacement amount of the piezoelectric element 60 generated by the drive signal COMCi may be different from each other.

Then, a configuration and an operation of the drive signal selection circuit 200 that outputs the drive signal VOUT by selecting or deselecting each of the drive signals COMA, COMB, and COMC will be described. FIG. 4 is a diagram showing a functional configuration of the drive signal selection circuit 200. As shown in FIG. 4, the drive signal selection circuit 200 includes a selection control circuit 210 and a plurality of selection circuits 230.

The print data signal SI, the latch signal LAT, and the clock signal SCK are input to the selection control circuit 210. Further, the selection control circuit 210 includes n sets of a shift register (S/R) 212, a latch circuit 214, and a decoder 216 corresponding respectively to the n ejection parts 600. That is, the drive signal selection circuit 200 includes the same number n of shift registers 212, latch circuits 214, and decoders 216 as the number n of ejection parts 600.

The print data signal SI is a signal synchronized with the clock signal SCK, and includes 2-bit print data [SIH, SIL] for defining the size of the dot formed by the ink ejected from each of the n ejection parts 600 with any one of a “large dot LD”, a “small dot SD”, “non-ejection ND”, and the “micro vibration BSD”. The print data signal SI is held in the shift register 212 corresponding to the ejection part 600 by the 2-bit print data [SIH, SIL].

Specifically, the n shift registers 212 corresponding to the ejection part 600 are cascaded one another. The 2-bit print data [SIH, SIL] provided to the print data signal SI is sequentially transferred to a subsequent stage in the shift registers 212 thus cascaded in accordance with the clock signal SCK. Then, when the supply of the clock signal SCK is stopped, the n shift registers 212 each hold the 2-bit print data [SIH, SIL] corresponding to the ejection part 600 corresponding to that shift register 212. Note that in FIG. 4, in order to distinguish n shift registers 212 thus cascaded from each other, a first stage, a second stage, . . . , and an n-th stage are illustrated from the upstream shift register to which the print data signal SI is input to the downstream shift register.

The n latch circuits 214 concurrently latch the 2-bit print data [SIH, SIL] held in the corresponding shift registers 212 at the rising edge of the latch signal LAT.

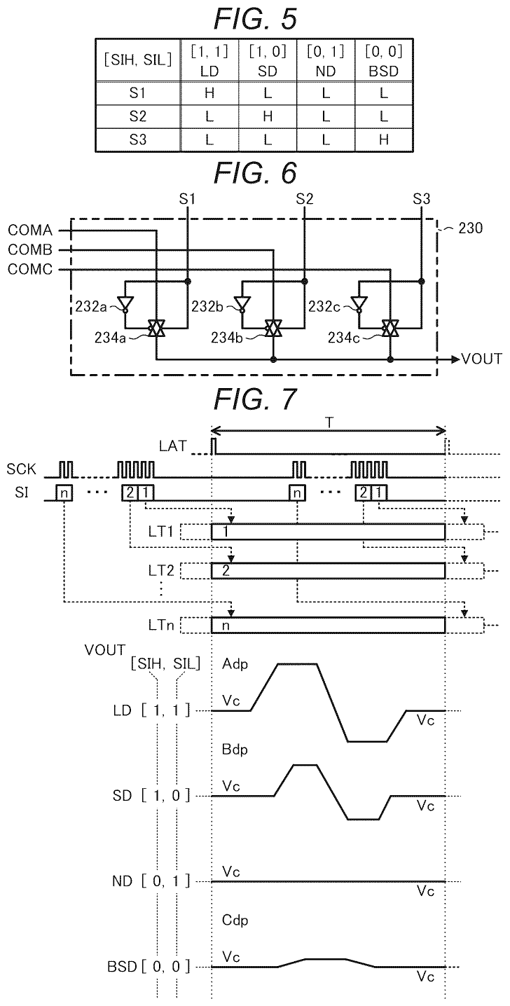

The 2-bit print data [SIH, SIL] latched by the latch circuit 214 is input to the corresponding decoder 216. Each of the n decoders 216 decodes the 2-bit print data [SIH, SIL] input thereto, and outputs selection signals S1, S2, and S3 in logic levels corresponding to the decoded contents by the period T. FIG. 5 is a diagram illustrating an example of decoded contents in the decoder 216. The decoder 216 generates logic level signals defined by the 2-bit print data [SIH, SIL] input thereto and the decoded content shown in FIG. 5, and then outputs the selection signals S1, S2, and S3 generated by level-shifting the logic levels of the signals thus generated into a high amplitude logic in accordance with the voltage value of the voltage signal VHV. For example, when the 2-bit print data [SIH, SIL] input to the decoder 216 is [1, 0], the decoder 216 sets the logic levels of the selection signals S1, S2, and S3 to L, H, and L levels, respectively, in the period T.

Going back to FIG. 4, the selection circuits 230 are provided corresponding respectively to the n ejection parts 600. That is, the drive signal selection circuit 200 includes the n selection circuits 230. The selection signals S1, S2, and S3 output by the decoder 216 corresponding to the same ejection part 600 and the drive signals COMA, COMB, and COMC are input to the selection circuit 230. The selection circuit 230 generates the drive signal VOUT by selecting or deselecting each of the drive signals COMA, COMB, and COMC based on the selection signals S1, S2, and S3, and then outputs the drive signal VOUT to the corresponding ejection part 600.

FIG. 6 is a diagram illustrating an example of the configuration of the selection circuit 230 corresponding to one ejection part 600. As shown in FIG. 6, the selection circuit 230 includes inverters 232a, 232b, and 232c and transfer gates 234a, 234b, and 234c.

The selection signal S1 is input to a positive control terminal which is not marked with a circle in the transfer gate 234a, and is also input to a negative control terminal which is marked with a circle in the transfer gate 234a after being logic-inverted by the inverter 232a. A drive signal COMA is input to an input terminal of the transfer gate 234a. The transfer gate 234a makes the input terminal and the output terminal conductive when the selection signal S1 input thereto is at the H level, and makes the input terminal and the output terminal nonconductive when the selection signal S1 input thereto is at the L level. That is, the transfer gate 234a outputs the drive signal COMA to the output terminal when the selection signal S1 is at the H level, and does not output the drive signal COMA to the output terminal when the selection signal S1 is at the L level.

The selection signal S2 is input to a positive control terminal which is not marked with a circle in the transfer gate 234b, and is also input to a negative control terminal which is marked with a circle in the transfer gate 234b after being logic-inverted by the inverter 232b. A drive signal COMB is input to an input terminal of the transfer gate 234b. The transfer gate 234b makes the input terminal and the output terminal conductive when the selection signal S2 input thereto is at the H level, and makes the input terminal and the output terminal nonconductive when the selection signal S2 input thereto is at the L level. That is, the transfer gate 234b outputs the drive signal COMB to the output terminal when the selection signal S2 is at the H level, and does not output the drive signal COMB to the output terminal when the selection signal S2 is at the L level.

The selection signal S3 is input to a positive control terminal which is not marked with a circle in the transfer gate 234c, and is also input to a negative control terminal which is marked with a circle in the transfer gate 234c after being logic-inverted by the inverter 232c. A drive signal COMC is input to an input terminal of the transfer gate 234c. The transfer gate 234c makes the input terminal and the output terminal conductive when the selection signal S3 input thereto is at the H level, and makes the input terminal and the output terminal nonconductive when the selection signal S3 input thereto is at the L level. That is, the transfer gate 234c outputs the drive signal COMC to the output terminal when the selection signal S3 is at the H level, and does not output the drive signal COMC to the output terminal when the selection signal S3 is at the L level.

In the selection circuit 230, the output terminals of the transfer gates 234a, 234b, and 234c are commonly coupled. That is, the drive signals COMA, COMB, and COMC that are selected or deselected in accordance with the selection signals S1, S2, and S3 are output from the output terminals of the transfer gates 234a, 234b, and 234c that are coupled in common. Then, the drive signal selection circuit 200 supplies the signal of the output terminals of the transfer gates 234a, 234b, and 234c to the piezoelectric element 60 provided to the corresponding ejection part 600 as the drive signal VOUT.

The operation of the drive signal selection circuit 200 configured as described hereinabove will be described. FIG. 7 is a diagram illustrating the operation of the drive signal selection circuit 200. The print data signal SI is a signal serially including the 2-bit print data [SIH, SIL], and is input to the drive signal selection circuit 200 in synchronization with the clock signal SCK. Further, the 2-bit print data [SIH, SIL] provided to the print data signal SI is sequentially transferred to the shift register 212 in a subsequent stage in synchronization with the clock signal SCK. Subsequently, when the input of the clock signal SCK is stopped, the 2-bit print data [SIH, SIL] corresponding to each of the ejection parts 600 is held in the shift register 212 corresponding to the same ejection part 600.

Subsequently, when the latch signal LAT rises, the latch circuits 214 concurrently latch the 2-bit print data [SIH, SIL] held in the shift registers 212. Note that in FIG. 7, the 2-bit print data [SIH, SIL] corresponding respectively to the shift registers 212 in the first stage, the second stage, . . . , and the n-th stage latched by the latch circuits 214 are illustrated as LT1, LT2, . . . , and LTn.

The 2-bit print data [SIH, SIL] latched by the latch circuit 214 is input to the decoder 216. The decoder 216 outputs the selection signals S1, S2, and S3 in the logic levels corresponding to the dot size defined by the 2-bit print data [SIH, SIL] input thereto.

Specifically, when the 2-bit print data [SIH, SIL] input thereto is [1,1], the decoder 216 sets the logic levels of the selection signals S1, S2, and S3 to the H, L, and L levels to output the selection signals S1, S2, and S3 to the selection circuit 230 in the period T. As a result, the selection circuit 230 selects the trapezoidal waveform Adp in the period T. As a result, the drive signal VOUT corresponding to the “large dot LD” shown in FIG. 7 is output from the drive signal selection circuit 200.

Further, when the 2-bit print data [SIH, SIL] input thereto is [1,0], the decoder 216 sets the logic levels of the selection signals S1, S2, and S3 to L, H, and L levels to output the selection signals S1, S2, and S3 to the selection circuit 230 in the period T. As a result, the selection circuit 230 selects the trapezoidal waveform Bdp in the period T. As a result, the drive signal VOUT corresponding to the “small dot LD” shown in FIG. 7 is output from the drive signal selection circuit 200.

Further, when the 2-bit print data [SIH, SIL] input thereto is [0, 1], the decoder 216 sets the logic levels of the selection signals S1, S2, and S3 to L, L, and L levels to output the selection signals S1, S2, and S3 to the selection circuit 230 in the period T. As a result, the selection circuit 230 does not select any of the trapezoidal waveforms Adp, Bdp, and Cdp in the period T. Thus, the drive signal VOUT corresponding to the “non-ejection ND” shown in FIG. 7 is output from the drive signal selection circuit 200.

Here, when the selection circuit 230 does not select any of the trapezoidal waveforms Adp, Bdp, and Cdp, the voltage Vc supplied immediately before the piezoelectric element 60 is held at the one end of the corresponding piezoelectric element 60 by a capacitance component of the piezoelectric element 60. That is, outputting the drive signal VOUT constant at the voltage Vc from the drive signal selection circuit 200 includes when the last voltage Vc held by the capacitance component of the piezoelectric element 60 is supplied to the piezoelectric element 60 as the drive signal VOUT when none of the trapezoidal waveforms Adp, Bdp, and Cdp is selected as the drive signal VOUT.

Further, when the 2-bit print data [SIH, SIL] input thereto is [0,0], the decoder 216 sets the logic levels of the selection signals S1, S2, and S3 to L, L, and H levels to output the selection signals S1, S2, and S3 to the selection circuit 230 in the period T. As a result, the selection circuit 230 selects the trapezoidal waveform Cdp in the period T. As a result, the drive signal VOUT corresponding to the “micro vibration BSD” shown in FIG. 7 is output from the drive signal selection circuit 200.

As described hereinabove, the drive signal selection circuit 200 selects or deselects the drive signals COMA, COMB, and COMC based on the voltage signal VHV, the print data signal SI, the latch signal LAT, and the clock signal SCK to thereby generate the drive signals VOUT corresponding respectively to the plurality of ejection parts 600, and then output the drive signals VOUT to the corresponding ejection parts 600. Thus, the amount of ink ejected from each of the plurality of ejection parts 600 is individually controlled.

Further, in the liquid ejection apparatus 1 according to the present embodiment, when the large dot is formed on the medium P, the drive signal selection circuit 200 supplies the drive signal COMA, which is output from the drive circuit 52a, to the ejection part 600 as the drive signal VOUT, and when the small dot is formed on the medium P, the drive signal selection circuit 200 supplies the drive signal COMB, which is output by the drive circuit 52b, to the ejection part 600 as the drive signal VOUT. That is, it is sufficient for the drive signal selection circuit 200 to select either one of the drive signals COMA, COMB in accordance with the size of the dot to be formed on the medium P. Therefore, the waveform period of the drive signals COMA, COMB can be shortened compared to a configuration in which one drive signal includes a plurality of signal waveforms and the signal waveforms are selected in a time-division manner to define the size of the dot to be formed on the medium P. As a result, it is possible to increase the image forming speed at which the liquid ejection apparatus 1 forms a desired image on the medium P.

Further, in the liquid ejection apparatus 1 according to the present embodiment, since the drive signal COMC for driving the piezoelectric element 60 so as not to eject the ink to the medium P is provided in addition to the drive signals COMA, COMB, it is possible to reduce the possibility that the ejection abnormality caused by an increase in ink viscosity occurs in the ejection part 600 without lowering the image forming speed in forming a desired image on the medium P. That is, in the liquid ejection apparatus 1 according to the present embodiment, since the drive signal COMC is provided in addition to the drive signals COMA, COMB, it is possible to realize an increase in the image forming speed in forming a desired image on the medium P without deteriorating the quality of the image formed on the medium P, and at the same time, it is possible to reduce the possibility that the ejection accuracy of the ink deteriorates.

Here, the drive signal VOUT supplied to the piezoelectric element 60 is generated by selecting the signal waveform provided to each of the drive signals COMA, COMB, and COMC. That is, the drive signal COMA is supplied as the drive signal VOUT to the corresponding piezoelectric element 60 when the drive signal selection circuit 200 selects the drive signal COMA, the drive signal COMB is supplied as the drive signal VOUT to the corresponding piezoelectric element 60 when the drive signal selection circuit 200 selects the drive signal COMB, and the drive signal COMC is supplied as the drive signal VOUT to the corresponding piezoelectric element 60 when the drive signal selection circuit 200 selects the drive signal COMC. That is, the drive circuit 52a outputs the drive signal COMA to be supplied to the piezoelectric element 60, the drive circuit 52b outputs the drive signal COMB to be supplied to the piezoelectric element 60, and the drive circuit 52c outputs the drive signal COMC to be supplied to the piezoelectric element 60.

### 2.3 Configuration and Operation of Drive Circuit

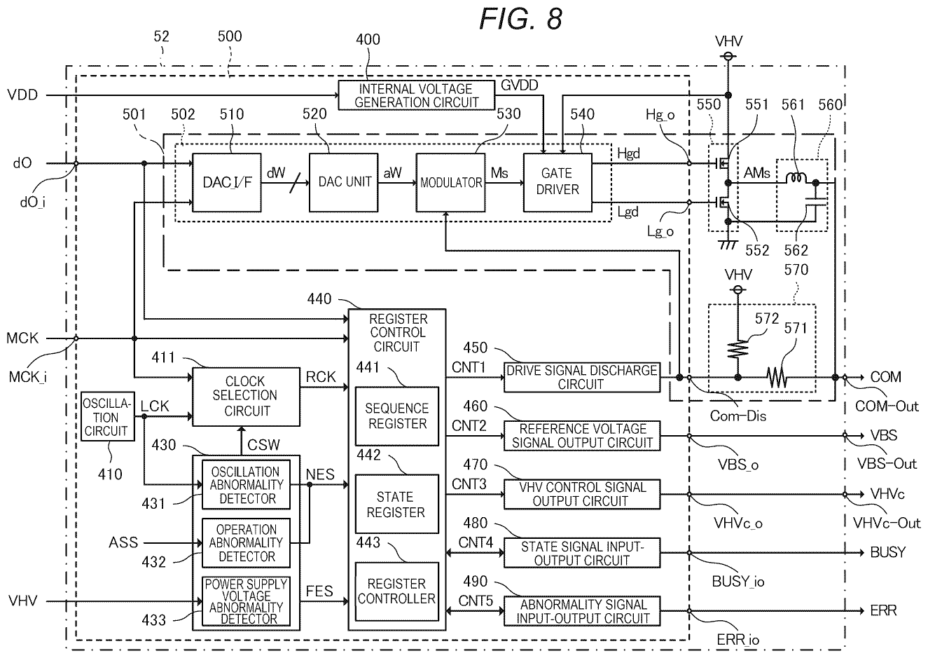

Then, a configuration and an operation of the drive circuit 52 that generates and outputs the drive signal COM will be described. FIG. 8 is a diagram showing an example of the configuration of the drive circuit 52. The drive circuit 52 includes an integrated circuit 500, an amplifier circuit 550, a demodulation circuit 560, and a feedback circuit 570.

The integrated 500 circuit includes an amplification control signal generation circuit 502, an internal voltage generation circuit 400, an oscillation circuit 410, a clock selection circuit 411, an abnormality detection circuit 430, a register control circuit 440, a drive signal discharge circuit 450, a reference voltage signal output circuit 460, a VHV control signal output circuit 470, a state signal input-output circuit 480, and an abnormality signal input-output circuit 490.

A voltage signal VDD is supplied to the internal voltage generation circuit 400. The internal voltage generation circuit 400 steps up or steps down the voltage of the voltage signal VDD input thereto to generate, for example, a voltage signal GVDD having a voltage value of DC 7.5 V. The voltage signal GVDD is input to various constituents of the integrated circuit 500 including a gate driver 540 described later. Note that the integrated circuit 500 may use the voltage signal VDD with the voltage value as it is without stepping up or stepping down the voltage of the voltage signal VDD input thereto.

A base drive data signal dO_is input to the amplification control signal generation circuit 502 via a terminal dO_i. The amplification control signal generation circuit 502 generates amplification control signals Hgd, Lgd based on the base drive data signal dO_input thereto. The amplification control signal generation circuit 502 includes a DAC interface (DAC_I/F: Digital-to-Analog Converter Interface) 510, a DAC unit 520, a modulator 530, and the gate driver 540.

The base drive data signal do supplied via the terminal dO_i and a clock signal MCK supplied via a terminal MCK-i are input to the DAC interface 510. Here, the clock signal MCK may be generated by an oscillation circuit (not shown) provided to the drive unit 10 or the control unit 2. The DAC interface 510 integrates the base drive data signal do based on the clock signal MCK to generate, for example, 10-bit drive waveform data dW that defines the waveform of the drive signal COM. The drive waveform data dW is input to the DAC unit 520. The DAC unit 520 converts the drive waveform data dW input thereto into a drive waveform signal aW as an analog signal. The drive waveform signal aw is a target signal before amplification of the drive signal COM. The drive waveform signal aW is input to the modulator 530. The modulator 530 performs pulse width modulation on the drive waveform signal aW to thereby generate the modulation signal Ms, and then outputs the modulation signal Ms. In other words, the modulator 530 outputs the modulation signal Ms obtained by modulating the drive waveform signal aW. The voltage signals VHV, GVDD and the modulation signal Ms are input to the gate driver 540. The gate driver 540 generates the amplification control signal Hgd obtained by amplifying the modulation signal Ms input thereto based on the voltage signal GVDD, and then level-shifting the result to the high amplitude logic based on the voltage signal VHV, and the amplification control signal Lgd obtained by inverting the logic level of the modulation signal Ms input thereto and then amplifying the result based on the voltage signal GVDD. That is, the logic level of the amplification control signal Hgd and the logic level of the amplification control signal Lgd become exclusively at the H level.

Here, the logic levels becoming exclusively at the H level means that the logic level of the amplification control signal Hgd and the logic level of the amplification control signal Lgd do not simultaneously become at the H level, and does not include when the logic level of the amplification control signal Hgd and the logic level of the amplification control signal Lgd simultaneously become at the L level. Therefore, the gate driver 540 may include a timing control circuit or the like that controls timing so that the logic level of the amplification control signal Hgd and the logic level of the amplification control signal Lgd do not simultaneously become at the H level.

The amplification control signal Hgd is output from the integrated circuit 500 via the terminal Hg_o, and is input to the amplifier circuit 550. The amplification control signal Lgd is output from the integrated circuit 500 via the terminal Lg_o, and is input to the amplifier circuit 550. Here, the amplification control signal Hgd is a signal obtained by level-shifting the logic level of the modulation signal Ms, and the amplification control signal Lgd is a signal obtained by inverting the logic level of the modulation signal Ms. Therefore, the amplification control signal Hgd and the amplification control signal Lgd can also be assumed as a modulation signal generated by the modulator 530 in a broad sense.

The amplifier circuit 550 operates based on the amplification control signals Hgd, Lgd to thereby output an amplified modulation signal AMs. In other words, the amplifier circuit 550 amplifies the modulation signal Ms to output the amplified modulation signal AMs.

Specifically, the amplifier circuit 550 includes transistors 551, 552. Each of the transistors 551, 552: is, example, for an N-channel FET (Field-Effect Transistor). The voltage signal VHV is supplied to a drain terminal of the transistor 551. The amplification control signal Hgd is supplied to a gate terminal of the transistor 551 via a terminal Hg_o. A source terminal of the transistor 551 is electrically coupled to a drain terminal of the transistor 552. Further, the amplification control signal Lgd is supplied to a gate terminal of the transistor 552 via a terminal Lg_o. The ground signal is supplied to a source terminal of the transistor 552. In the amplifier circuit 550 configured as described above, the transistor 551 operates according to the amplification control signal Hgd, and the transistor 552 operates according to the amplification control signal Lgd. That is, the transistors 551, 552 are exclusively turned on. Further, by driving the transistor 551 and the transistor 552, an amplified modulation signal AMs obtained by amplifying the modulation signal Ms based on the voltage signal VHV is generated at a coupling point where the source terminal of the transistor 551 and the drain terminal of the transistor 552 are coupled to each other. The amplifier circuit 550 outputs the amplified modulation signal AMs generated at the coupling point.

The amplified modulation signal AMs output by the amplifier circuit 550 is input to the demodulation circuit 560. The demodulation circuit 560 includes a coil 561 and a capacitor 562. One end of the coil 561 is electrically coupled to the source terminal of the transistor 551 and the drain terminal of the transistor 552. The other end of the coil 561 is electrically coupled to one end of the capacitor 562. The ground signal is supplied to the other end of the capacitor 562. That is, the coil 561 and the capacitor 562 configure a low-pass filter. The demodulation circuit 560 generates the drive signal COM by smoothing and demodulating the amplified modulation signal AMs supplied by the low-pass filter. The drive signal COM generated by the demodulation circuit 560 is output from the drive circuit 52 via a terminal COM-Out. That is, the amplifier circuit 550 and the demodulation circuit 560 operate under the control of the integrated circuit 500 to thereby output the drive signal COM corresponding to the voltage signal VHV.

Further, the drive signal COM output by the demodulation circuit 560 is fed back to the modulator 530 via the feedback circuit 570. The feedback circuit 570 includes resistors 571, 572. One end of the resistor 571 is electrically coupled to the other end of the coil 561, and the other end of the resistor 571 is electrically coupled to one end of the resistor 572. The voltage signal VHV is supplied to the other end of the resistor 572. Further, the other end of the resistor 571 and the one end of the resistor 572 are electrically coupled to the modulator 530 via a terminal Com-Dis. That is, a signal based on the drive signal COM is fed back to the modulator 530. This improves the waveform accuracy of the signal waveform of the drive signal COM output by the demodulation circuit 560. Note that the feedback circuit 570 may include a feedback path that extracts a specific frequency component from the drive signal COM and feeds back the extracted signal to the modulator 530 in addition to the configuration including the resistor 571 and the resistor 572 described above.

As described above, the amplification control signal generation circuit 502, the amplifier circuit 550, the demodulation circuit 560, and the feedback circuit 570 generate the drive signal COM for driving the piezoelectric element 60 based on the base drive data signal do, and then output the drive signal COM. In the following description, the amplification control signal generation circuit 502, the amplifier circuit 550, the demodulation circuit 560, and the feedback circuit 570 that output the drive signal COM for driving the piezoelectric element 60 based on the drive data signal do may be referred to as a drive signal generation circuit 501 in some cases. Further, the drive signal COM generated by the drive signal generation circuit 501 is supplied to the piezoelectric element 60 via the terminal COM-Out. The drive signal generation circuit 501 configured as described above can output a signal having a constant voltage value when the base drive data signal do corresponding to a constant voltage value is supplied besides the drive signal COM changing in voltage value such as the trapezoidal waveforms Adp, Bdp, and Cdp as shown in FIG. 3.

That is, the drive circuit 52 includes the amplifier circuit 550 and the demodulation circuit 560 which are supplied with the voltage signal VHV and output a drive signal COM corresponding to the voltage signal VHV, and the integrated circuit 500 which is supplied with the voltage signal VDD and controls the drive of the amplifier circuit 550 in accordance with the voltage signal VDD. The drive circuit 52 outputs the drive signal COM by amplifying the drive waveform signal aW corresponding to the base drive data signal do, which is the base of the drive signal COM, based on the voltage signal VHV.

The oscillation circuit 410 generates and outputs a clock signal LCK that defines an operation timing of the integrated circuit 500. The clock signal LCK is input to the clock selection circuit 411 and the abnormality detection circuit 430.

The clock signals MCK, LCK and a clock selection signal CSW are input to the clock selection circuit 411. The clock selection circuit 411 switches whether to output the clock signal MCK to the register control circuit 440 as a clock signal RCK, or to output the clock signal LCK to the register control circuit 440 as the clock signal RCK based on the logic level of the clock selection signal CSW. For example, the clock selection circuit 411 outputs the clock signal MCK to the register control circuit 440 as the clock signal RCK when the clock selection signal CSW input thereto is at the H level, and outputs the clock signal LCK to the register control circuit 440 as the clock signal RCK when the clock selection signal CSW input thereto is at the L level.

The abnormality detection circuit 430 includes an oscillation abnormality detector 431, an operation abnormality detector 432, and a power supply voltage abnormality detector 433.

The clock signal LCK output by the oscillation circuit 410 is input to the oscillation abnormality detector 431. The oscillation abnormality detector 431 acquires the frequency, the voltage value, and so on of the clock signal LCK input thereto, and detects whether the clock signal LCK is normal from the information thus acquired. Further, when the oscillation abnormality detector 431 detects the abnormality of the clock signal LCK input thereto, the oscillation abnormality detector 431 generates the clock selection signal CSW representing the abnormality, and outputs the clock selection signal CSW to the clock selection circuit 411, and at the same time, generates an error signal NES representing the abnormality and outputs the error signal NES to the register control circuit 440, and when the oscillation abnormality detector 431 does not detect the abnormality in the clock signal LCK input thereto, the oscillation abnormality detector 431 generates the clock selection signal CSW representing normality, outputs the clock selection signal CSW to the clock selection circuit 411, and at the same time, generates the error signal NES representing normality, and outputs the error signal NES to the register control circuit 440.

An operation state signal ASS representing the operation states of various constituents provided to the drive circuit 52 is input to the operation abnormality detector 432. The operation abnormality detector 432 detects whether the various constituents of the drive circuit 52 normally operate based on the operation state signal ASS input thereto. Further, when the operation state signal ASS representing that an abnormality has occurred in any one of the various constituents of the drive circuit 52 is input, the operation abnormality detector 432 generates the error signal NES representing the abnormality and then outputs the error signal NES to the register control circuit 440.

The voltage signal VHV is input to the power supply voltage abnormality detector 433. The power supply voltage abnormality detector 433 detects whether the voltage value of the voltage signal VHV input thereto is normal. Then, when the voltage value of the voltage signal VHV thus detected is abnormal, the power supply voltage abnormality detector 433 generates an error signal FES representing an abnormality and then outputs the error signal FES to the register control circuit 440.

The register control circuit 440 includes a sequence register 441, a state register 442, and a register controller 443. The sequence register 441 and the state register 442 hold operation information and so on input as the base drive data signal dO_in synchronization with the clock signal MCK. The register controller 443 generates control signals CNT1 to CNT5 based on the information held in the sequence register 441 and the state register 442 in synchronization with the clock signal RCK. Then the register control circuit 440 outputs the control signals CNT1 to CNT5 generated by the register controller 443 to the corresponding constituents.

The control signal CNT1 output by the register control circuit 440 is input to the drive signal discharge circuit 450. The drive signal discharge circuit 450 is electrically coupled to the terminal COM-Out via the terminal Com-Dis and the feedback circuit 570. The drive signal discharge circuit 450 controls the discharge of the residual charge stored in the propagation path of the drive signal COM.

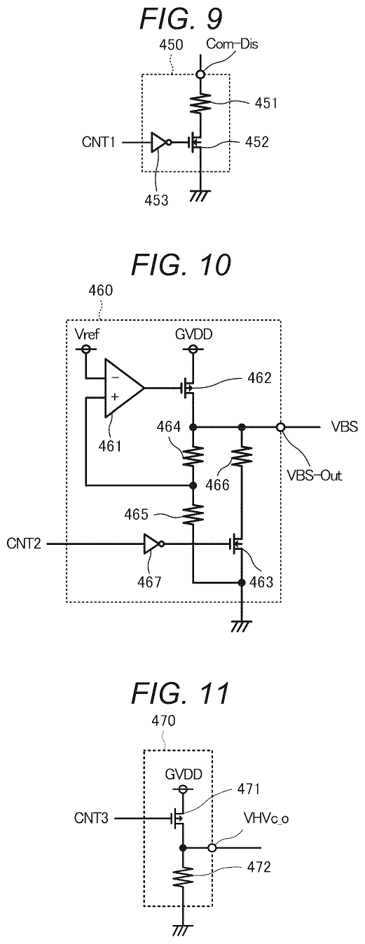

FIG. 9 is a diagram illustrating an example of a configuration of the drive signal discharge circuit 450. The drive signal discharge circuit 450 includes a resistor 451, a transistor 452, and an inverter 453. Note that the description will be presented assuming that the transistor 452 is an NMOS transistor. One end of the resistor 451 is electrically coupled to the terminal Com-Dis. The other end of the resistor 451 is electrically coupled to a drain terminal of the transistor 452. The ground signal is supplied to a source terminal of the transistor 452. The control signal CNT1 is input to a gate terminal of the transistor 452 via the inverter 453. The drive signal discharge circuit 450 configured as described above discharges the residual charge accumulated in the propagation path of the drive signal COM when the control signal CNT1 at the L level is input. Specifically, when the control signal CNT1 at the L level is input to the drive signal discharge circuit 450, the transistor 452 is controlled to be turned on. Thus, the terminal Com-Out is electrically coupled to the propagation path through which the ground signal propagates via the resistor 571, the terminal Com-Dis, the resistor 451, and a transistor 542. As a result, the residual charge accumulated in the propagation path of the drive signal COM including the terminal COM-Out is discharged.

The control signal CNT2 output by the register control circuit 440 is input to the reference voltage signal output circuit 460. The reference voltage signal output circuit 460 is electrically coupled to the piezoelectric element 60 via a terminal VBS_o and a terminal VBS_Out. The reference voltage signal output circuit 460 generates the reference voltage signal VBS to be supplied to the piezoelectric element 60 in accordance with the control signal CNT2, and then outputs the reference voltage signal VBS.

FIG. 10 is a diagram illustrating an example of a configuration of the reference voltage signal output circuit 460. The reference voltage signal output circuit 460 includes a comparator 461, transistors 462, 463, resistors 464, 465, and 466, and an inverter 467. Note that the description will be presented assuming that the transistor 462 is a PMOS transistor, and the transistor 463 is an NMOS transistor. A reference voltage Vref is supplied to a negative input terminal of the comparator 461. As the reference voltage Vref, for example, a bandgap reference voltage of the integrated circuit 500 is used. A positive input terminal of the comparator 461 is electrically coupled to one end of the resistor 464 and one end of the resistor 465. An output terminal of the comparator 461 is electrically coupled to a gate terminal of the transistor 462. The voltage signal GVDD is supplied to a source terminal of the transistor 462. A drain terminal of the transistor 462 is electrically coupled to the other end of the resistor 464, one end of the resistor 466, and the terminal VBS_o to which the reference voltage signal VBS is output. The other end of the resistor 466 is electrically coupled to a drain terminal of the transistor 463. The control signal CNT2 is input to a gate terminal of the transistor 463 via the inverter 467. The ground signal is supplied to a source terminal of the transistor 463 and the other end of the resistor 465.

In the reference voltage signal output circuit 460 configured as described above, when a voltage value supplied to the positive input terminal of the comparator 461 is greater than a voltage value of the reference voltage Vref supplied to the negative input terminal of the comparator 461, the comparator 461 outputs a signal at the H level. Accordingly, the transistor 462 is controlled to be turned off, and the voltage signal GVDD is not supplied to the terminal VBS_o. On the other hand, when the voltage value supplied to the positive input terminal of the comparator 461 is less than the voltage value of the reference voltage Vref supplied to the negative input terminal of the comparator 461, the comparator 461 outputs a signal at the L level. Thus, the transistor 462 is controlled to be on, and the voltage signal GVDD is supplied to the terminal VBS_o. That is, in the reference voltage signal output circuit 460, the comparator 461 controls the conduction state of the transistor 462 so that a voltage value obtained by dividing the voltage value of the terminal VBS_o by the resistors 464, 465 is equal to the voltage value of the reference voltage Vref. Thus, the reference voltage signal output circuit 460 generates a signal having a constant voltage value based on the voltage signal GVDD. The signal having the constant voltage value generated by the reference voltage signal output circuit 460 is output as the reference voltage signal VBS. The reference voltage signal VBS_output by the reference voltage signal output circuit 460 is supplied to the piezoelectric element 60 via the terminal VBS_o and the terminal VBS_Out.

Further, the control signal CNT2 is input to the reference voltage signal output circuit 460. When the control signal CNT2 at the H level is input to the reference voltage signal output circuit 460, the transistor 463 is controlled to be turned off. Thus, control of providing high impedance between the terminal VBS_o and the propagation path through which the ground signal is propagated is performed. Therefore, the reference voltage signal VBS generated by the reference voltage signal output circuit 460 is output via the terminal VBS_o. On the other hand, when the control signal CNT2 at the L level is input to the reference voltage signal output circuit 460, the transistor 463 is controlled to be turned on. Thus, the terminal VBS_o is electrically coupled to the propagation path through which the ground signal is propagated via the resistor 576 and the transistor 463. Therefore, the reference voltage signal VBS generated by the reference voltage signal output circuit 460 is not output, and the potential of the terminal VBS_o becomes that of the ground signal. That is, when the control signal CNT2 at the L level is input to the reference voltage signal output circuit 460, the reference voltage signal output circuit 460 stops outputting the reference voltage signal VBS to the piezoelectric element 60, and releases the charge stored in the terminal VBS_o.

The control signal CNT3 output by the register control circuit 440 is input to the VHV control signal output circuit 470. The VHV control signal output circuit 470 is electrically coupled to the step-down circuit 130 via a terminal VHVc_o and a terminal VHVc-Out. The VHV control signal output circuit 470 controls the operation of the step-down circuit 130 by outputting the step-down control signal VHVc the logic level of which changes in accordance with the control signal CNT3 to the step-down circuit 130.

FIG. 11 is a diagram illustrating an example of a configuration of the VHV control signal output circuit 470. The VHV control signal output circuit 470 includes a transistor 471 and a resistor 472. Note that the description will be presented assuming that the transistor 471 is a PMOS transistor. The voltage signal GVDD is supplied to a source terminal of the transistor 471. A drain terminal of the transistor 471 is electrically coupled to one end of the resistor 472 and the terminal VHVc_o. The control signal CNT3 is input to a gate terminal of the transistor 471. The ground signal is supplied to the other end of the resistor 472. When the control signal CNT3 at the L level is input to the VHV control signal output circuit 470 configured as described above, the VHV control signal output circuit 470 supplies the voltage signal GVDD to the terminal VHVc_o. In other words, the VHV control signal output circuit 470 outputs the step-down control signal VHVc of the voltage signal GVDD. Further, when the control signal CNT3 at the H level is input to the VHV control signal output circuit 470, the VHV control signal output circuit 470 supplies the ground signal to the terminal VHVC_O. In other words, the VHV control signal output circuit 470 outputs the step-down control signal VHVc of the ground signal. That is, the VHV control signal output circuit 470 generates the step-down control signal VHVc the H level of which is the voltage value of the voltage signal GVDD and the L level of which is the ground signal in accordance with the logic level of the control signal CNT3, and then outputs the step-down control signal VHVc to the step-down circuit 130.

The control signal CNT4 output by the register control circuit 440 is input to the state signal input-output circuit 480. The state signal input-output circuit 480 is electrically coupled to other constituents via a terminal BUSY_io. The state signal input-output circuit 480 outputs a state signal BUSY the logic level of which changes in accordance with the control signal CNT4 to thereby notify another constituent of the operation state of the drive circuit 52, and acquires the state signal BUSY output by the other constituent. Here, another constituent may be, for example, any one of the drive signal output circuits 50-1 to 50-6 provided to the liquid ejection apparatus 1, or may be the control circuit 100.

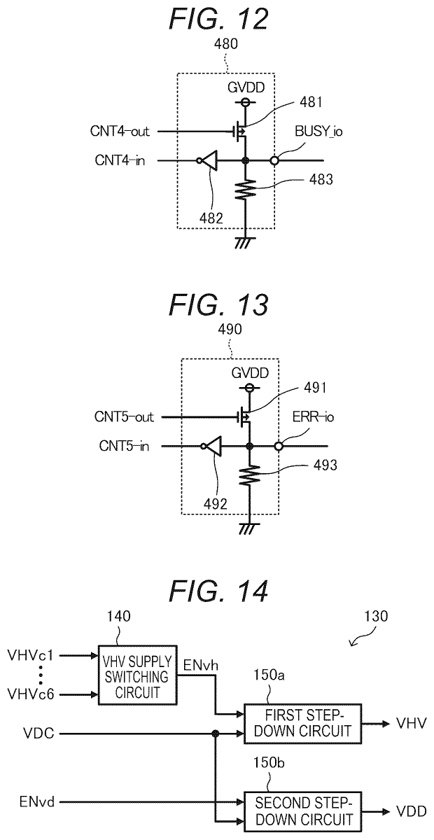

FIG. 12 is a diagram illustrating a configuration of the state signal input-output circuit 480. The state signal input-output circuit 480 includes a transistor 481, an inverter 482, and a resistor 483. Note that the description will be presented assuming that the transistor 481 is a PMOS transistor. Further, the inverter 482 functions as a COMS input terminal of the integrated circuit 500. That is, the state signal input-output circuit 480 generates the state signal BUSY based on the control signal CNT4 output from the register control circuit 440, and outputs the state signal BUSY to another constituent via a terminal BUSY_io, and at the same time, outputs a signal input via a terminal BUSY_io to the register control circuit 440. Note that in FIG. 12, the control signal CNT4 output from the register control circuit 440 is illustrated as a control signal CNT4-out, and the control signal CNT4 output to the register control circuit 440 is illustrated as a control signal CNT4-in.

The voltage signal GVDD is supplied to a source terminal of the transistor 481. A drain terminal of the transistor 481 is electrically coupled to the input terminal of the inverter 482, one end of the resistor 483, and the terminal BUSY_io. The control signal CNT4-out output by the register control circuit 440 is input to a gate terminal of the transistor 481. The control signal CNT4-in is output from an output terminal of the inverter 482 to the register control circuit 440. The ground signal is supplied to the other end of the resistor 483. When the control signal CNT4 at the L level is input to the state signal input-output circuit 480 configured as described above, the state signal input-output circuit 480 supplies the voltage signal GVDD to the terminal BUSY_io. In other words, the state signal input-output circuit 480 outputs the state signal BUSY of the voltage signal GVDD. On the other hand, when the control signal CNT4 at the H level is input to the state signal input-output circuit 480, the state signal input-output circuit 480 supplies the ground signal to the terminal BUSY_io. In other words, the state signal input-output circuit 480 outputs the state signal BUSY of the ground signal. That is, the state signal input-output circuit 480 generates the state signal BUSY the H level of which is the voltage value of the voltage signal GVDD, and the L level of which is the ground signal in accordance with the logic level of the control signal CNT4, and then outputs the state signal BUSY to the other constituent.

The control signal CNT5 output by the register control circuit 440 is input to the abnormality signal input-output circuit 490. The abnormality signal input-output circuit 490 is electrically coupled to another constituent via a terminal ERR_io. The abnormality signal input-output circuit 490 outputs the abnormality signal ERR the logic level of which changes in accordance with the control signal CNT5 to thereby notify the other constituent of whether an abnormality has occurred in the drive circuit 52, and acquires the abnormality signal ERR output from the other constituent. Here, another constituent may be, for example, any one of the drive signal output circuits 50-1 to 50-6 provided to the liquid ejection apparatus 1, or may be the control circuit 100.

FIG. 13 is a diagram illustrating a configuration of the abnormality signal input-output circuit 490. The abnormality signal input-output circuit 490 includes a transistor 491, an inverter 492, and a resistor 493. Note that in the following description, it is assumed that the transistor 491 is a PMOS transistor. Further, the inverter 492 functions as a COMS input terminal of the integrated circuit 500. That is, the abnormality signal input-output circuit 490 generates the abnormality signal ERR based on the control signal CNT5 output from the register control circuit 440, and outputs the abnormality signal ERR via a terminal ERR_io, and at the same time, outputs a signal input via the terminal ERR_io to the register control circuit 440. Note that in FIG. 13, the control signal CNT5 output from the register control circuit 440 is illustrated as a control signal CNT5-out, and the control signal CNT5 output to the register control circuit 440 is illustrated as a control signal CNT5-in.

The voltage signal GVDD is supplied to a source terminal of the transistor 491. A drain terminal of the transistor 491 is electrically coupled to an input terminal of the inverter 492, one end of the resistor 493, and the terminal ERR_io. The control signal CNT5-out output by the register control circuit 440 is input to a gate terminal of the transistor 491. The control signal CNT5-in is output from an output terminal of the inverter 492 to the register control circuit 440. The ground signal is supplied to the other end of the resistor 493. When the control signal CNT5 at the L level is input to the abnormality signal input-output circuit 490 configured as described above, the abnormality signal input-output circuit 490 supplies the voltage signal GVDD to the terminal ERR_io. In other words, the abnormality signal input-output circuit 490 outputs the abnormality signal ERR of the voltage signal GVDD. On the other hand, when the control signal CNT5 at the H level is input to the abnormality signal input-output circuit 490, the abnormality signal input-output circuit 490 supplies the ground signal to the terminal ERR_io. In other words, the abnormality signal input-output circuit 490 outputs the abnormality signal ERR of the ground signal. That is, the abnormality signal input-output circuit 490 generates the abnormality signal ERR the H level of which is the voltage value of the voltage signal GVDD, and the L level of which is the ground signal in accordance with the logic level of the control signal CNT5, and then outputs the abnormality signal ERR to the other constituent.

As described hereinabove, the drive unit 10 in the present embodiment includes the drive circuit 52 that outputs the drive signal COM and the reference voltage signal output circuit 460 that outputs the reference voltage signal VBS. Specifically, the drive circuit 52 in the present embodiment includes the drive signal generation circuit 501 that generates the drive signal COM for driving the piezoelectric element 60 based on the base drive data signal do, the drive signal discharge circuit 450 that discharges the residual charge remaining in the propagation path of the drive signal COM, the reference voltage signal output circuit 460 that outputs the reference voltage signal VBS, and discharges the residual charge remaining in the propagation path of the reference voltage signal VBS, the VHV control signal output circuit 470 that controls the operation of the step-down circuit 130, the state signal input-output circuit 480 and the abnormality signal input-output circuit 490 that mutually propagate the state or the presence or absence of abnormality with another constituent, and the register control circuit 440 that controls the operations of the drive signal discharge circuit 450, the reference voltage signal output circuit 460, the VHV control signal output circuit 470, the state signal input-output circuit 480, and the abnormality signal input-output circuit 490 by switching the logic levels of the control signals CNT1 to CNT5.

Further, in the drive circuit 52 in the present embodiment, by the register control circuit 440 controlling the operations of the drive signal discharge circuit 450, the reference voltage signal output circuit 460, and the VHV control signal output circuit 470 with the control signals CNT1 to CNT3, it is possible to control the supply of the voltage signal VHV, the drive signal COM, and the reference voltage signal VBS to the print head 23 without the intervention of the control circuit 100. Thus, since the processing load on the control circuit 100 can be reduced, and the supply of the voltage signal VHV, the drive signal COM, and the reference voltage signal VBS to the print head 23 can be controlled at an appropriate timing and in a short time since the intervention of the control circuit 100 is omitted.

For example, when the operation mode of the liquid ejection apparatus 1 is a standby mode or a sleep mode in which the operation stops without ejecting the ink to the medium P, the register control circuit 440 controls the logic levels of the control signals CNT1 to CNT3 so that the drive signal discharge circuit 450 discharges the residual charge stored in the propagation path of the drive signal COM including the terminal COM-Out, the reference voltage signal output circuit 460 stops outputting the reference voltage signal VBS to the piezoelectric element 60, and releases the charge accumulated at the terminal VBS_o, and the VHV control signal output circuit 470 stops outputting the voltage signal VHV from the step-down circuit 130. Thus, the charges at both ends of the piezoelectric element 60 provided to the print head 23 are released. Therefore, even when the standby mode or the sleep mode in which the operation of the liquid ejection apparatus 1 is stopped continues for a long time, a possibility that an unintended voltage is applied to the piezoelectric element 60 provided to the print head 23, and thus, an unintended displacement is continuously applied to the piezoelectric element 60 provided to the print head 23 is reduced. As a result, the possibility that the drive characteristic of the piezoelectric element 60 changes is reduced, and the possibility that the ejection accuracy of the ink ejected by the drive of the piezoelectric element 60 decreases is reduced, and at the same time, the possibility that the abnormality occurs in the piezoelectric element 60 due to the unintended displacement applied to the piezoelectric element 60 is also reduced.

Further, at a timing at which the operation mode of the liquid ejection apparatus 1 makes the transition from the standby mode or the sleep mode described above to the drive mode in which the ink is ejected to the medium P, the register control circuit 440 sequentially switches the logic levels of the control signals CNT1 to CNT3 according to a predetermined operation sequence. This makes it possible to smoothly execute the transition of the operation mode of the liquid ejection apparatus 1, and at the same time, the possibility that the unintended voltage is applied to the piezoelectric element 60 provided to the print head 23 can be reduced even when making the transition of the operation mode.

Further, in the drive circuit 52 in the present embodiment, by the register control circuit 440 controlling the operations of the state signal input-output circuit 480 and the abnormality signal input-output circuit 490 with the control signals CNT4 to CNT5, it is possible to share the operation state and the presence or absence of the abnormality among the plurality of drive circuits 52 provided to the liquid ejection apparatus 1 and the head unit 5. Thus, in the drive circuit 52 in the present embodiment, when the liquid ejection apparatus 1 and the head unit 5 include the plurality of drive circuits 52, and when an abnormality occurs in any one of the plurality of drive circuits 52, the information of that abnormality can be acquired without the intervention of the control circuit 100. Thus, in the drive circuit 52 in the present embodiment, it is possible to execute stop processing of the drive circuit 52 at an appropriate timing and in a short time.

### 2.4 Configuration and Operation of Step-Down Circuit

Then, a configuration and an operation of the step-down circuit 130 will be described. FIG. 14 is a diagram illustrating an example of the configuration of the step-down circuit 130. As shown in FIG. 14, the step-down circuit 130 includes a VHV supply switching circuit 140, a first step-down circuit 150a, and a second step-down circuit 150b.

The step-down control signals VHVc1 to VHVc6 output by the respective drive signal output circuits 50-1 to 50-6 are input to the VHV supply switching circuit 140. The VHV supply switching circuit 140 outputs an enable signal ENvh which enables output of the voltage signal VHV when all the step-down control signals VHVc1 to VHVc6 input from the respective drive signal output circuits 50-1 to 50-6 include information which requests to output the voltage signal VHV, and outputs the enable signal ENvh which does not enable the output of the voltage signal VHV when at least one of the step-down control signals VHVc1 to VHVc6 input from the respective drive signal output circuits 50-1 to 50-6 includes information which does not request to output the voltage signal VHV. Such a VHV supply switching circuit 140 can be configured with a combination of logic circuits such as an AND circuit and an OR circuit.

The voltage signal VDC output by the control unit 2 and the enable signal ENvh output by the VHV supply switching circuit 140 are input to the first step-down circuit 150a. Then, the first step-down circuit 150a generates the voltage signal VHV obtained by stepping down the voltage value of the voltage signal VDC when the enable signal ENvh which enables the output of the voltage signal VHV is input, and stops generating the voltage signal VHV when the enable signal ENvh which does not enable the output of the voltage signal VHV is input. That is, the integrated circuit 500 provided to the drive circuit 52 controls whether to output the voltage signal VHV from the first step-down circuit 150a by outputting the step-down control signal VHVc.

The voltage signal VDC output by the control unit 2 and an enable signal ENvd are input to the second step-down circuit 150b. The enable signal ENvd is a signal for switching whether to enable the output of the voltage signal VDD from the second step-down circuit 150b, and is input from, for example, the control unit 2. Then, the second step-down circuit 150b generates the voltage signal VDD obtained by stepping down the voltage value of the voltage signal VDC when the enable signal ENvd which enables the output of the voltage signal VDD is input, and stops generating the voltage signal VDD when the enable signal ENvd which does not enable the output of the voltage signal VDD is input.

That is, the step-down circuit 130 provided to the drive unit 10 includes the first step-down circuit 150a that steps down the voltage value of the voltage signal VDC to output the voltage signal VHV, and the second step-down circuit 150b that steps down the voltage value of the voltage signal VDC to output the voltage signal VDD.

Here, as described above, the voltage signal VHV is used as the power supply voltage for the amplification when the drive circuit 52 generates the drive signal COM and the voltage for the level shift of the selection signals S1, S2, and S3 output by the decoder 216 of the drive signal selection circuit 200 to the high amplitude logic. That is, the voltage signal VHV is mainly used to drive the piezoelectric element 60 when the operation mode of the liquid ejection apparatus 1 is the drive mode in which the ink is ejected to the medium P. By controlling whether the first step-down circuit 150a outputs such a voltage signal VHV with the enable signal ENvh according to the step-down control signals VHVc1 to VHVc6 output by the respective drive signal output circuits 50-1 to 50-6, it is possible for the first step-down circuit 150a to output the voltage signal VHV only in the period in which the voltage signal VHV is used and when, for example, the operation mode of the liquid ejection apparatus 1 is the drive mode. Thus, it is possible to reduce the power consumption associated with the generation of the voltage signal VHV, and at the same time, the risk that an unintended voltage is applied to the piezoelectric element 60 due to a leakage current or the like that may occur along with the propagation of the voltage signal VHV is reduced, and further, the possibility that an unintended displacement is continuously applied to the piezoelectric element 60 provided to the print head 23 is also reduced. As a result, the possibility that the drive characteristic of the piezoelectric element 60 changes is reduced, and the possibility that the ejection accuracy of the ink ejected by the drive of the piezoelectric element 60 decreases is reduced, and at the same time, the possibility that the abnormality occurs in the piezoelectric element 60 due to the unintended displacement applied to the piezoelectric element 60 is also reduced.

On the other hand, the voltage signal VDD, which is a DC voltage signal lower in voltage value than the voltage signal VHV, is mainly used as a power supply voltage of the integrated circuit 500, the drive signal selection circuit 200, and so on provided to the control circuit 100 and the drive circuit 52. The control circuit 100, the integrated circuit 500, and the drive signal selection circuit 200 described above need to operate irrespectively of the operation mode of the liquid ejection apparatus 1. Therefore, the second step-down circuit 150b outputs the voltage signal VDD regardless of the operation mode of the liquid ejection apparatus 1. In the step-down circuit 130 in the present embodiment, the enable signal ENvd independent of the enable signal ENvh is input to the second step-down circuit 150b. Thus, the second step-down circuit 150b can continuously output the voltage signal VDD regardless of the operation state of the first step-down circuit 150a. Note that the enable signal ENvd input to the second step-down circuit 150b is not limited to when being input from the control unit 2, and may also be, for example, a signal fixed to a predetermined logic level which enables the output of the voltage signal VDD in the second step-down circuit 150b.

Here, an example of the configurations of the first step-down circuit 150a and the second step-down circuit 150b will be described. The first step-down circuit 150a and the second step-down circuit 150b have substantially the same configurations only different in voltage value of the signal to be output. Therefore, in the following description, only an example of the configuration of the first step-down circuit 150a will be described, and the description of an example of the configuration of the second step-down circuit 150b will be simplified or omitted.

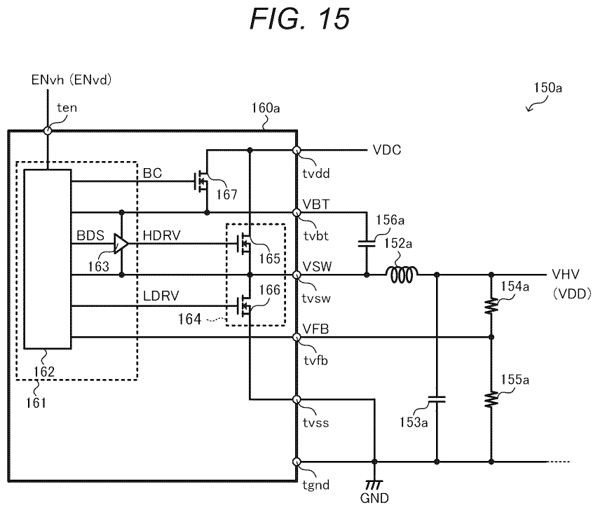

FIG. 15 is a diagram illustrating an example of the configuration of the first step-down circuit 150a. FIG. 15 illustrates a step-down switching regulator as an example of the first step-down circuit 150a. As illustrated in FIG. 15, the first step-down circuit 150a includes an integrated circuit 160a, a coil 152a, capacitors 153a, 156a, and resistors 154a, 155a.

The integrated circuit 160a includes terminals tvdd, tvbt, tvsw, tvfb, tvss, tgnd, and ten electrically coupled to various circuits provided to the first step-down circuit 150a. The integrated circuit 160a operates with the voltage signal VDC input via the terminal tvdd as the drive power. Then, by the enable signal ENvh which enables the operation of the first step-down circuit 150a being input to the integrated circuit 160a via the terminal ten, the integrated circuit 160a generates a switching signal VSW and outputs the switching signal VSW from the terminal tvsw. Further, the integrated circuit 160a includes a drive circuit 161, a switching circuit 164, and a transistor 167.

The drive circuit 161 includes a drive control circuit 162 and a level shift circuit 163. The enable signal ENvh and a feedback voltage signal VFB are input to the drive control circuit 162. The drive control circuit 162 outputs a base drive signal BDS the logic level of which is inverted in accordance with the voltage value of the feedback voltage signal VFB input thereto during a period in which the enable signal ENvh which enables the output of the voltage signal VHV is input. The base drive signal BDS output by the drive control circuit 162 is input to the level shift circuit 163. A boot voltage signal VBT and the switching signal VSW are input to the level shift circuit 163. The level shift circuit 163 shifts the H level voltage value of the base drive signal BDS input thereto to a voltage value of the boot voltage signal VBT, and at the same time, generates a drive signal HDRV obtained by shifting the L level voltage value of the base drive signal BDS input thereto to a voltage value of the switching signal VSW, and then outputs the drive signal HDRV. Further, the drive control circuit 162 outputs a drive signal LDRV the logic level of which is inverted in accordance with the voltage value of the feedback voltage signal VFB input thereto during a period in which the enable signal ENvh which enables the output of the voltage signal VHV is input.

The drive signal HDRV and the drive signal LDRV output by the drive circuit 161 are input to the switching circuit 164. The switching circuit 164 includes transistors 165, 166 which are n-channel type FETs (Field Effect Transistors). The drive signal HDRV output by the drive circuit 161 is supplied to a gate terminal of the transistor 165. The transistor 165 has a drain terminal electrically coupled to the terminal tvdd, and a source terminal electrically coupled to the terminal tvsw. Further, the drive signal LDRV output by the drive circuit 161 is supplied to the gate terminal of the transistor 166. The transistor 165 has a drain terminal electrically coupled to the terminal tvsw, and a source terminal electrically coupled to the terminal tvss. Further, the ground signal is supplied to the terminal tvss.

As described above, the source terminal of the transistor 165 and the drain terminal of the transistor 166 are coupled to each other, and the coupling point where the source terminal of the transistor 165 and the drain terminal of the transistor 166 are coupled to each other is electrically coupled to the terminal tvsw of the integrated circuit 160a. Then, when the drive signal HDRV at the H level supplied to the switching circuit: the transistor 165 becomes conductive between the drain terminal and the source terminal, and when the drive signal LDRV at the H level is supplied to the switching circuit 164, the transistor 166 becomes conductive between the drain terminal and the source terminal. Therefore, the switching circuit 164 outputs the voltage signal VDC from the terminal tvsw as the switching signal VSW when the drive signal HDRV at the H level is input, and outputs the ground signal from the terminal tvsw as the switching signal VSW when the drive signal LDRV at the H level is input.

That is, by the conduction state of each of the transistors 165, 166 being controlled in accordance with the drive signal HDRV and the drive signal LDRV output by the drive circuit 161, the switching circuit 164 outputs the switching signal VSW from the terminal tvsw as the coupling point where the source terminal of the transistor 165 and the drain terminal of the transistor 166 are coupled to each other. Here, in the following description, a state in which the drain terminal and the source terminal of the transistors 165, 166 are controlled to be conductive may be referred to as ON, and a state in which the drain terminal and the source terminal of the transistors 165, 166 are controlled to be non-conductive may be referred to as OFF in some cases.

Further, the drive control circuit 162 outputs a boost control signal BC the logic level of which is inverted at a timing synchronized with at least one of the base drive signal BDS and the drive signal LDRV. The boost control signal BC is supplied to a gate terminal of the transistor 167. The transistor 167 is a p-channel FET, and has a source terminal electrically coupled to the terminal tvdd and a drain terminal electrically coupled to the terminal tvbt. the transistor 167 becomes conductive between the source terminal and the drain terminal when the boost control signal BC at the L level is supplied to the gate terminal, and becomes non-conductive between the source terminal and the drain terminal when the boost control siganl BC at the H level is supplied to the gate terminal. Therefore, the transistor 167 supplies the voltage signal VDC to the terminal tvbt when the boost control signal BC at the L level is supplied to the gate terminal, and stops supplying the voltage signal VDC to the terminal tvbt when the boost control signal BC at the H level is supplied to the gate terminal. Here, in the following description, a state in which the source terminal and the drain terminal of the transistor 167 are controlled to be conductive may be referred to as ON, and a state in which the drain terminal and the source terminal of the transistor 167 are controlled to be non-conductive may be referred to as OFF in some cases.

One end of the coil 152a is electrically coupled to the terminal tvsw, and the other end of the coil 152a is electrically coupled to one end of the capacitor 153a. Further, the ground signal is supplied to the other end of the capacitor 153a. That is, the coil 152a and the capacitor 153a constitute a low-pass filter circuit. The switching signal VSW output via the terminal tvsw of the integrated circuit 160a is smoothed by the low-pass filter circuit formed of the coil 152a and the capacitor 153a. The first step-down circuit 150a outputs the signal smoothed by that low-pass filter circuit as the voltage signal VHV.

One end of the resistor 154a is electrically coupled to the other end of the coil 152a, and the other end of the resistor 154a is electrically coupled to one end of the resistor 155a. The ground signal is supplied to the other end of the resistor 155a. Further, a coupling point at which the other end of the resistor 154a and the one end of the resistor 155a are coupled to each other is electrically coupled to the terminal tvfb of the integrated circuit 160a. That is, the resistor 154a and the resistor 155a divide the voltage value of the voltage signal VHV, and feed back a signal having the voltage thus divided to the integrated circuit 160a as the feedback voltage signal VFB.

The drive control circuit 162 controls at least one of the time when the base drive signal BDS becomes at the high level, the time when the base drive signal BDS becomes at the low level, the time when the drive signal LDRV becomes at the high level, and the time when the drive signal LDRV becomes at the low level so that the voltage value of the feedback voltage signal VFB input thereto becomes a predetermined value.

Specifically, the drive control circuit 162 increases the ON duty of the base drive signal BDS to be output when the voltage value of the feedback voltage signal VFB input thereto is lower than a predetermined voltage value, and increases the ON duty of the drive signal LDRV to be output when the voltage value of the feedback voltage signal VFB input thereto is higher than the predetermined voltage value. Thus, the voltage value of the voltage signal VHV smoothed by the low-pass filter circuit formed of the coil 152a and the capacitor 153a is controlled.

Here, the ON duty is a proportion of the time during which the signal at the H level is output to the time period from when the signal to be output becomes at the H level to when the signal becomes at the H level again after the signal once becomes at the L level. For example, when the time period from when the signal to be output becomes at the H level, to when the signal becomes at the H level again after the signal once becomes at the L level is 100 ms, and the time during which the signal is at the H level is 30 ms, the ON duty is 30%. Further, increasing the ON duty means to increase the proportion of the time period during which the signal at the H level is output to the time period from when the signal to be output becomes at the H level to when the signal which once becomes at the L level becomes at the H level again, and it is possible to, for example, fix the time period from when the signal to be output becomes at the H level to when the signal once becomes at the L level and then becomes at the H level again, and elongate the time period during which the signal is at the H level out of that time period, it is possible to fix the time period during which the signal is at the L level while increasing the time period during which the signal is at the H level in a period from when the signal to be output becomes at the H level to when the signal once becomes at the L level and then becomes at the H level, and it is also possible to fix the time period during which the signal is at the H level while decreasing the time period during which the signal is at the L level in the period from when the signal to be output becomes at the H level to when the signal once becomes at the L level and then becomes at the H level.

One end of the capacitor 156a is electrically coupled to the terminal tvsw for outputting the switching signal VSW, and the other end of the capacitor 156a is electrically coupled to the terminal tvbt. A charge corresponding to a potential difference between the one end and the other end is accumulated in the capacitor 156a. Further, the capacitor 156a generates the boot voltage signal VBT the voltage value of which changes in accordance with a change in the voltage value of the switching signal VSW output from the terminal tvsw, and then outputs the boot voltage signal VBT from the other end.

As described above, the first step-down circuit 150a in the present embodiment includes the integrated circuit 160a, the coil 152a, and the capacitor 153a, and generates and outputs the voltage signal VHV obtained by stepping down the voltage value of the voltage signal VDC in accordance with the enable signal ENvh based on the step-down control signals VHVc1 to VHVc6 input from the drive signal output circuits 50-1 to 50-6.

Further, the first step-down circuit 150a in the present embodiment preferably has a so-called soft start function of gradually increasing the voltage value of the voltage signal VHV to be output toward a predetermined voltage value when the input enable signal ENvh is switched from the state in which the output of the voltage signal VHV is not enabled to the state in which the output of the voltage signal VHV is enabled. In other words, the first step-down circuit 150a has the soft start function of gradually increasing the voltage value of the voltage signal VHV when starting the output of the voltage signal VHV.

Specifically, when the enable signal ENvh input to the first step-down circuit 150a is switched from the state in which the output of the voltage signal VHV is not enabled to the state in which the output of the voltage signal VHV is enabled, the drive control circuit 162 gradually increases the ON duty of the base drive signal BDS to be output regardless of the voltage value of the feedback voltage signal VFB input thereto. Thus, the voltage value of the voltage signal VHV output by the first step-down circuit 150a gradually increases.

Then, when the voltage value of the voltage signal VHV output from the first step-down circuit 150a reaches a predetermined voltage value such as 42 V, the voltage value of the feedback voltage signal VFB input to the drive control circuit 162 reaches a predetermined voltage value. When the voltage value of the feedback voltage signal VFB input to the drive control circuit 162 reaches the predetermined value, the drive control circuit 162 switches the control of the ON duty of the base drive signal BDS to be output to the control with the voltage value of the feedback voltage signal VFB. Thus, the voltage value of the voltage signal VHV output by the first step-down circuit 150a is controlled to be constant at a predetermined voltage value.

As described hereinabove, by the first step-down circuit 150a executing the soft start immediately after the enable signal ENvh input to the first step-down circuit 150a is switched from the state in which the output of the voltage signal VHV is not enabled to the state in which the output of the voltage signal VHV is enabled, the possibility that inrush current occurs immediately after the start of the supply of the voltage signal VHV is reduced.

Here, as described above, the second step-down circuit 150b in the present embodiment has substantially the same configuration as that of the first step-down circuit 150a. Therefore, in the following description, it is assumed that the second step-down circuit 150b includes an integrated circuit 160b corresponding to the integrated circuit 160a, a coil 152b corresponding to the coil 152a, and a capacitor 153b corresponding to the capacitor 153a, and generates and then outputs the voltage signal VDD obtained by stepping down the voltage value of the voltage signal VDC.

### 3. Structure of Head Unit

Then, a structure of the head unit 5 in the present embodiment will be described. As described above, the head unit 5 includes the drive unit 10 and the ejection unit 20, and the drive unit 10 and the ejection unit 20 are electrically coupled to each other via the coupling member 30. An example of each of the structure of the drive unit 10 and the structure of the ejection unit 20 will be described below.

### 3.1 Structure of Ejection Unit

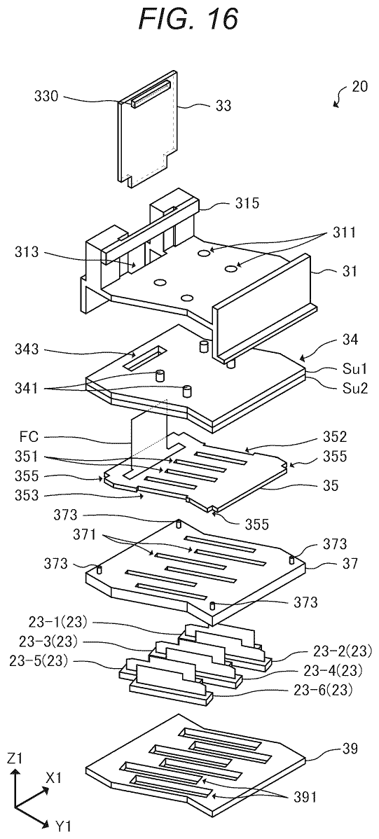

First, an example of the structure of the ejection unit 20 provided to the head unit 5 will be described. FIG. 16 is a diagram showing the structure of the ejection unit 20. Here, in the following description, X1 axis, Y1 axis, and Z1 axis orthogonal to each other are used. Further, in the following description, in some cases, the tip side of the arrow along the X1 axis in the drawing is referred to as +X1 side, the base side is referred to as −X1 side, the tip side of the arrow along the Y1 axis in the drawing is referred to as +Y1 side, the base side is referred to as −Y1 side, and the tip side of the arrow along the Z1 axis in the drawing is referred to as +Z1 side, and the base side is referred to as −Z1 side.

As shown in FIG. 16, the ejection unit 20 includes a housing 31, a collective substrate 33, a flow channel structure 34, a head substrate 35, a distribution flow channel 37, a fixation plate 39, and the print heads 23-1 to 23-6. In the ejection unit 20, the flow channel structure 34, the head substrate 35, the distribution flow channel 37, and the fixation plate 39 are stacked in the order of the fixation plate 39, the distribution flow channel 37, the head substrate 35, and the flow channel structure 34 along the Z1 axis from the −Z1 side toward the +Z1 side, and the housing 31 is located on the periphery of the flow channel structure 34, the head substrate 35, the distribution flow channel 37, and the fixation plate 39 so as to support the flow channel structure 34, the head substrate 35, the distribution flow channel 37, and the fixation plate 39. Further, the collective substrate 33 is erected at the +Z1 side of the housing 31 in the state of being held by the housing 31, and the print heads 23-1 to 23-6 are located between the distribution flow channel 37 and the fixation plate 39 so as to partially be exposed to the outside of the ejection unit 20.

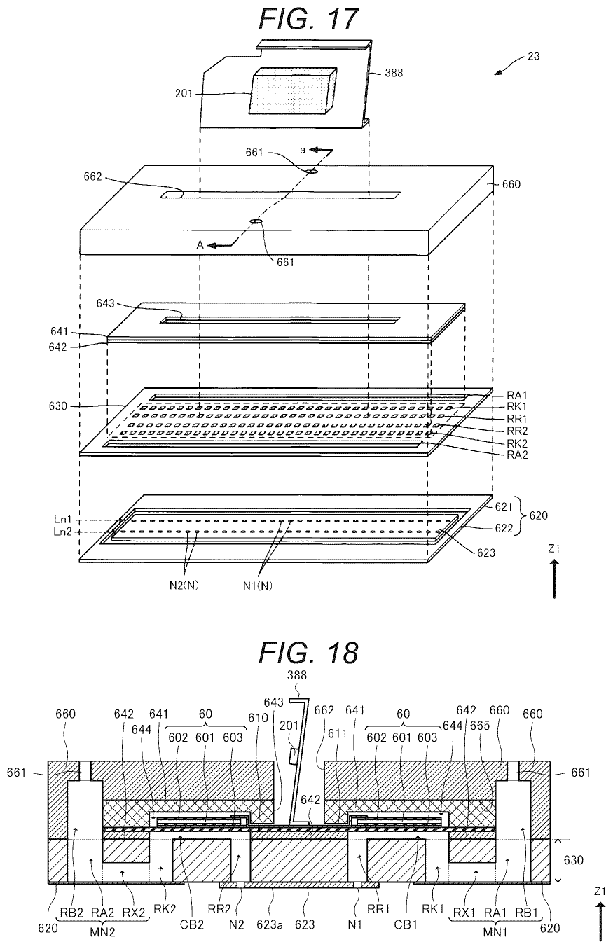

As a preparation of the description of the structure of the ejection unit 20, first, the structure of the print head 23 provided to the ejection unit 20 will be described. FIG. 17 is a diagram illustrating an example of the structure of the print head 23. Further, FIG. 18 is a diagram illustrating an example of a cross-sectional surface of the print head 23. Here, FIG. 18 is a cross-sectional view of the print head 23 when being cut along the line A-a shown in FIG. 17. Note that the line A-a shown in FIG. 17 is a virtual line segment passing through introduction paths 661 provided to the print head 23 and passing through a nozzle N1 and a nozzle N2.

As illustrated in FIGS. 17 and 18, the print head 23 includes a plurality of nozzles N1 arranged side by side and a plurality of nozzles N2 arranged side by side. The total number of nozzles N1 and nozzles N2 provided to the print head 23 is n which is the same as the number of ejection parts 600 provided to the print head 23. Note that the description will be presented assuming that the number of nozzles N1 provided to the print head 23 is the same as the number of nozzles N2 provided to the print head 23. That is, the print head 23 has n/2 nozzles N1 and n/2 nozzles N2. Further, in the following description, the nozzles N1, N2 may be simply referred to as nozzles N in some cases when not required to be distinguished from each other.

The print head 23 includes a wiring member 388, a case 660, a protective substrate 641, a flow channel forming substrate 642, a communication plate 630, a compliance substrate 620, and a nozzle plate 623.

In the flow channel forming substrate 642, pressure chambers CB1 partitioned by a plurality of partition walls are arranged side by side so as to correspond to the nozzles N1 by performing anisotropic etching from one surface side, and pressure chambers CB2 partitioned by a plurality of partition walls are arranged side by side so as to correspond to the nozzles N2 by performing anisotropic etching from the one surface side. Here, in the following description, the pressure chambers CB1, CB2 may be simply referred to as pressure chambers CB when not required to be distinguished from each other.

The nozzle plate 623 is located at the −21 side of the flow channel forming substrate 642. The nozzle plate 623 is provided with a nozzle array Ln1 formed of n/2 nozzles N1 and a nozzle array Ln2 formed of n/2 nozzles N2. Here, in the following description, a surface at the −21 side of the nozzle plate 623 on which the nozzles N are opened may be referred to as a liquid jet surface 623a in some cases.

The communication plate 630 is located at the −Z1 side of the flow channel forming substrate 642 and at the +Z1 side of the nozzle plate 623. The communication plate 630 is provided with nozzle communication channels RR1 each communicating the pressure chamber CB1 with the nozzle N1, and nozzle communication channels RR2 each communicating the pressure chamber CB2 and the nozzle N2 with each other. Further, the communication plate 630 is provided with pressure chamber communication channels RK1 each communicating the pressure chamber CB1 with a manifold MN1, and pressure chamber communication channels RK2 each communicating the pressure chamber CB2 with a manifold MN2 independently so as to correspond respectively to the pressure chambers CB1, CB2.

The manifold MN1 includes a supply communication channel RA1 and connecting communication channels RX1. The supply communication channel RA1 is formed so as to penetrate the communication plate 630 along the Z1 axis, while the connecting communication channel RX1 is formed partway in a direction along the Z1 axis so as to open at the nozzle plate 623 side of the communication plate 630 without penetrating the communication plate 630 along the Z1 axis. Similarly, the manifold MN2 includes a supply communication channel RA2 and connecting communication channels RX2. The supply communication channel RA2 is formed so as to penetrate the communication plate 630 along the Z1 axis, while the connecting communication channel RX2 is formed partway in a direction along the Z1 axis so as to open at the nozzle plate 623 side of the communication plate 630 without penetrating the communication plate 630 along the Z1 axis. Further, the connecting communication channel RX1 provided to the manifold MN1 communicates with the pressure chamber CB1 corresponding thereto with the pressure chamber communication channel RK1, and the connecting communication channel RX2 provided to the manifold MN2 communicates with the pressure chamber CB2 corresponding thereto with the pressure chamber communication channel RK2.

Here, in the following description, in some cases, the nozzle communication channels RR1, RR2 may be simply referred to as nozzle communication channels RR when not required to be distinguished from each other, the manifolds MN1, MN2 may be simply referred to as manifolds MN when not required to be distinguished from each other, the supply communication channels RA1, RA2 may be simply referred to as supply communication channels RA when not required to be distinguished from each other, and the connecting communication channels RX1, RX2 may be simply referred to as connecting communication channels RX when not required to be distinguished from each other.

A vibration plate 610 is located on a surface at the +Z1 side of the flow channel forming substrate 642. Further, n piezoelectric elements 60 corresponding to the nozzles N1 and N2 are formed in two rows on the surface at the +Z1 side of the vibration plate 610.

The piezoelectric element 60 includes a piezoelectric body 601 and a pair of electrodes 602, 603 disposed so as to sandwich the piezoelectric body 601. The electrode 602 and the piezoelectric body 601 are formed on the surface at the +Z1 side of the vibration plate 610 for each of the pressure chambers CB, and the electrode 603 is configured as a common electrode common to the pressure chambers on the surface at the +Z1 side of the vibration plate 610. Further, by supplying the drive signal VOUT to the electrode 602 from the drive signal selection circuit 200, and supplying the reference voltage signal VBS to the electrode 603 as the common electrode, the piezoelectric element 60 is driven so that the piezoelectric body 601 is displaced in an up-down direction.

The protective substrate 641 is bonded to the surface at the +Z1 side of the flow channel forming substrate 642. The protective substrate 641 forms a protective space 644 for protecting the piezoelectric elements 60. Further, the protective substrate 641 is provided with a through hole 643 penetrating along the Z1 axis. A lead electrode 611 extracted from each of the electrodes 602, 603 of the piezoelectric element 60 is extended so that an end portion of the lead electrode 611 is exposed inside the through hole 643. Further, the wiring member 388 is electrically coupled to the lead electrode 611 exposed inside the through hole 643.

Further, the case 660 that defines a part of the manifold MN communicating with the plurality of pressure chambers CB is fixed to the protective substrate 641 and the communication plate 630. The case 660 is bonded to the protective substrate 641 and is also bonded to the communication plate 630. Specifically, the case 660 has a recess 665 on the surface at the −21 side, and the recess 665 houses the flow channel forming substrate 642 and the protective substrate 641. The recess 665 has a larger opening area than the area of a surface where the protective substrate 641 is bonded to the flow channel forming substrate 642. The flow channel forming substrate 642 and so on are housed in the recess 665. Further, in a state where the flow channel forming substrate 642 and so on are housed in the recess 665, the opening surface at the −21 side of the recess 665 is sealed with the communication plate 630. Accordingly, the case 660, the flow channel forming substrate 642, and the protective substrate 641 define a supply communication channel RB1 and a supply communication channel RB2 in an outer peripheral portion of the flow channel forming substrate 642. Here, the supply communication channel RB1 and the supply communication channel RB2 may be simply referred to as supply communication channels RB when not required to be distinguished from each other.

Further, the compliance substrate 620 is disposed on a surface of the communication plate 630 where the supply communication channels RA and the coupling communication channels RX are opened. The openings of the supply communication channels RA and the connecting communication channels RX are sealed with the compliance substrate 620. Such a compliance substrate 620 includes a sealing film 621 and a fixation substrate 622. The sealing film 621 is formed of a thin film having flexibility or the like, and the fixation substrate 622 is formed of a rigid material such as metal including stainless steel.

Further, the case 660 is provided with the introduction paths 661 for supplying the ink to the manifolds MN. Further, the case 660 is provided with a connection port 662 which is an opening communicating with the through hole 643 of the protective substrate 641 and penetrating along the Z1 axis, and through which the wiring member 388 is inserted.

The wiring member 388 is a flexible member for electrically coupling the print head 23 and the head substrate 35 to each other, and an FPC, for example, can be used therefor. An integrated circuit 201 is mounted on the wiring member 388 by COF (Chip On Film) mounting. At least a part of the drive signal selection circuit 200 described above is implemented in the integrated circuit 201.

In the print head 23 configured as described above, the wiring member 388 propagates the voltage signal VHV, the drive signals COMA, COMB, and COMC, the reference voltage signal VBS, the clock signal SCK, the print data signal SI, and the latch signal LAT. Among these, the voltage signal VHV, the drive signals COMA, COMB, and COMC, the clock signal SCK, the print data signal SI, and the latch signal LAT are input to the drive signal selection circuit 200 including the integrated circuit 201 provided to the wiring member 388. Further, the drive signal selection circuit 200 generates the drive signal VOUT by selecting or deselecting the drive signals COMA, COMB, and COMC based on the voltage signal VHV, the clock signal SCK, the print data signal SI, and the latch signal LAT input thereto, and then outputs the drive signal VOUT. The drive signal VOUT output by the drive signal selection circuit 200 propagates through the wiring member 388 and is then supplied to the electrode 602 via the lead electrode 611. Further, the reference voltage signal VBS propagates through the wiring member 388 and is then supplied to the electrode 603 via the lead electrode 611. Thus, the piezoelectric body 601 is deformed in accordance with the potential difference between the drive signal VOUT supplied to the electrode 602 and the reference voltage signal VBS supplied to the electrode 603. That is, the piezoelectric element 60 is driven. Due to the drive of the piezoelectric element 60, the vibration plate 610 provided with the piezoelectric element 60 is deformed in the up-down direction. Accordingly, the internal pressure of the corresponding pressure chamber CB changes, and the ink stored inside the pressure chamber CB is ejected from the nozzle N in accordance with the change in the internal pressure of the pressure chamber CB.

In the print head 23 configured as described above, the configuration including the nozzle N, the nozzle communication channel RR, the pressure chamber CB, the piezoelectric element 60, and the vibration plate 610 corresponds to the ejection part 600 described above. That is, the print head 23 includes a plurality of ejection parts 600 each including the piezoelectric element 60, and ejecting the ink in accordance with the drive of the piezoelectric element 60.

That is, the ejection unit 20 includes the print head 23-1 including the piezoelectric element 60 one end of which is supplied with the drive signal VOUT based on the drive signals COMA1, COMB1, and COMC1, and the other end of which is supplied with the reference voltage signal VBS1 constant in voltage value, and ejecting the ink in accordance with the drive of the piezoelectric element 60, the print head 23-2 including the piezoelectric element 60 one end of which is supplied with the drive signal VOUT based on the drive signals COMA2, COMB2, and COMC2, and the other end of which is supplied with the reference voltage signal VBS2 constant in voltage value, and ejecting the ink in accordance with the drive of the piezoelectric element 60, the print head 23-3 including the piezoelectric element 60 one end of which is supplied with the drive signal VOUT based on the drive signals COMA3, COMB3, and COMC3, and the other end of which is supplied with the reference voltage signal VBS3 constant in voltage value, and ejecting the ink in accordance with the drive of the piezoelectric element 60, the print head 23-4 including the piezoelectric element 60 one end of which is supplied with the drive signal VOUT based on the drive signals COMA4, COMB4, and COMC4, and the other end of which is supplied with the reference voltage signal VBS4 constant in voltage value, and ejecting the ink in accordance with the drive of the piezoelectric element 60, the print head 23-5 including the piezoelectric element 60 one end of which is supplied with the drive signal VOUT based on the drive signals COMA5, COMB5, and COMC5, and the other end of which is supplied with the reference voltage signal VBS5 constant in voltage value, and ejecting the ink in accordance with the drive of the piezoelectric element 60, and the print head 23-6 including the piezoelectric element 60 one end of which is supplied with the drive signal VOUT based on the drive signals COMA6, COMB6, and COMC6, and the other end of which is supplied with the reference voltage signal VBS6 constant in voltage value, and ejecting the ink in accordance with the drive of the piezoelectric element 60.

Going back to FIG. 16, the fixation plate 39 is located at the −Z1 side of the print heads 23-1 to 23-6. The print heads 23-1 to 23-6 are fixed to the fixation plate 39. Specifically, the fixation plate 39 includes six opening portions 391 which penetrate the fixation plate 39 along the Z1 axis and correspond respectively to the print heads 23-1 to 23-6. The print heads 23-1 to 23-6 are fixed to the fixation plate 39 so that the liquid jet surfaces 623a are exposed from the six opening portions 391, respectively.

The distribution flow channel 37 is located at the +Z1 side of the print heads 23-1 to 23-6. Four introduction parts 373 are disposed on a surface at the +Z1 side of the distribution flow channel 37. The four introduction parts 373 are flow path pipes protruding from the surface at the +Z1 side of the distribution flow channel 37 toward the +Z1 side along the Z1 axis, and communicate with flow path holes (not illustrated) provided to a surface at the −Z1 side of the flow channel structure 34. Further, flow path pipes (not shown) to be communicated with the four introduction parts 373 are located on a surface at the −21 side of the distribution flow channel 37. The flow path pipes (not shown) located on the surface at the −21 side of the distribution flow channel 37 communicate with the introduction paths 661 provided to each of the print heads 23-1 to 23-6. Further, the distribution flow channel 37 has six opening portions 371 penetrating along the Z1 axis. The wiring members 388 respectively provided to the print heads 23-1 to 23-6 are inserted into the six opening portions 371, respectively.

The head substrate 35 is located at the +Z1 side of the distribution flow channel 37. A wiring member FC to be electrically coupled to the collective substrate 33 described later is attached to the head substrate 35. Further, four opening portions 351 and cutout portions 352, 353 are provided to the head substrate 35. The wiring members 388 provided to the print heads 23-2 to 23-5 are respectively inserted through the four opening portions 351 and are electrically coupled to the head substrate 35 with solder or the like. Further, the wiring member 388 provided to the print head 23-1 passes through the cutout portion 352, and the wiring member 388 provided to the print head 23-6 passes through the cutout portion 353. The wiring members 388 which are respectively provided to the print heads 23-1, 23-6, and respectively pass through the cutout portions 352, 353 are electrically coupled to the head substrate 35 with solder or the like.

Further, four cutout portions 355 are formed at four corners of the head substrate 35. The introduction parts 373 pass through the four cutout portions 355. The four introduction parts 373 having passed through the cutout portions 355 are coupled to the flow channel structure 34 located at the +Z1 side of the head substrate 35.

The flow channel structure 34 includes a flow channel plate Su1 and a flow channel plate Su2. The flow channel plate Su1 and the flow channel plate Su2 are stacked along the Z1 axis in a state where the flow channel plate Su1 is located at the +Z1 side and the flow channel plate Su2 is located at the −Z1 side, and are bonded to each other with an adhesive or the like. Further, the flow channel structure 34 has four introduction parts 341 protruding toward the +Z1 side along the Z1 axis on the surface at the +Z1 side. The four introduction parts 341 communicate with flow path holes not shown provided to a surface at the −21 side of the flow channel structure 34 via ink flow channels formed inside the flow channel structure 34. The flow path holes (not shown) provided to the surface at the −21 side of the flow channel structure 34 communicate with the four introduction parts 373. Further, through hole 343 penetrating along the Z1 axis is provided to the flow channel structure 34. The wiring member FC to be electrically coupled to the head substrate 35 is inserted through the through hole 343.

Here, inside the flow channel structure 34, in addition to the ink flow channel that communicates the introduction part 341 with a flow path hole (not shown) formed on a surface at the −Z1 side, a capture filter or the like for capturing foreign matters contained in the ink flowing through the ink flow channel may be provided.

The housing 31 is located so as to cover the periphery of the flow channel structure 34, the head substrate 35, the distribution flow channel 37, and the fixation plate 39 to support the flow channel structure 34, the head substrate 35, the distribution flow channel 37, and the fixation plate 39. The housing 31 includes four opening portions 311, a collective substrate insertion portion 313, and a holding member 315.

The four introduction parts 341 provided to the flow channel structure 34 are inserted into the four opening portions 311, respectively. Further, the four introduction parts 341 having been inserted through the four opening portions 311 are supplied with the ink from the liquid container 3 via a tube or the like (not shown).

The holding member 315 clamps the collective substrate 33 with the housing 31 in a state in which a part of the collective substrate 33 has passed through the collective substrate insertion portion 313. The collective substrate 33 is provided with a coupling part 330. The coupling member 30 that propagates various signals such as the voltage signals VHV, VDD, the data signal DATA, the drive signals COMA, COMB, and COMC, the reference voltage signal VBS, and other power supply voltages output by the drive unit 10 is attached to the coupling part 330. Further, the wiring member FC provided to the head substrate 35 is electrically coupled to the collective substrate 33. Thus, the collective substrate 33 and the head substrate 35 are electrically coupled. Here, the collective substrate 33 may be provided with a semiconductor device corresponding to the restoration circuit 220 described above. Further, although FIG. 16 illustrates when a single coupling part 330 is provided to the collective substrate 33, the collective substrate 33 may include a plurality of coupling parts 330.

In the ejection unit 20 configured as described above, by the liquid container 3 and the introduction parts 341 communicating with each other via tubes or the like (not illustrated), the ink stored in the liquid container 3 is supplied to the ejection unit 20. The ink supplied to the ejection unit 20 is guided to the flow path hole (not shown) provided to the surface at the −Z1 side of the flow channel structure 34 via an ink flow channel formed inside the flow channel structure 34, and then supplied to the four introduction parts 373 provide to the distribution flow channel 37. The ink supplied to the distribution flow channel 37 is distributed so as to correspond to each of the print heads 23-1 to 23-6 in an ink flow channel (not shown) formed inside the distribution flow channel 37, and is then supplied to the introduction paths 661 provided to the corresponding print heads 23-1 to 23-6. Further, the ink supplied to the print heads 23-1 to 23-6 via the introduction paths 661 is stored in the pressure chamber CB provided to the ejection part 600.

Further, various signals including the voltage signals VHV, VDD, the drive signals COMA1 to COMA6, COMB1 to COMB6, and COMC1 to COMC6, the reference voltage signals VBS1 to VBS6, and the data signal DATA output by the drive unit 10 propagate through the coupling member 30 and are input to the ejection unit 20 via the coupling part 330. Various signals including the drive signals COMA1 to COMA6, COMB1 to COMB6, and COMC1 to COMC6, the reference voltage signals VBS1 to VBS6, and the data signal DATA input to the ejection unit 20 propagate through the collective substrate 33 and the head substrate 35. On this occasion, the restoration circuit 220 generates the clock signals SCK1 to SCK6, the print data signals SI1 to SI6, and the latch signals LAT1 to LAT6 corresponding respectively to the print heads 23-1 to 23-6 from the data signal DATA, and separates these signals so as to correspond respectively to the print heads 23-1 to 23-6. Then, the voltage signals VHV, VDD, the drive signals COMA1 to COMA6, COMB1 to COMB6, and COMC1 to COMC6, the reference voltage signals VBS1 to VBS6, the clock signals SCK1 to SCK6, the print data signals SI1 to SI6, and the latch signals LAT1 to LAT6 are respectively input to the wiring members 388 provided to the print heads 23-1 to 23-6 corresponding respectively to these signals. The voltage signals VHV, VDD, the drive signals COMA, COMB, and COMC, the reference voltage signal VBS, the clock signal SCK, the print data signal SI, and the latch signal LAT supplied to the wiring member 388 propagate through the wiring member 388. On this occasion, the integrated circuit 201 which includes the drive signal selection circuit 200, and is provided to the wiring member 388 generates the drive signals VOUT corresponding respectively to the n ejection parts 600, and supplies the drive signals VOUT to the electrodes 602 of the piezoelectric elements 60 provided to the corresponding ejection parts 600. Thus, the n piezoelectric elements 60 are individually driven in accordance with the drive signals VOUT. As a result, the ink stored in the pressure chamber CB corresponding to the piezoelectric element 60 is ejected from the corresponding nozzle N.

### 3.2 Structure of Drive Unit

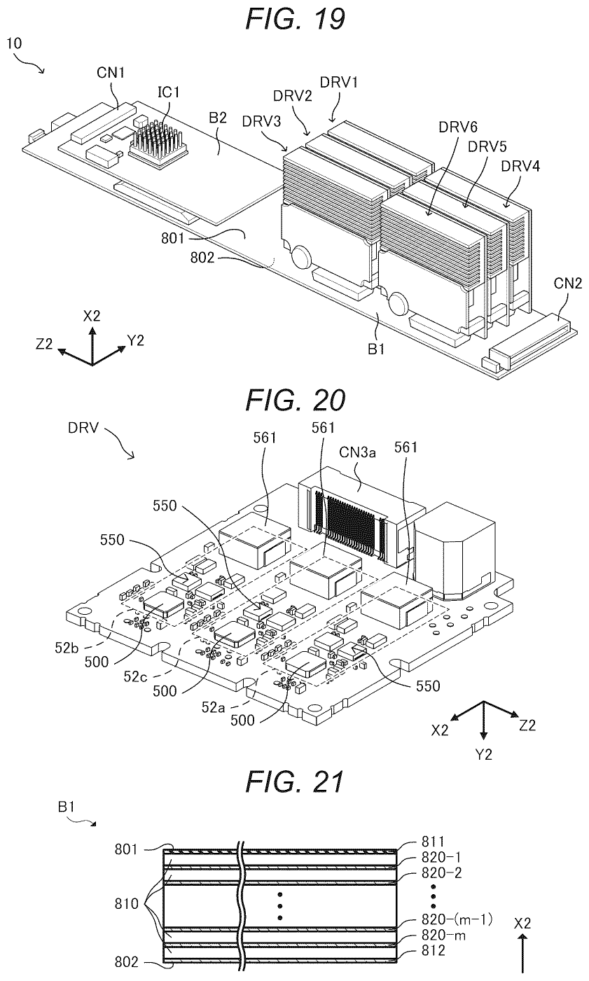

Then, a structure of the drive unit 10 provided to the head unit 5 will be described. Here, in FIGS. 19 and 20, an X2 axis, a Y2 axis, and a Z2 axis orthogonal to each other are illustrated as axes independent of the X1 axis, the Y1 axis, and the Z1 axis described above. Further, in the following description, in some cases, the tip side of the arrow along the X2 axis in the drawing is referred to as +X2 side, the base side is referred to as −X2 side, the tip side of the arrow along the Y2 axis in the drawing is referred to as +Y2 side, the base side is referred to as −Y2 side, and the tip side of the arrow along the Z2 axis in the drawing is referred to as +Z2 side, and the base side is referred to as −Z2 side.

FIG. 19 is a diagram showing the structure of the drive unit 10. As shown in FIG. 19, the drive unit 10 includes a base substrate B1, a conversion circuit board B2, and drive circuit modules DRV1 to DRV6.

The base substrate B1 includes a surface 801 and a surface 802 which is a reverse side of the surface 801 and is located so as to face the surface 801. The base substrate B1 is located so that the surface 801 and the surface 802 extend along the Y2−Z2 plane formed by the Y2 axis and the Z2 axis, and the surface 801 is located at the +X2 side and the surface 802 is located at the −X2 side. Note that the base substrate B1 will be described later in detail.

The conversion circuit board B2 is located at the surface 801 side of the base substrate B1, and at the +X2 side, and is located such that the component mounting surface on which various electronic components are mounted extends along the Y2−Z2 plane. The conversion circuit board B2 is electrically coupled to the base substrate B1 via the BtoB connector at the −X2 side in the component mounting surface. Further, the conversion circuit board B2 is fixed to the base substrate B1 with a single screw or a plurality of screws.

A connector CN1 and an integrated circuit IC1 are disposed on a surface at the +X2 side in the component mounting surface of the conversion circuit board B2. The connector CN1 is located at the +Z2 side of the conversion circuit board B2. A cable such as an FFC for electrically coupling the drive unit 10 and the control unit 2 to each other is attached to the connector CN1. The integrated circuit IC1 is located at the +Z2 side of the connector CN1. At last a part of the control circuit 100 and the conversion circuit 120 described above is implemented in the integrated circuit IC2.

Various signals including the image information signal IP output by the control unit 2 are input to the drive unit 10 via the connector CN1. The various signals including the image information signal IP input to the drive unit 10 propagate through the conversion circuit board B2 and are then input to the integrated circuit IC1. The integrated circuit IC1 generates various signals including the data signal DATA and the base drive data signals dA1 to dA6, dB1 to dB6, and dC1 to dC6 based on the image information signal IP input thereto. Then, the various signals including the data signal DATA and the base drive data signals dA1 to dA6, dB1 to dB6, and dC1 to dC6 generated in the integrated circuit IC1 propagate through the conversion circuit board B2 and are then output to the base substrate B1 via the BtoB connector electrically coupled to the base substrate B1.

The drive circuit modules DRV1 to DRV6 are located at the surface 801 side of the base substrate B1 and at the −22 side of the conversion circuit board B2. Specifically, the drive circuit modules DRV1 to DRV3 are located at the surface 801 side of the base substrate B1, and at the −Z2 side of the conversion circuit board B2, in the order of the drive circuit module DRV1, the drive circuit module DRV2, and the drive circuit module DRV3 along the Y2 axis from the +Y2 side toward the −Y2 side in an erected state with respect to the base substrate B1 at intervals from each other. Further, the drive circuit modules DRV4 to DRV6 are located at the surface 801 side of the base substrate B1, and at the −22 side of the drive circuit modules DRV1 to DRV3, in the order of the drive circuit module DRV4, the drive circuit module DRV5, and the drive circuit module DRV6 along the Y2 axis from the +Y2 side toward the −Y2 side in an erected state with respect to the base substrate B1 at intervals from each other. On this occasion, each of the drive circuit modules DRV1 to DRV6 is fixed and electrically coupled to the base substrate B1 via the corresponding BtoB connector. Note that the drive circuit modules DRV1 to DRV6 may be fixed to the base substrate B1 using a fixation member such as a screw in addition to the BtoB connector.

Each of the drive circuit modules DRV1 to DRV6 located as described above includes the drive signal output circuits 50-1 to 50-6 described above. Specifically, the drive circuit module DRV1 includes the drive signal output circuit 50-1, the drive circuit module DRV2 includes the drive signal output circuit 50-2, the drive circuit module DRV3 includes the drive signal output circuit 50-3, the drive circuit module DRV4 includes the drive signal output circuit 50-4, the drive circuit module DRV5 includes the drive signal output circuit 50-5, and the drive circuit module DRV6 includes the drive signal output circuit 50-6. Further, the drive circuit module DRV1 outputs the drive signals COMA1, COMB1, and COMC1 and the reference voltage signal VBS1 generated by the drive signal output circuit 50-1 to the base substrate B1 via the corresponding BtoB connector, and similarly, the drive circuit module DRVi outputs the drive signals COMAi, COMBi, COMCi and the reference voltage signal VBSi generated by the drive signal output circuit 50-i to the base substrate B1 via the corresponding BtoB connector.

Here, the drive circuit modules DRV1 to DRV6 are all substantially the same in configuration. Therefore, the drive circuit modules DRV1 to DRV6 may be simply referred to as drive circuit modules DRV in some cases when not required to be distinguished from each other. In this case, the description will be presented assuming that the drive circuit module DRV includes the drive signal output circuit 50 as one of the drive signal output circuits 50-1 to 50-6, and outputs the drive signals COMA, COMB, and COMC, and the reference voltage signal VBS to the base substrate B1 via the corresponding BtoB connector.

Here, an example of a structure of the drive circuit module DRV will be described. FIG. 20 is a diagram illustrating an example of the structure of the drive circuit module DRV. As shown in FIG. 20, the drive circuit module DRV includes drive circuits 52a, 52b, and 52c provided to the drive signal output circuit 50, a connector CN3a, and a drive circuit board DRB on which the drive circuits 52a, 52b, and 52c and the connector CN3a are mounted.

The drive circuit board DRB is a circuit board on which various electronic components are mounted, and is located such that a component mounting surface extends along the X2−Z2 plane formed by the X2 axis and the Z2 axis.

The drive circuits 52a, 52b, and 52c are arranged side by side along the Z2 axis on a surface at the −Y2 side of the drive circuit board DRB.

Specifically, in the drive circuit 52a, the integrated circuit 500, the amplifier circuit 550, and the coil 561 provided to the drive circuit 52a are arranged side by side in the order of the coil 561, the amplifier circuit 550, and the integrated circuit 500 from the −X2 side toward the +X2 side along the X2 axis. On this occasion, the transistors 551, 552 provided to the amplifier circuit 550 of the drive circuit 52a are arranged side by side along the Z2 axis. Further, in the drive circuit 52b, the integrated circuit 500, the amplifier circuit 550, and the coil 561 provided to the drive circuit 52b are arranged side by side in the order of the coil 561, the amplifier circuit 550, and the integrated circuit 500 from the −X2 side toward the +X2 side along the X2 axis at the −22 side of the drive circuit 52a. On this occasion, the transistors 551, 552 provided to the amplifier circuit 550 of the drive circuit 52b are arranged side by side along the Z2 axis. Further, in the drive circuit 52c, the integrated circuit 500, the amplifier circuit 550, and the coil 561 provided to the drive circuit 52c are arranged side by side in the order of the coil 561, the amplifier circuit 550, and the integrated circuit 500 from the −X2 side toward the +X2 side along the X2 axis at the −22 side of the drive circuit 52a and at the +Z2 side of the drive circuit 52b. On this occasion, the transistors 551, 552 provided to the amplifier circuit 550 of the drive circuit 52c are arranged side by side along the Z2 axis. That is, the drive circuits 52a, 52b, and 52c are arranged side by side on the surface at the −Y2 side of the drive circuit board DRB in the order of the drive circuit 52a, the drive circuit 52c, and the drive circuit 52b from the +Z2 side toward the −22 side along the Z2 axis.

On this occasion, the integrated circuits 500 provided respectively to the drive circuits 52a, 52b, and 52c are arranged side by side along the Z2 axis, the amplifier circuits 550 provided respectively to the drive circuits 52a, 52b, and 52c are arranged side by side along the Z2 axis, and the coils 561 provided respectively to the drive circuits 52a, 52b, and 52c are arranged side by side along the Z2 axis.

As described above, the voltage amplitudes of the drive signal COMA and the drive signal COMB are larger than the voltage amplitude of the drive signal COMC, and accordingly, the amounts of the currents occurring due to the propagations of the drive signals COMA, COMB are larger than the amount of the current occurring due to the propagation of the drive signal COMC. Therefore, the heat generation amount of the drive circuit 52a that outputs the drive signal COMA and the heat generation amount of the drive circuit 52b that outputs the drive signal COMB are larger than the heat generation amount of the drive circuit 52c that outputs the drive signal COMC. By disposing the drive circuit 52c smaller in heat generation amount between the drive circuits 52a, 52b larger in heat generation amount as described above, the drive circuit 52a and the drive circuit 52b are arranged at a distance. Accordingly, the possibility that the heat generated in the drive circuit 52a and the heat generated in the drive circuit 52b interfere with each other to generate local heat concentration in the drive circuit module DRV is reduced.

The connector CN3a is located along a side at the −X2 side of the drive circuit board DRB on the surface at the −Y2 side of the drive circuit board DRB, and at the −X2 side of the drive circuits 52a, 52b, and 52c. The connector CN3a is fitted to a connector CN3b (to be described later) provided to the base substrate B1, whereby the drive circuit board DRB and the base substrate B1 are electrically coupled to each other. That is, the connector CN3a and the connector CN3b constitute a BtoB connector that electrically couples the drive circuit module DRV and the base substrate B1 to each other. Thus, the drive signals COMA, COMB, and COMC and the reference voltage signals VBS output by the drive circuits 52a, 52b, and 52c are input to the base substrate B1. On this occasion, the terminals provided to the connector CN3a through which the drive signals COMA, COMB, and COMC propagate and the terminals provided to the connector CN3b through which the drive signals COMA, COMB, and COMC propagate correspond to the terminal COM-Out described above, and the terminal provided to the connector CN3a through which the reference voltage signal VBS propagates and the terminal provided to the connector CN3b through which the reference voltage signal VBS propagates correspond to the terminal VBS-Out described above.

Further, as shown in FIG. 20, by the connector CN3 being located at the −X2 side of the drive circuits 52a, 52b, and 52c, and along the side at the −X2 side of the drive circuit board DRB, the shortest distance between the coil 561 provided to the drive circuit 52a and the connector CN3a is shorter than the shortest distance between the integrated circuit 500 provided to the drive circuit 52a and the connector CN3a, the shortest distance between the coil 561 provided to the drive circuit 52b and the connector CN3a is shorter than the shortest distance between the integrated circuit 500 provided to the drive circuit 52b and the connector CN3a, and the shortest distance between the coil 561 provided to the drive circuit 52c and the connector CN3a is shorter than the shortest distance between the integrated circuit 500 provided to the drive circuit 52c and the connector CN3a. This makes it possible to shorten the wiring length of the wiring patterns through which the drive signals COMA, COMB, and COMC and the reference voltage signal VBS_output by the drive circuits 52a, 52b, and 52c propagate in the drive circuit board DRB. As a result, the waveform accuracy of the signal waveforms of the drive signals COMA, COMB, and COMC and the reference voltage signal VBS_output from the drive circuit module DRV is improved.

That is, the drive unit 10 includes the drive circuit module DRV including the drive signal output circuit 50-1 including the drive circuits 52a, 52b, and 52c, the reference voltage signal output circuits 460 provided to the drive circuits 52a, 52b, and 52c, the connector CN3a to be electrically coupled to the base substrate B1, and the drive circuit board DRB provided with the drive signal output circuit 50 including the drive circuits 52a, 52b, and 52c and the connector CN3a.

Going back to FIG. 19, the connector CN2 is disposed on the surface 801 of the base substrate B1. The connector CN2 is located along a side at the −22 side of the base substrate B1. One end of the coupling member 30 is attached to the connector CN2. The other end of the coupling member 30 is coupled to the coupling part 330 described above. Thus, signals including the drive signals COMA1 to COMA6, COMB1 to COMB6, and COMC1 to COMC6 and the data signal DATA having propagated through the base substrate B1 are supplied to the ejection unit 20.

That is, the drive unit 10 includes the connector CN2 to be electrically coupled to the ejection unit 20 provided with the print heads 23-1 to 23-6, and the base substrate B1 which is provided with the connector CN2 and through which the drive signals COMA1 to COMA6, COMB1 to COMB6, and COMC1 to COMC6, and the reference voltage signals VBS1 to VBS6 propagate.

In the drive unit 10 in the present embodiment configured as described above, the drive circuit module DRV including the drive signal output circuit 50 is erected and fixed to the base substrate B1 via the BtoB connector. Thus, it is not necessary to mount the drive signal output circuits 50-1 to 50-6 on the base substrate B1, it becomes possible to reduce the size of the base substrate B1, and as a result, it becomes possible to reduce the size of the drive unit 10 including the base substrate B1 and the head unit 5 including the drive unit 10.

On the other hand, in such a configuration, since the base substrate B1 becomes small, the region where the wiring patterns through which various signals propagate is reduced in the base substrate B1. As a result, there is a possibility that the various signals propagating through the base substrate B1 interfere with each other. In particular, when distortion occurs in the signal waveforms of the drive signals COMA1 to COMA6, COMB1 to COMB6, and COMC1 to COMC6 propagating through the base substrate B1, there is a possibility that the driving characteristics of the plurality of piezoelectric elements 60 provided to the ejection unit 20 change, and as a result, the possibility that the ejection accuracy of the ink from the ejection unit 20 is deteriorated increases.

Therefore, there will hereinafter be described an example of the configuration which is capable of achieving both the reduction in size of the base substrate B1 and the reduction in the possibility that the distortion occurs in the signal waveforms of the drive signals COMA1 to COMA6, COMB1 to COMB6, and COMC1 to COMC6 propagating through the base substrate B1, and which is an optimum arrangement of the electronic components mounted on the base substrate B1, and an example of an optimum wiring pattern formed on the base substrate B1, which is an optimum wiring pattern for propagating the drive signals COMA1 to COMA6, COMB1 to COMB6, and COMC1 to COMC6 and the reference voltage signals VBS1 to VBS6 propagating through the base substrate B1.

As a preparation for the description of the example of the optimum arrangement of the electronic components mounted on the base substrate B1 and the example of the optimum wiring pattern formed on the base substrate B1, first, a structure of the base substrate B1 will be described. FIG. 21 is a diagram illustrating an example of a cross-sectional structure of the base substrate B1. As shown in FIG. 21, the base substrate B1 includes surface wiring layers 811, 812 located between the surface 801 and the surface 802 described above, internal wiring layers 820-1 to 820-m, and a plurality of insulating layers 810.

The surface wiring layer 811 is a surface layer that forms a wiring pattern on the surface 801, and the surface wiring layer 812 is a surface layer that forms a wiring pattern on the surface 802. The internal wiring layers 820-1 to 820-m are inner layers which are located between the surface wiring layer 811 and the surface wiring layer 812 along the X2 axis, and form wiring patterns inside the base substrate B1, and are stacked in the order of the internal wiring layers 820-1, 820-2, . . . , 820-(m−1), and 820-m from the +X2 side toward the −X2 side. Further, the wiring patterns through which the various signals propagate are formed in each of the surface wiring layers 811, 812 and the internal wiring layers 820-1 to 820-m by applying an etching process to a copper foil excellent in electrical conductivity.

The plurality of insulating layers 810 insulates the surface wiring layers 811, 812 and the internal wiring layers 820-1 to 820-m from each other. Specifically, the plurality of insulating layers 810 is respectively located between the surface wiring layer 811 and the internal wiring layer 820-1, between the internal wiring layer 820-1 and the internal wiring layer 820-2, between the internal wiring layer 820-j (j is one of 1 to m−1) and the internal wiring layer 820-(j+1), and between the internal wiring layer 820-m and the surface wiring layer 812 along the X2 axis. Such a plurality of insulating layers 810 is configured including a substance excellent in insulating performance such as epoxy glass formed by impregnating a cloth of glass fibers with an epoxy resin. Note that a solder resist (not shown) for insulating the surface wiring layer 811 and the surface wiring layer 812 may be applied to the surface 801 and the surface 802.

As described above, the base substrate B1 in the present embodiment includes the surface 801, the surface 802 located at the reverse side of the surface 801 and facing the surface 801, and the plurality of internal wiring layers 820 located between the surface 801 and the surface 802. That is, the base substrate B1 is formed of a so-called multilayer substrate having a plurality of layers. Further, a plurality of electronic components is mounted on at least one of the surface 801 and the surface 802 of the base substrate B1, and the plurality of electronic components mounted on the surface 801 and the surface 802 are electrically coupled to each other via the surface wiring layers 811, 812 and the wiring patterns formed in the internal wiring layers 820-1 to 820-m. Thus, the base substrate B1 propagates the various signals to desired constituents.

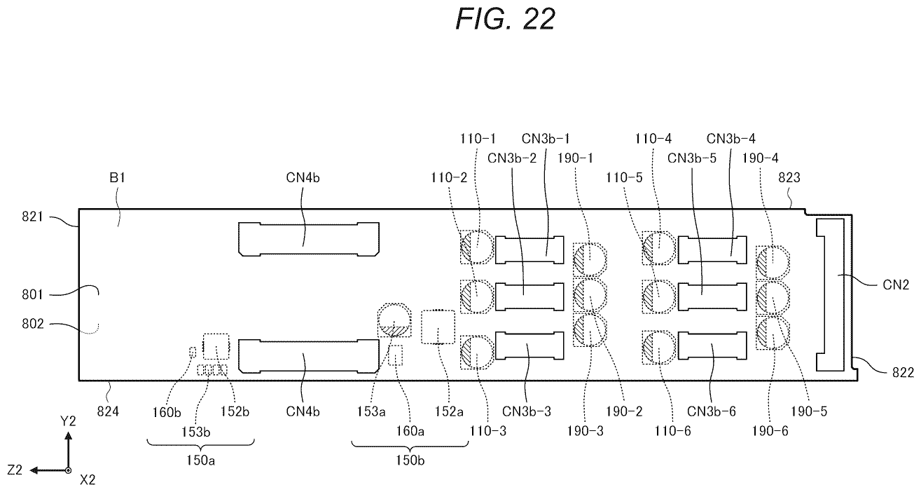

Then, an example of the optimum arrangement of the electronic components mounted on the base substrate B1 which is a multilayer substrate will be described. FIG. 22 is a diagram illustrating an example of the arrangement of a plurality of electronic components mounted on the base substrate B1. Note that in FIG. 22, the electronic components mounted on the surface 801 located at the +X2 side of the base substrate B1 are illustrated with solid lines, and the electronic components mounted on the surface 802 located at the −X2 side of the base substrate B1 are illustrated with broken lines.

As illustrated in FIG. 22, the base substrate B1 includes sides 821, 822, 823, and 824. The side 821 and the side 822 are located so as to face each other so that the side 821 is at the +Z2 side and the side 822 is at the −Z2 side along the Z2 axis. The side 823 and the side 824 are longer than the side 821 and the side 822 and are located so as to face each other so that the side 823 is at the +Y2 side and the side 824 is at the −Y2 side along the Y2 axis. That is, the base substrate B1 has a substantially rectangular shape in which the sides 821 and 822 are short sides and the sides 823 and 824 are long sides. The shape of the base substrate B1 is not limited to a rectangular shape.

The connector CN2, connectors CN3b-1 to CN3b-6 as the connector CN3b described above, and two connectors CN4b are mounted on the surface 801 of the base substrate B1.

The connector CN2 is located at the −22 side of the base substrate B1. Specifically, the connector CN2 has a plurality of terminals through which signals including the drive signals COMA1 to COMA6, COMB1 to COMB6, COMC1 to COMC6, and the data signal DATA propagate, and is mounted on an end portion at the −22 side of the base substrate B1 so that the plurality of terminals is arranged side by side along the side 822.

The connectors CN3b-4, CN3b-5, and CN3b-6 are located at the +Z2 side of the connector CN2 in the order of the connector CN3b-4, the connector CN3b-5, and the connector CN3b-6 from the +Y2 side toward the −Y2 side along the Y2 axis.

The connector CN3a provided to the drive circuit module DRV4 is coupled to the connector CN3b-4. That is, the connector CN3b-4 has a plurality of terminals through which the drive signals COMA4, COMB4, COMC4 and the reference voltage signal VBS4 output by the drive signal output circuit 50-4 propagate. The connector CN3a provided to the drive circuit module DRV5 is coupled to the connector CN3b-5. That is, the connector CN3b-5 has a plurality of terminals through which the drive signals COMA5, COMB5, COMC5 and the reference voltage signal VBS5 output by the drive signal output circuit 50-5 propagate. The connector CN3a provided to the drive circuit module DRV6 is coupled to the connector CN3b-6. That is, the connector CN3b-6 has a plurality of terminals through which the drive signals COMA6, COMB6, COMC6 and the reference voltage signal VBS6 output by the drive signal output circuit 50-6 propagate. Further, the connectors CN3b-4, CN3b-5, and CN3b-6 are disposed on the base substrate B1 such that the terminals of the connectors CN3b-4, CN3b-5, and CN3b-6 are arranged side by side along the Z2 axis.

The connectors CN3b-1, CN3b-2, and CN3b-3 are located at the +Z2 side of the connectors CN3b-4, CN3b-5, and CN3b-6 in the order of the connector CN3b-1, the connector CN3b-2, and the connector CN3b-3 from the +Y2 side toward the −Y2 side along the Y2 axis.

The connector CN3a provided to the drive circuit module DRV1 is coupled to the connector CN3b-1. That is, the connector CN3b-1 has a plurality of terminals through which the drive signals COMA1, COMB1, COMC1 and the reference voltage signal VBS1 output by the drive signal output circuit 50-1 propagate. The connector CN3a provided to the drive circuit module DRV2 is coupled to the connector CN3b-2. That is, the connector CN3b-2 has a plurality of terminals through which the drive signals COMA2, COMB2, COMC2 and the reference voltage signal VBS2 output by the drive signal output circuit 50-2 propagate. The connector CN3a provided to the drive circuit module DRV3 is coupled to the connector CN3b-3. That is, the connector CN3b-3 has a plurality of terminals through which the drive signals COMA3, COMB3, COMC3 and the reference voltage signal VBS3 output by the drive signal output circuit 50-3 propagate. Further, the connectors CN3b-1, CN3b-2, and CN3b-3 are disposed on the base substrate B1 such that the terminals of the connectors CN3b-1, CN3b-2, and CN3b-3 are arranged side by side along the Z2 axis.

As described above, in the base substrate B1, the connectors CN3b-1, CN3b-2, and CN3b-3 are located farther from the connector CN2 than the connectors CN3b-4, CN3b-5, and CN3b-6. In other words, in the base substrate B1, the shortest distance between the connectors CN3b-1, CN3b-2, and CN3b-3 and the connector CN2 is longer than the shortest distance between the connectors CN3b-4, CN3b-5, and CN3b-6 and the connector CN2. Therefore, the drive signal output circuit 50-1 provided to the drive circuit module DRV1 coupled to the connector CN3b-1, the drive signal output circuit 50-2 provided to the drive circuit module DRV2 coupled to the connector CN3b-2, and the drive signal output circuit 50-3 provided to the drive circuit module DRV3 coupled to the connector CN3b-3 are located farther from the connector CN2 than the drive signal output circuit 50-4 provided to the drive circuit module DRV4 coupled to the connector CN3b-4, the drive signal output circuit 50-5 provided to the drive circuit module DRV5 coupled to the connector CN3b-5, and the drive signal output circuit 50-6 provided to the drive circuit module DRV6 coupled to the connector CN3b-6. In other words, the shortest distance between the drive signal output circuits 50-1, 50-2, and 50-3 and the connector CN2 and the shortest distance between the reference voltage signal output circuits 460 respectively provided to the drive signal output circuits 50-1, 50-2, and 50-3 and the connector CN2 are longer than the shortest distance between the drive signal output circuits 50-4, 50-5, and 50-6 and the connector CN2 and the shortest distance between the reference voltage signal output circuits 460 respectively provided to the drive signal output circuits 50-4, 50-5, and 50-6 and the connector CN2, respectively.

The two connectors CN4b are arranged side by side along the Y2 axis at the +Z2 side of the connectors CN3b-1, CN3b-2, and CN3b-3. The two connectors CN4b are fitted to connectors (not shown) disposed on the component mounting surface at the −X2 side of the conversion circuit board B2 to thereby form the BtoB connectors. Thus, the conversion circuit board B2 and the base substrate B1 are electrically coupled to each other. That is, the two connectors CN4b have a plurality of terminals through which various signals including the data signal DATA and the base drive data signals dA1 to dA6, dB1 to dB6, and dC1 to dC6 propagate. Further, the two connectors CN4b are disposed on the base substrate B1 such that the plurality of terminals provided to each of the connectors CN4b is arranged side by side along the Z2 axis.

Further, as shown in FIG. 22, the capacitors 110-1 to 110-6, 190-1 to 190-6, the first step-down circuit 150a, and the second step-down circuit 150b are disposed on the surface 802 of the base substrate B1.

When the base substrate B1 is viewed along the X2 axis in the normal direction of the surface 801 of the base substrate B1, the capacitors 190-4 to 190-6 are arranged side by side in the order of the capacitor 190-4, the capacitor 190-5, and the capacitor 190-6 from the +Y2 side toward the −Y2 side along the Y2 direction between the connector CN2 located in an end portion at the −22 side of the base substrate B1, and the connector CN3b-4, the connector CN3b-5, and the connector CN3b-6 arranged side by side along the Y2 axis.

On this occasion, the capacitor 190-4 is disposed on the base substrate B1 such that the shortest distance between the capacitor 190-4 and the connector CN3b-4 is shorter than the shortest distance between the capacitor 190-5 and the connector CN3b-4 and the shortest distance between the capacitor 190-6 and the connector CN3b-4, the capacitor 190-5 is disposed on the base substrate B1 such that the shortest distance between the capacitor 190-5 and the connector CN3b-5 is shorter than the shortest distance between the capacitor 190-4 and the connector CN3b-5 and the shortest distance between the capacitor 190-6 and the connector CN3b-5, and the capacitor 190-6 is disposed on the base substrate B1 such that the shortest distance between the capacitor 190-6 and the connector CN3b-6 is shorter than the shortest distance between the capacitor 190-4 and the connector CN3b-6 and the shortest distance between the capacitor 190-5 and the connector CN3b-6.

Further, the capacitor 190-4 is mounted on the base substrate B1 so that one end which is supplied with the reference voltage signal VBS4, and is a positive terminal of the electrolytic capacitor as the capacitor 190-4 is located at the −22 side, the other end which is supplied with the ground signal, and is a negative terminal of the electrolytic capacitor as the capacitor 190-4 is located at the +Z2 side, and the one end and the other end are located along the Z2 axis. That is, the capacitor 190-4 is mounted on the base substrate B1 such that one end which is supplied with the reference voltage signal VBS4 is located closer to the connector CN2 which outputs the reference voltage signal VBS4 to the ejection unit 20, and the other end which is supplied with the ground signal is located closer to the connector CN3b-4 supplied with the drive signals COMA4, COMB4, and COMC4.

Similarly, the capacitor 190-5 is mounted on the base substrate B1 so that one end which is supplied with the reference voltage signal VBS5, and is a positive terminal of the electrolytic capacitor as the capacitor 190-5 is located at the −22 side, the other end which is supplied with the ground signal, and is a negative terminal of the electrolytic capacitor as the capacitor 190-5 is located at the +Z2 side, and the one end and the other end are located along the Z2 axis. That is, the capacitor 190-5 is mounted on the base substrate B1 such that one end which is supplied with the reference voltage signal VBS5 is located closer to the connector CN2 which outputs the reference voltage signal VBS5 to the ejection unit 20, and the other end which is supplied with the ground signal is located closer to the connector CN3b-5 supplied with the drive signals COMA5, COMB5, and COMC5.

Similarly, the capacitor 190-6 is mounted on the base substrate B1 so that one end which is supplied with the reference voltage signal VBS6, and is a positive terminal of the electrolytic capacitor as the capacitor 190-6 is located at the −22 side, the other end which is supplied with the ground signal, and is a negative terminal of the electrolytic capacitor as the capacitor 190-6 is located at the +Z2 side, and the one end and the other end are located along the Z2 axis. That is, the capacitor 190-6 is mounted on the base substrate B1 such that one end which is supplied with the reference voltage signal VBS6 is located closer to the connector CN2 which outputs the reference voltage signal VBS6 to the ejection unit 20, and the other end which is supplied with the ground signal is located closer to the connector CN3b-6 supplied with the drive signals COMA6, COMB6, and COMC6.

When the base substrate B1 is viewed along the X2 axis in the normal direction of the surface 801 of the base substrate B1, the capacitors 190-1 to 190-3 are arranged side by side in the order of the capacitor 190-1, the capacitor 190-2, and the capacitor 190-3 from the +Y2 side toward the −Y2 side along the Y2 direction between the connector CN3b-4, the connector CN3b-5, and the connector CN3b-6 arranged side by side along the Y2 axis, and the connector CN3b-1, the connector CN3b-2, and the connector CN3b-3 arranged side by side along the Y2 axis.

On this occasion, the capacitor 190-1 is disposed on the base substrate B1 such that the shortest distance between the capacitor 190-1 and the connector CN3b-1 is shorter than the shortest distance between the capacitor 190-2 and the connector CN3b-1 and the shortest distance between the capacitor 190-3 and the connector CN3b-1, the capacitor 190-2 is disposed on the base substrate B1 such that the shortest distance between the capacitor 190-2 and the connector CN3b-2 is shorter than the shortest distance between the capacitor 190-1 and the connector CN3b-2 and the shortest distance between the capacitor 190-3 and the connector CN3b-2, and the capacitor 190-3 is disposed on the base substrate B1 such that the shortest distance between the capacitor 190-3 and the connector CN3b-3 is shorter than the shortest distance between the capacitor 190-1 and the connector CN3b-3 and the shortest distance between the capacitor 190-2 and the connector CN3b-3.

Further, the capacitor 190-1 is mounted on the base substrate B1 so that one end which is supplied with the reference voltage signal VBS1, and is a positive terminal of the electrolytic capacitor as the capacitor 190-1 is located at the −Z2 side, the other end which is supplied with the ground signal, and is a negative terminal of the electrolytic capacitor as the capacitor 190-1 is located at the +Z2 side, and the one end and the other end are located along the Z2 axis. That is, the capacitor 190-1 is mounted on the base substrate B1 such that one end which is supplied with the reference voltage signal VBS1 is located closer to the connector CN2 which outputs the reference voltage signal VBS1 to the ejection unit 20, and the other end which is supplied with the ground signal is located closer to the connector CN3b-1 supplied with the drive signals COMA1, COMB1, and COMC1.

Similarly, the capacitor 190-2 is mounted on the base substrate B1 so that one end which is supplied with the reference voltage signal VBS2, and is a positive terminal of the electrolytic capacitor as the capacitor 190-2 is located at the −22 side, the other end which is supplied with the ground signal, and is a negative terminal of the electrolytic capacitor as the capacitor 190-2 is located at the +Z2 side, and the one end and the other end are located along the Z2 axis. That is, the capacitor 190-2 is mounted on the base substrate B1 such that one end which is supplied with the reference voltage signal VBS2 is located closer to the connector CN2 which outputs the reference voltage signal VBS2 to the ejection unit 20, and the other end which is supplied with the ground signal is located closer to the connector CN3b-2 supplied with the drive signals COMA2, COMB2, and COMC2.

Similarly, the capacitor 190-3 is mounted on the base substrate B1 so that one end which is supplied with the reference voltage signal VBS3, and is a positive terminal of the electrolytic capacitor as the capacitor 190-3 is located at the −22 side, the other end which is supplied with the ground signal, and is a negative terminal of the electrolytic capacitor as the capacitor 190-3 is located at the +Z2 side, and the one end and the other end are located along the Z2 axis. That is, the capacitor 190-3 is mounted on the base substrate B1 such that one end which is supplied with the reference voltage signal VBS3 is located closer to the connector CN2 which outputs the reference voltage signal VBS3 to the ejection unit 20, and the other end which is supplied with the ground signal is located closer to the connector CN3b-3 supplied with the drive signals COMA3, COMB3, and COMC3.

That is, the shortest distance between the connector CN2 and the capacitors 190-1 to 190-3 is longer than the shortest distance between the connector CN2 and the capacitors 190-4 to 190-6.

When the base substrate B1 is viewed along the X2 axis in the normal direction of the surface 801 of the base substrate B1, the capacitors 110-4 to 110-6 are arranged side by side in the order of the capacitor 110-4, the capacitor 110-5, and the capacitor 110-6 from the +Y2 side toward the −Y2 side along the Y2 direction between the connector CN3b-4, the connector CN3b-5, and the connector CN3b-6 arranged side by side along the Y2 axis, and the capacitor 190-1, the capacitor 190-2, and the capacitor 190-3 arranged side by side along the Y2 axis.

On this occasion, the capacitor 110-4 is disposed on the base substrate B1 such that the shortest distance between the capacitor 110-4 and the connector CN3b-4 is shorter than the shortest distance between the capacitor 110-5 and the connector CN3b-4 and the shortest distance between the capacitor 110-6 and the connector CN3b-4, the capacitor 110-5 is disposed on the base substrate B1 such that the shortest distance between the capacitor 110-5 and the connector CN3b-5 is shorter than the shortest distance between the capacitor 110-4 and the connector CN3b-5 and the shortest distance between the capacitor 110-6 and the connector CN3b-5, and the capacitor 110-6 is disposed on the base substrate B1 such that the shortest distance between the capacitor 110-6 and the connector CN3b-6 is shorter than the shortest distance between the capacitor 110-4 and the connector CN3b-6 and the shortest distance between the capacitor 110-5 and the connector CN3b-6.

Further, the capacitor 110-4 is mounted on the base substrate B1 so that one end which is supplied with the voltage signal VHV, and is a positive terminal of the electrolytic capacitor as the capacitor 110-4 is located at the −22 side, the other end which is supplied with the ground signal, and is a negative terminal of the electrolytic capacitor as the capacitor 110-4 is located at the +Z2 side, and the one end and the other end are located along the Z2 axis. Similarly, the capacitor 110-5 is mounted on the base substrate B1 so that one end which is supplied with the voltage signal VHV, and is a positive terminal of the electrolytic capacitor as the capacitor 110-5 is located at the −22 side, the other end which is supplied with the ground signal, and is a negative terminal of the electrolytic capacitor as the capacitor 110-5 is located at the +Z2 side, and the one end and the other end are located along the Z2 axis, and the capacitor 110-6 is mounted on the base substrate B1 so that one end which is supplied with the voltage signal VHV, and is a positive terminal of the electrolytic capacitor as the capacitor 110-6 is located at the −22 side, the other end which is supplied with the ground signal, and is a negative terminal of the electrolytic capacitor as the capacitor 110-6 is located at the +Z2 side, and the one end and the other end are located along the Z2 axis.

When the base substrate B1 is viewed along the X2 axis in the normal direction of the surface 801 of the base substrate B1, the capacitors 110-1 to 110-3 are arranged side by side in the order of the capacitor 110-1, the capacitor 110-2, and the capacitor 110-3 from the +Y2 side toward the −Y2 side along the Y2 direction between the connector CN3b-1, the connector CN3b-2, and the connector CN3b-3 arranged side by side along the Y2 axis, and the connectors CN4b arranged side by side along the Y2 axis.

On this occasion, the capacitor 110-1 is disposed on the base substrate B1 such that the shortest distance between the capacitor 110-1 and the connector CN3b-1 is shorter than the shortest distance between the capacitor 110-2 and the connector CN3b-1 and the shortest distance between the capacitor 110-3 and the connector CN3b-1, the capacitor 110-2 is disposed on the base substrate B1 such that the shortest distance between the capacitor 110-2 and the connector CN3b-2 is shorter than the shortest distance between the capacitor 110-1 and the connector CN3b-2 and the shortest distance between the capacitor 110-3 and the connector CN3b-2, and the capacitor 110-3 is disposed on the base substrate B1 such that the shortest distance between the capacitor 110-3 and the connector CN3b-3 is shorter than the shortest distance between the capacitor 110-1 and the connector CN3b-3 and the shortest distance between the capacitor 110-2 and the connector CN3b-3.

Further, the capacitor 110-1 is mounted on the base substrate B1 so that one end which is supplied with the voltage signal VHV, and is a positive terminal of the electrolytic capacitor as the capacitor 110-1 is located at the −Z2 side, the other end which is supplied with the ground signal, and is a negative terminal of the electrolytic capacitor as the capacitor 110-1 is located at the +Z2 side, and the one end and the other end are located along the Z2 axis. Similarly, the capacitor 110-2 is mounted on the base substrate B1 so that one end which is supplied with the voltage signal VHV, and is a positive terminal of the electrolytic capacitor as the capacitor 110-2 is located at the −22 side, the other end which is supplied with the ground signal, and is a negative terminal of the electrolytic capacitor as the capacitor 110-2 is located at the +Z2 side, and the one end and the other end are located along the Z2 axis, and the capacitor 110-3 is mounted on the base substrate B1 so that one end which is supplied with the voltage signal VHV, and is a positive terminal of the electrolytic capacitor as the capacitor 110-3 is located at the −22 side, the other end which is supplied with the ground signal, and is a negative terminal of the electrolytic capacitor as the capacitor 110-3 is located at the +Z2 side, and the one end and the other end are located along the Z2 axis.

When the base substrate B1 is viewed along the X2 axis in the normal direction of the surface 801 of the base substrate B1, the first step-down circuit 150a is located between the capacitors 110-1, 110-2, and 110-3 aligned side by side along the Y2 axis and the connectors CN4b arranged side by side along the Y2 axis.

When the base substrate B1 is viewed along the X2 axis in the normal direction of the surface 801 of the base substrate B1, the second step-down circuit 150b is located at the +Z2 side of the connectors CN4b arranged side by side along the Y2 axis when the base substrate B1 is viewed along the X2.

As described above, the base substrate B1 includes the side 821, the side 822 located so as to face the side 821, the side 823, and the side 824 located so as to face the side 823. Further, the connector CN2, the connectors CN3b-1 to CN3b-6, and the two connectors CN4b are disposed on the surface 801 of the base substrate B1, and the capacitors 110-1 to 110-6, 190-1 to 190-6, the first step-down circuit 150a, and the second step-down circuit 150b are disposed on the surface 802 of the base substrate B1.

Then, the connectors CN3a respectively provided to the drive circuit modules DRV1 to DRV6 are fitted in the connectors CN3b-1 to CN3b-6 disposed on the surface 801 of the base substrate B1. Further, by the connector CN3b-1 disposed on the surface 801 of the base substrate B1 and the connector CN3a provided to the drive circuit module DRV1 being fitted to each other, the drive circuit board DRB on which the drive signal output circuit 50-1 is mounted and which is provided to the drive circuit module DRV1 is electrically coupled to the base substrate B1, and by the connector CN3b-i disposed on the surface 801 of the base substrate B1 and the connector CN3a provided to the drive circuit module DRVi being fitted to each other, the drive circuit board DRB on which the drive signal output circuit 50-i is mounted, and which is provided to the drive circuit module DRVi and the base substrate B1 are electrically coupled to each other.

In other words, the drive circuit board DRB on which the drive signal output circuit 50-1 is mounted and which is provided to the drive circuit module DRV1 is electrically coupled to the base substrate B1 via the BtoB connector constituted with the connector CN3b-1 and the connector CN3a, and the drive circuit board DRB on which the drive signal output circuit 50-i is mounted and which is provided to the drive circuit module DRVi is electrically coupled to the base substrate B1 via the BtoB connector configured with the connector CN3b-i and the connector CN3a.

Therefore, the drive signal output circuits 50-1 to 50-6 that output the drive signals COMA1 to COMA6, COMB1 to COMB6, and COMC1 to COMC6, and the reference voltage signals VBS1 to VBS6 are located at the surface 801 side of the base substrate B1. That is, the shortest distance between the drive circuits 52a, 52b, and 52c provided to each of the drive signal output circuits 50-1 to 50-6 and the surface 801 is shorter than the shortest distance between the drive circuits 52a, 52b, and 52c provided to each of the drive signal output circuits 50-1 to 50-6 and the surface 802, and the shortest distance between the reference voltage signal output circuits 460 provided to the drive circuits 52a, 52b, and 52c provided to each of the drive signal output circuits 50-1 to 50-6 and the surface 801 is shorter than the shortest distance between the reference voltage signal output circuits 460 provided to the drive circuits 52a, 52b, and 52c provided to each of the drive signal output circuits 50-1 to 50-6 and the surface 802. In other words, the base substrate B1 is located between the drive signal output circuits 50-1 to 50-6, and the capacitors 110-1 to 110-6, 190-1 to 190-6, the first step-down circuit 150a, and the second step-down circuit 150b.

Further, the drive signals COMA1, COMB1, and COMC1 and the reference voltage signal VBS_output by the drive signal output circuit 50-1 provided to the drive circuit module DRV1 are supplied to the base substrate B1 via the BtoB connector configured with the connector CN3b-1 and the connector CN3a, and the drive signals COMAi, COMBi, and COMCi and the reference voltage signal VBSi output by the drive signal output circuit 50-i provided to the drive circuit module DRVi are supplied to the base substrate B1 via the BtoB connector configured with the connector CN3b-i and the connector CN3a. That is, the base substrate B1 includes electrodes as coupling points to which the connector CN3b-1 is electrically coupled, and which are supplied with the drive signals COMA1, COMB1, and COMC1 and the reference voltage signal VBS1, electrodes as coupling points to which the connector CN3b-2 is electrically coupled, and which are supplied with the drive signals COMA2, COMB2, and COMC2 and the reference voltage signal VBS2, electrodes as coupling points to which the connector CN3b-3 is electrically coupled, and which are supplied with the drive signals COMA3, COMB3, and COMC3 and the reference voltage signal VBS3, electrodes as coupling points to which the connector CN3b-4 is electrically coupled, and which are supplied with the drive signals COMA4, COMB4, and COMC4 and the reference voltage signal VBS4, electrodes as coupling points to which the connector CN3b-5 is electrically coupled, and which are supplied with the drive signals COMA5, COMB5, and COMC5 and the reference voltage signal VBS5, electrodes coupling points to which the connector CN3b-6 is as electrically coupled, and which are supplied with the drive signals COMA6, COMB6, and COMC6 and the reference voltage signal VBS6.

Further, when viewed along the X2 axis orthogonal to the Z2 axis connecting the side 821 and the side 822 of the base substrate B1, the capacitor 190-1 is located between the connector CN2 and the connector CN3b-1, and between the connector CN2 and the electrode where the connector CN3b-1 is electrically coupled to the base substrate B1, the capacitor 190-2 is located between the connector CN2 and the connector CN3b-2, and between the connector CN2 and the electrode where the connector CN3b-2 is electrically coupled to the base substrate B1, and the capacitor 190-3 is located between the connector CN2 and the connector CN3b-3, and between the connector CN2 and the electrode where the connector CN3b-3 is electrically coupled to the base substrate B1.

On this occasion, the capacitor 190-1 is disposed on the base substrate B1 such that the shortest distance between the connector CN2 and one end of the capacitor 190-1 as a positive terminal supplied with the reference voltage signal VBS1 is shorter than the shortest distance between the connector CN2 and the other end of the capacitor 190-1 as a negative terminal supplied with the ground signal, and the shortest distance between the connector CN3b-1 and one end of the capacitor 190-1 as a positive terminal supplied with the reference voltage signal VBS1 is longer than the shortest distance between the connector CN3b-1 and the other end of the capacitor 190-1 as a negative terminal supplied with the ground signal, the capacitor 190-2 is disposed on the base substrate B1 such that the shortest distance between the connector CN2 and one end of the capacitor 190-2 as a positive terminal supplied with the reference voltage signal VBS2 is shorter than the shortest distance between the connector CN2 and the other end of the capacitor 190-2 as a negative terminal supplied with the ground signal, and the shortest distance between the connector CN3b-2 and one end of the capacitor 190-2 as a positive terminal supplied with the reference voltage signal VBS2 is longer than the shortest distance between the connector CN3b-2 and the other end of the capacitor 190-2 as a negative terminal supplied with the ground signal, the capacitor 190-3 is disposed on the base substrate B1 such that the shortest distance between the connector CN2 and one end of the capacitor 190-3 as a positive terminal supplied with the reference voltage signal VBS3 is shorter than the shortest distance between the connector CN2 and the other end of the capacitor 190-3 as a negative terminal supplied with the ground signal, and the shortest distance between the connector CN3b-3 and one end of the capacitor 190-3 as a positive terminal supplied with the reference voltage signal VBS3 is longer than the shortest distance between the connector CN3b-3 and the other end of the capacitor 190-3 as a negative terminal supplied with the ground signal.

Similarly, when viewed along the X2 axis orthogonal to the Z2 axis connecting the side 821 and the side 822 of the base substrate B1, the capacitor 190-4 is located between the connector CN2 and the connector CN3b-4, and between the connector CN2 and the electrode where the connector CN3b-4 is electrically coupled to the base substrate B1, the capacitor 190-5 is located between the connector CN2 and the connector CN3b-5, and between the connector CN2 and the electrode where the connector CN3b-5 is electrically coupled to the base substrate B1, and the capacitor 190-6 is located between the connector CN2 and the connector CN3b-6, and between the connector CN2 and the electrode where the connector CN3b-6 is electrically coupled to the base substrate B1.

On this occasion, the capacitor 190-4 is disposed on the base substrate B1 such that the shortest distance between the connector CN2 and one end of the capacitor 190-4 as a positive terminal supplied with the reference voltage signal VBS1 is shorter than the shortest distance between the connector CN2 and the other end of the capacitor 190-4 as a negative terminal supplied with the ground signal, and the shortest distance between the connector CN3b-4 and one end of the capacitor 190-4 as a positive terminal supplied with the reference voltage signal VBS1 is longer than the shortest distance between the connector CN3b-4 and the other end of the capacitor 190-4 as a negative terminal supplied with the ground signal, the capacitor 190-5 is disposed on the base substrate B1 such that the shortest distance between the connector CN2 and one end of the capacitor 190-5 as a positive terminal supplied with the reference voltage signal VBS2 is shorter than the shortest distance between the connector CN2 and the other end of the capacitor 190-5 as a negative terminal supplied with the ground signal, and the shortest distance between the connector CN3b-5 and one end of the capacitor 190-5 as a positive terminal supplied with the reference voltage signal VBS2 is longer than the shortest distance between the connector CN3b-5 and the other end of the capacitor 190-5 as a negative terminal supplied with the ground signal, the capacitor 190-6 is disposed on the base substrate B1 such that the shortest distance between the connector CN2 and one end of the capacitor 190-6 as a positive terminal supplied with the reference voltage signal VBS3 is shorter than the shortest distance between the connector CN2 and the other end of the capacitor 190-6 as a negative terminal supplied with the ground signal, and the shortest distance between the connector CN3b-6 and one end of the capacitor 190-6 as a positive terminal supplied with the reference voltage signal VBS6 is longer than the shortest distance between the connector CN3b-6 and the other end of the capacitor 190-6 as a negative terminal supplied with the ground signal.

On this occasion, it is preferable that the capacitor 190-1 is located along the Z2 axis such that one end as the positive terminal supplied with the reference voltage signal VBS1 is located at the −22 side, and the other end as the negative terminal supplied with the ground signal is located at the +Z2 side, the capacitor 190-2 is located along the Z2 axis such that one end as the positive terminal supplied with the reference voltage signal VBS2 is located at the −22 side, and the other end as the negative terminal supplied with the ground signal is located at the +Z2 side, the capacitor 190-3 is located along the Z2 axis such that one end as the positive terminal supplied with the reference voltage signal VBS3 is located at the −22 side, and the other end as the negative terminal supplied with the ground signal is located at the +Z2 side, the capacitor 190-4 is located along the Z2 axis such that one end as the positive terminal supplied with the reference voltage signal VBS4 is located at the −22 side, and the other end as the negative terminal supplied with the ground signal is located at the +Z2 side, the capacitor 190-5 is located along the Z2 axis such that one end as the positive terminal supplied with the reference voltage signal VBS5 is located at the −Z2 side, and the other end as the negative terminal supplied with the ground signal is located at the +Z2 side, the capacitor 190-6 is located along the Z2 axis such that one end as the positive terminal supplied with the reference voltage signal VBS6 is located at the −Z2 side, and the other end as the negative terminal supplied with the ground signal is located at the +Z2 side.

Note that in addition to the electronic components described above, various electronic components may be mounted on the base substrate B1.

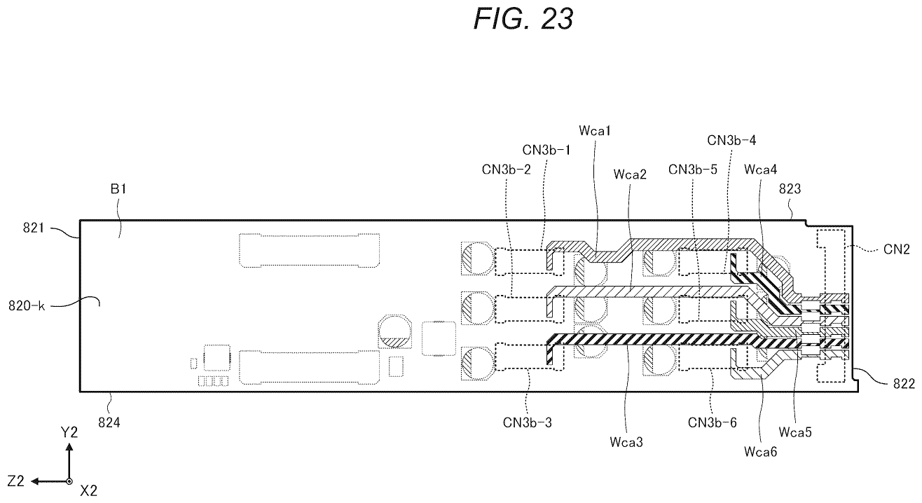

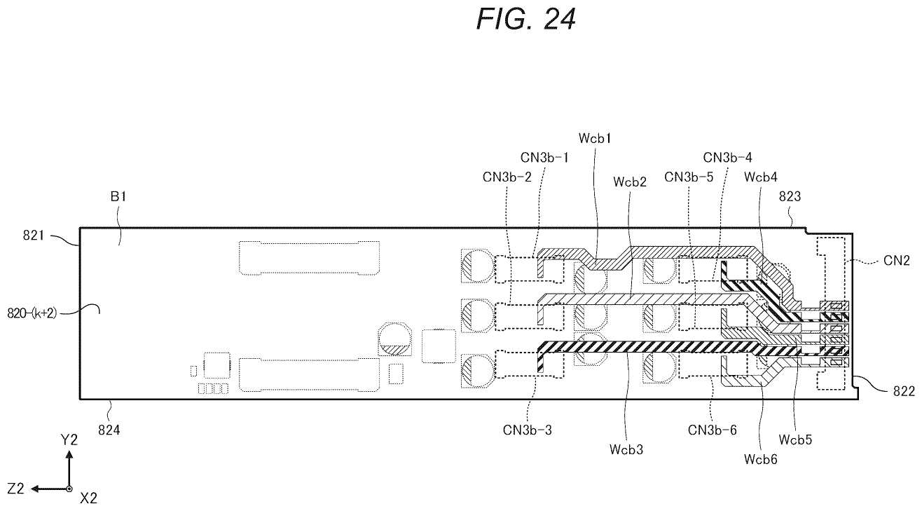

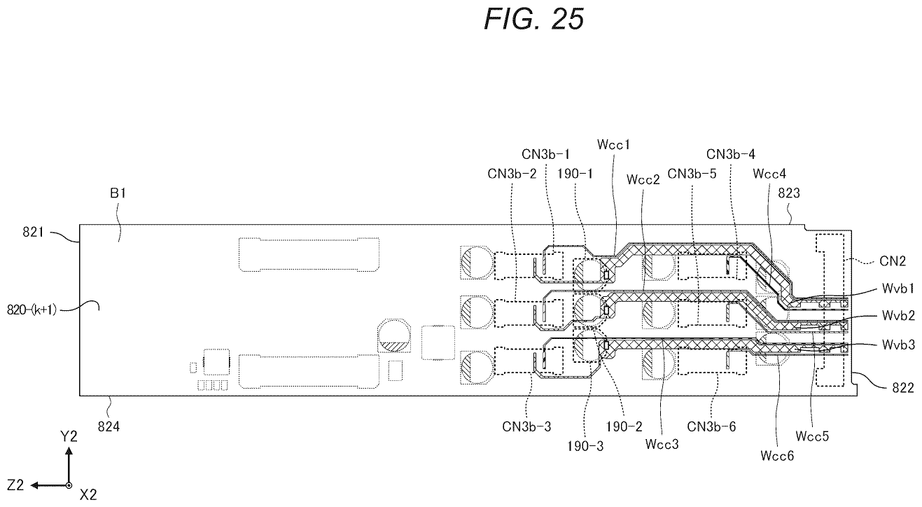

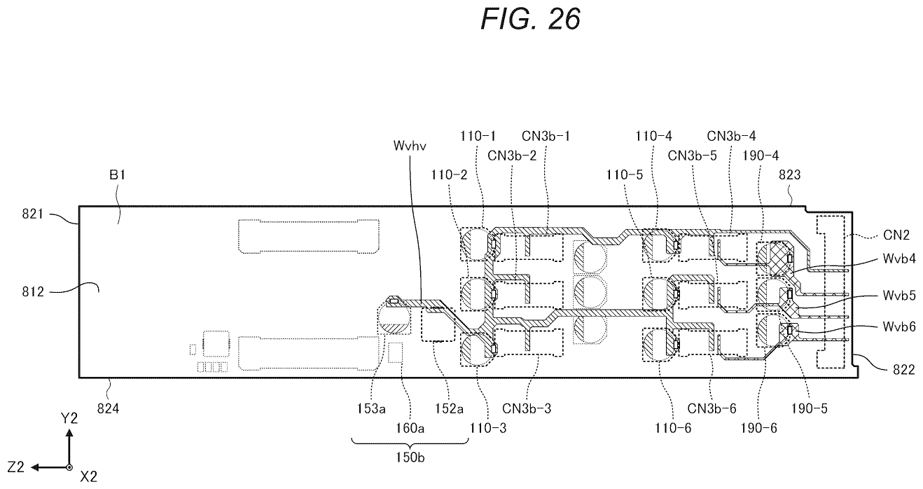

Then, an example of an optimum wiring pattern formed on the base substrate B1 as a multilayer substrate, which is an example of an optimum wiring pattern that is provided to the base substrate B1, and propagates the drive signals COMA1 to COMA6, COMB1 to COMB6, and COMC1 to COMC6 and the reference voltage signals VBS1 to VBS6. FIG. 23 is a diagram illustrating an example of a wiring pattern that is provided to the base substrate B1 and propagates the drive signals COMA1 to COMA6, FIG. 24 is a diagram illustrating an example of a wiring pattern that is provided to the base substrate B1 and propagates the drive signals COMB1 to COMB6, and FIG. 25 is a diagram illustrating an example of a wiring pattern that is provided to the base substrate B1 and propagates the drive signals COMC1 to COMC6 and the reference voltage signals VBS1 to VBS3, and FIG. 26 is a diagram illustrating an example of a wiring pattern that is provided to the base substrate B1 and propagates the reference voltage signals VBS4 to VBS6.

As shown in FIG. 23, the wiring lines Wca1 to Wca6 through which the drive signals COMA1 to COMA6 propagate are formed in the internal wiring layer 820-k (k is one of 1 to m−2).

The wiring line Wca1 electrically couples a terminal for inputting the drive signal COMA1 to the base substrate B1 out of a plurality of terminals provided to the connector CN3b-1 electrically coupled to the drive circuit module DRV1, and a terminal for supplying the drive signal COMA1 to the print head 23-1 out of a plurality of terminals provided to the connector CN2 electrically coupled to the ejection unit 20, and propagates the drive signal COMA1.

The wiring line Wca2 is located at the −Y2 side of the wiring line Wca1, and electrically couples a terminal for inputting the drive signal COMA2 to the base substrate B1 out of a plurality of terminals provided to the connector CN3b-2 electrically coupled to the drive circuit module DRV2, and a terminal for supplying the drive signal COMA2 to the print head 23-2 out of the plurality of terminals provided to the connector CN2 electrically coupled to the ejection unit 20, and propagates the drive signal COMA2.

The wiring line Wca3 is located at the −Y2 side of the wiring line Wca2, and electrically couples a terminal for inputting the drive signal COMA3 to the base substrate B1 out of a plurality of terminals provided to the connector CN3b-3 electrically coupled to the drive circuit module DRV3, and a terminal for supplying the drive signal COMA3 to the print head 23-3 out of the plurality of terminals provided to the connector CN2 electrically coupled to the ejection unit 20, and propagates the drive signal COMA3.

The wiring line Wca4 is located between the wiring line Wca1 and the wiring line Wca2 in a plan view of the base substrate B1 when viewing the base substrate B1 along the X2 axis, and electrically couples a terminal for inputting the drive signal COMA4 to the base substrate B1 out of a plurality of terminals provided to the connector CN3b-4 electrically coupled to the drive circuit module DRV4, and a terminal for supplying the drive signal COMA4 to the print head 23-4 out of the plurality of terminals provided to the connector CN2 electrically coupled to the ejection unit 20, and propagates the drive signal COMA4.

The wiring line Wca5 is located between the wiring line Wca2 and the wiring line Wca3 in a plan view of the base substrate B1 when viewing the base substrate B1 along the X2 axis, and electrically couples a terminal for inputting the drive signal COMA5 to the base substrate B1 out of a plurality of terminals provided to the connector CN3b-5 electrically coupled to the drive circuit module DRV5, and a terminal for supplying the drive signal COMA5 to the print head 23-5 out of the plurality of terminals provided to the connector CN2 electrically coupled to the ejection unit 20, and propagates the drive signal COMA5.

The wiring line Wca6 is located at the −Y2 side of the wiring line Wca3, and electrically couples a terminal for inputting the drive signal COMA6 to the base substrate B1 out of a plurality of terminals provided to the connector CN3b-6 electrically coupled to the drive circuit module DRV6, and a terminal for supplying the drive signal COMA6 to the print head 23-6 out of the plurality of terminals provided to the connector CN2 electrically coupled to the ejection unit 20, and propagates the drive signal COMA6.

That is, the wiring line Wca1 through which the drive signal COMA1 propagates, the wiring line Wca2 through which the drive signal COMA2 propagates, the wiring line Wca3 through which the drive signal COMA3 propagates, the wiring line Wca4 through which the drive signal COMA4 propagates, the wiring line Wca5 through which the drive signal COMA5 propagates, and the wiring line Wca6 through which the drive signal COMA6 propagates are formed in the internal wiring layer 820-k of the base substrate B1. In the base substrate B1, the wiring lines Wca1 to Wca6 are arranged in the order of the wiring line Wca1, the wiring line Wca4, the wiring line Wca2, the wiring line Wca5, the wiring line Wca3, and the wiring line Wca6 from the +Y2 side toward the −Y2 side along the Y2 axis in the vicinity of the connector CN2 electrically coupled to the ejection unit 20.

As shown in FIG. 24, wiring lines Wcb1 to Wcb6 through which the drive signals COMB1 to COMB6 respectively propagate are formed in the internal wiring layer 820-(k+2).

The wiring line Wcb1 electrically couples a terminal for inputting the drive signal COMB1 to the base substrate B1 out of the plurality of terminals provided to the connector CN3b-1 electrically coupled to the drive circuit module DRV1, and a terminal for supplying the drive signal COMB1 to the print head 23-1 out of the plurality of terminals provided to the connector CN2 electrically coupled to the ejection unit 20, and propagates the drive signal COMB1.

The wiring line Wcb2 is located at the −Y2 side of the wiring line Wcb1, and electrically couples a terminal for inputting the drive signal COMB2 to the base substrate B1 out of the plurality of terminals provided to the connector CN3b-2 electrically coupled to the drive circuit module DRV2, and a terminal for supplying the drive signal COMB2 to the print head 23-2 out of the plurality of terminals provided to the connector CN2 electrically coupled to the ejection unit 20, and propagates the drive signal COMB2.

The wiring line Wcb3 is located at the −Y2 side of the wiring line Wcb2, and electrically couples a terminal for inputting the drive signal COMB3 to the base substrate B1 out of the plurality of terminals provided to the connector CN3b-3 electrically coupled to the drive circuit module DRV3, and a terminal for supplying the drive signal COMB3 to the print head 23-3 out of the plurality of terminals provided to the connector CN2 electrically coupled to the ejection unit 20, and propagates the drive signal COMB3.

The wiring line Wcb4 is located between the wiring line Wcb1 and the wiring line Wcb2 in a plan view of the base substrate B1 when viewing the base substrate B1 along the X2 axis, and electrically couples a terminal for inputting the drive signal COMB4 to the base substrate B1 out of the plurality of terminals provided to the connector CN3b-4 electrically coupled to the drive circuit module DRV4, and a terminal for supplying the drive signal COMB4 to the print head 23-4 out of the plurality of terminals provided to the connector CN2 electrically coupled to the ejection unit 20, and propagates the drive signal COMB4.

The wiring line Wcb5 is located between the wiring line Wcb2 and the wiring line Wcb3 in a plan view of the base substrate B1 when viewing the base substrate B1 along the X2 axis, and electrically couples a terminal for inputting the drive signal COMB5 to the base substrate B1 out of the plurality of terminals provided to the connector CN3b-5 electrically coupled to the drive circuit module DRV5, and a terminal for supplying the drive signal COMB5 to the print head 23-5 out of the plurality of terminals provided to the connector CN2 electrically coupled to the ejection unit 20, and propagates the drive signal COMB5.

The wiring line Wcb6 is located at the −Y2 side of the wiring line Wcb3, and electrically couples a terminal for inputting the drive signal COMB6 to the base substrate B1 out of the plurality of terminals provided to the connector CN3b-6 electrically coupled to the drive circuit module DRV6, and a terminal for supplying the drive signal COMB6 to the print head 23-6 out of the plurality of terminals provided to the connector CN2 electrically coupled to the ejection unit 20, and propagates the drive signal COMB6.

That is, the base substrate B1 includes the wiring line Wcb1 through t which the drive signal COMB1 propagates, the wiring line Web2 through which the drive signal COMB2 propagates, the wiring line Wcb3 through which the drive signal COMB3 propagates, the wiring line Wcb4 through which the drive signal COMB4 propagates, the wiring line Wcb5 through which the drive signal COMB5 propagates, and the wiring line Wcb6 through which the drive signal COMB6 propagates formed in the internal wiring layer 820-(k+2), the wiring lines Wcb1 to Wcb6 located in the order of the wiring line Wcb1, the wiring line Wcb4, the wiring line Wcb2, the wiring line Wcb5, the wiring line Wcb3, and the wiring line Wcb6 from the +Y side toward the −Y2 side along the Y2 axis in the vicinity of the connector CN2 electrically coupled to the ejection unit 20.

As shown in FIG. 25, the wiring lines Wcc1 to Wcc6 through which the drive signals COMC1 to COMC6 respectively propagate and the wiring lines Wvb1 to Wvb3 through which the reference voltage signals VBS1 to VBS3 respectively propagate are formed in the internal wiring layer 820-(k+1). In other words, the wiring lines Wcc1 to Wcc6 through which the drive signals COMC1 to COMC6 respectively propagate and the wiring lines Wvb1 to Wvb3 through which the reference voltage signals VBS1 to VBS3 respectively propagate are formed in the internal wiring layer 820-(k+1) located between the internal wiring layer 820-k in which the wiring lines Wca1 to Wca6 through which the drive signals COMA1 to COMA6 respectively propagate are formed and the internal wiring layer 820-(k+2) in which the wiring lines Wcb1 to Wcb6 through which the drive signals COMB1 to COMB6 respectively propagate are formed.

The wiring line Wvb1 electrically couples a terminal for inputting the reference voltage signal VBS1 to the base substrate B1 out of the plurality of terminals provided to the connector CN3b-1 electrically coupled to the drive circuit module DRV1, and a terminal for supplying the reference voltage signal VBS1 to the print head 23-1 out of the plurality of terminals provided to the connector CN2 electrically coupled to the ejection unit 20, and propagates the reference voltage signal VBS1. Further, the wiring line Wvb1 is also electrically coupled to the positive terminal of the capacitor 190-1. Further, the wiring line Wvb1 is located so as to overlap at least a part of the wiring line Wca1 and at least a part of the wiring line Wcb1 in a plan view of the base substrate B1 and when viewing the base substrate B1 along the X2 axis in a range of the wiring line Wvb1 from the positive terminal of the capacitor 190-1 to the terminal for supplying the reference voltage signal VBS1 provided to the connector CN2.

The wiring line Wvb2 is located at the −Y2 side of the wiring line Wvb1, and electrically couples a terminal for inputting the reference voltage signal VBS2 to the base substrate B1 out of the plurality of terminals provided to the connector CN3b-2 electrically coupled to the drive circuit module DRV2, and a terminal for supplying the reference voltage signal VBS2 to the print head 23-2 out of the plurality of terminals provided to the connector CN2 electrically coupled to the ejection unit 20, and propagates the reference voltage signal VBS2. Further, the wiring line Wvb2 is also electrically coupled to the positive terminal of the capacitor 190-2. Further, the wiring line Wvb2 is located so as to overlap at least a part of the wiring line Wca2 and at least a part of the wiring line Wcb2 in a plan view of the base substrate B1 and when viewing the base substrate B1 along the X2 axis in a range of the wiring line Wvb2 from the positive terminal of the capacitor 190-2 to the terminal for supplying the reference voltage signal VBS2 provided to the connector CN2.

The wiring line Wvb3 is located at the −Y2 side of the wiring line Wvb2, and electrically couples a terminal for inputting the reference voltage signal VBS3 to the base substrate B1 out of the plurality of terminals provided to the connector CN3b-3 electrically coupled to the drive circuit module DRV3, and a terminal for supplying the reference voltage signal VBS3 to the print head 23-3 out of the plurality of terminals provided to the connector CN2 electrically coupled to the ejection unit 20, and propagates the reference voltage signal VBS3. Further, the wiring line Wvb3 is also electrically coupled to the positive terminal of the capacitor 190-3. Further, the wiring line Wvb3 is located so as to overlap at least a part of the wiring line Wca3 and at least a part of the wiring line Wcb3 in a plan view of the base substrate B1 and when viewing the base substrate B1 along the X2 axis in a range of the wiring line Wvb3 from the positive terminal of the capacitor 190-3 to the terminal for supplying the reference voltage signal VBS3 provided to the connector CN2.

The wiring line Wcc1 is located at the +Y2 side of the wiring line Wvb1, and electrically couples a terminal for inputting the drive signal COMC1 to the base substrate B1 out of the plurality of terminals provided to the connector CN3b-1 electrically coupled to the drive circuit module DRV1, and a terminal for supplying the drive signal COMC1 to the print head 23-1 out of the plurality of terminals provided to the connector CN2 electrically coupled to the ejection unit 20, and propagates the drive signal COMC1. The wiring line Wcc1 is located along the wiring line Wvb1 through which the reference voltage signal VBS1 propagates.

The wiring line Wcc2 is located at the −Y2 side of the wiring line Wvb1 and at the +Y2 side of the wiring line Wvb2, and electrically couples a terminal for inputting the drive signal COMC2 to the base substrate B1 out of the plurality of terminals provided to the connector CN3b-2 electrically coupled to the drive circuit module DRV2, and a terminal for supplying the drive signal COMC2 to the print head 23-2 out of the plurality of terminals provided to the connector CN2 electrically coupled to the ejection unit 20, and propagates the drive signal COMC2. The wiring line Wcc2 is located along the wiring line Wvb2 through which the reference voltage signal VBS2 propagates.

The wiring line Wcc3 is located at the −Y2 side of the wiring line Wvb2 and at the +Y2 side of the wiring line Wvb3, and electrically couples a terminal for inputting the drive signal COMC3 to the base substrate B1 out of the plurality of terminals provided to the connector CN3b-3 electrically coupled to the drive circuit module DRV3, and a terminal for supplying the drive signal COMC3 to the print head 23-3 out of the plurality of terminals provided to the connector CN2 electrically coupled to the ejection unit 20, and propagates the drive signal COMC3. The wiring line Wcc3 is located along the wiring line Wvb3 through which the reference voltage signal VBS3 propagates.

The wiring line Wcc4 is located at the −Y2 side of the wiring line Wvb1 and at the +Y2 side of the wiring line Wcc2, and electrically couples a terminal for inputting the drive signal COMC4 to the base substrate B1 out of the plurality of terminals provided to the connector CN3b-4 electrically coupled to the drive circuit module DRV4, and a terminal for supplying the drive signal COMC4 to the print head 23-4 out of the plurality of terminals provided to the connector CN2 electrically coupled to the ejection unit 20, and propagates the drive signal COMC4. The wiring line Wcc4 is located along the wiring line Wvb1 through which the reference voltage signal VBS1 propagates.

The wiring line Wcc5 is located at the −Y2 side of the wiring line Wvb2 and at the +Y2 side of the wiring line Wcc3, and electrically couples a terminal for inputting the drive signal COMC5 to the base substrate B1 out of the plurality of terminals provided to the connector CN3b-5 electrically coupled to the drive circuit module DRV5, and a terminal for supplying the drive signal COMC5 to the print head 23-5 out of the plurality of terminals provided to the connector CN2 electrically coupled to the ejection unit 20, and propagates the drive signal COMC5. The wiring line Wcc5 is located along the wiring line Wvb2 through which the reference voltage signal VBS2 propagates.

The wiring line Wcc6 is located at the −Y2 side of the wiring line Wvb3, and electrically couples a terminal for inputting the drive signal COMC6 to the base substrate B1 out of the plurality of terminals provided to the connector CN3b-6 electrically coupled to the drive circuit module DRV6, and a terminal for supplying the drive signal COMC6 to the print head 23-6 out of the plurality of terminals provided to the connector CN2 electrically coupled to the ejection unit 20, and propagates the drive signal COMC6. The wiring line Wcc6 is located along the wiring line Wvb3 through which the reference voltage signal VBS3 propagates.

That is, the base substrate B1 includes the wiring line Wcc1 through which the drive signal COMC1 propagates, the wiring line Wcc2 through which the drive signal COMC2 propagates, the wiring line Wcc3 through which the drive signal COMC3 propagates, the wiring line Wcc4 through which the drive signal COMC4 propagates, the wiring line Wcc5 through which the drive signal COMC5 propagates, the wiring line Wcc6 through which the drive signal COMC6 propagates, the wiring line Wvb1 through which the reference voltage signal VBS1 propagates, the wiring line Wvb2 through which the reference voltage signal VBS2 propagates, and the wiring line Wvb3 through which the reference voltage signal VBS3 propagates formed in the internal wiring layer 820-(k+1), the wiring lines Wcc1 to Wcc6 and Wvb1 to Wvb3 are located in the order of the wiring line Wcc1, the wiring line Wvb1, the wiring line Wcc4, the wiring line Wcc2, the wiring line Wvb2, the wiring line Wcc5, the wiring line Wcc3, the wiring line Wvb3, and the wiring line Wcc6 from the +Y2 side toward the −Y2 side along the Y2 axis in the vicinity of the connector CN2 electrically coupled to the ejection unit 20. Further, in a plan view of the base substrate B1 and when viewing the base substrate B1 along the X2 axis, the wiring line Wvb1 is located so as to overlap at least a part of the wiring line Wca1 and the wiring line Wcb1, and the wiring line Wvb2 is located so as to overlap at least a part of the wiring line Wca2 and the wiring line Wcb2.

As shown in FIG. 26, wiring lines Wvb4 to Wvb6 through which the reference voltage signals VBS4 to VBS6 respectively propagate and wiring line Wvhv through which the voltage signal VHV propagates are formed in the surface wiring layer 812.

The wiring line Wvb4 electrically couples a terminal for inputting the reference voltage signal VBS4 to the base substrate B1 out of the plurality of terminals provided to the connector CN3b-4 electrically coupled to the drive circuit module DRV4, and a terminal for supplying the reference voltage signal VBS4 to the print head 23-4 out of the plurality of terminals provided to the connector CN2 electrically coupled to the ejection unit 20, and propagates the reference voltage signal VBS4. Further, the wiring line Wvb4 is also electrically coupled to the positive terminal of the capacitor 190-4.

The wiring line Wvb5 is located at the −Y2 side of the wiring line Wvb4, and electrically couples a terminal for inputting the reference voltage signal VBS5 to the base substrate B1 out of the plurality of terminals provided to the connector CN3b-5 electrically coupled to the drive circuit module DRV5, and a terminal for supplying the reference voltage signal VBS5 to the print head 23-5 out of the plurality of terminals provided to the connector CN2 electrically coupled to the ejection unit 20, and propagates the reference voltage signal VBS5. Further, the wiring line Wvb5 is also electrically coupled to the positive terminal of the capacitor 190-5.

The wiring line Wvb6 is located at the −Y2 side of the wiring line Wvb5, and electrically couples a terminal for inputting the reference voltage signal VBS6 to the base substrate B1 out of the plurality of terminals provided to the connector CN3b-6 electrically coupled to the drive circuit module DRV6, and a terminal for supplying the reference voltage signal VBS6 to the print head 23-6 out of the plurality of terminals provided to the connector CN2 electrically coupled to the ejection unit 20, and propagates the reference voltage signal VBS6.

One end of the wiring line Wvhv is electrically coupled to the coil 152a provided to the first step-down circuit 150a and the capacitor 153a. Thus, the wiring line Wvhv propagates the voltage signal VHV generated by the first step-down circuit 150a. Further, the wiring line Wvhv is electrically coupled to the positive electrodes of the capacitors 110-1 to 110-6, and is electrically coupled to the connectors CN3b-1 to CN3b-6. Thus, the voltage signal VHV propagating through the wiring line Wvhv is supplied to each of the drive circuit modules DRV1 to DRV6. Further, the wiring line Wvhv bypasses at the +Y2 side of the wiring line Wvb4 and is also electrically coupled to the connector CN2. Thus, the voltage signal VHV propagating through the wiring line Wvhv is also supplied to the ejection unit 20.

That is, the wiring line Wvb4 that propagates the reference voltage signal VBS4, the wiring line Wvb5 that propagates the reference voltage signal VBS5, the wiring line Wvb6 that propagates the reference voltage signal VBS6, and the wiring line Wvhv through which the voltage signal VHV propagates are formed in the surface wiring layer 812 of the base substrate B1.

As described above, among the capacitors 190-1 to 190-6 provided to the base substrate B1, the capacitors 190-1 to 190-3 are located farther from the connector CN2 electrically coupled to the ejection unit 20 compared to the capacitors 190-4 to 190-6. That is, the shortest distance between the connector CN2 and the capacitors 190-1 to 190-3 is longer than the shortest distance between the connector CN2 and the capacitors 190-4 to 190-6.

On this occasion, the wiring line Wvb1 that electrically couples the capacitor 190-1 located farther from the connector CN2 and the connector CN2 to each other to propagate the reference voltage signal VBS1 is provided to the internal wiring layer 820-(k+1) out of the plurality of internal wiring layers 820, the wiring line Wca1 through which the drive signal COMA1 input to the print head 23-1 supplied with the reference voltage signal VBS1 propagates is provided to the internal wiring layer 820-(k) adjacent to the internal wiring layer 820-(k+1) out of the plurality of internal wiring layers 820, the wiring line Wcb1 through which the drive signal COMB1 input to the print head 23-1 supplied with the reference voltage signal VBS1 propagates is provided to the internal wiring layer 820-(k+2) adjacent to the internal wiring layer 820-(k+1) out of the plurality of internal wiring layers 820, and the wiring line Wvb1, and the wiring line Wca1 and the wiring line Wcb1 at least partially overlap each other when viewing the base substrate B1 in the normal direction of the surface 801 of the base substrate B1 and along the X2 axis.

Similarly, the wiring line Wvb2 that electrically couples the capacitor 190-2 located farther from the connector CN2 and the connector CN2 to each other to propagate the reference voltage signal VBS2 is provided to the internal wiring layer 820-(k+1) out of the plurality of internal wiring layers 820, the wiring line Wca2 through which the drive signal COMA2 input to the print head 23-2 supplied with the reference voltage signal VBS2 propagates is provided to the internal wiring layer 820-(k) adjacent to the internal wiring layer 820-(k+1) out of the plurality of internal wiring layers 820, the wiring line Wcb2 through which the drive signal COMB2 input to the print head 23-2 supplied with the reference voltage signal VBS2 propagates is provided to the internal wiring layer 820-(k+2) adjacent to the internal wiring layer 820-(k+1) out of the plurality of internal wiring layers 820, and the wiring line Wvb2, and the wiring line Wca2 and the wiring line Wcb2 at least partially overlap each other when viewing the base substrate B1 in the normal direction of the surface 801 of the base substrate B1 and along the X2 axis.

Similarly, the wiring line Wvb2 that electrically couples the capacitor 190-3 located farther from the connector CN2 and the connector CN2 to each other to propagate the reference voltage signal VBS3 is provided to the internal wiring layer 820-(k+1) out of the plurality of internal wiring layers 820, the wiring line Wca3 through which the drive signal COMA3 input to the print head 23-3 supplied with the reference voltage signal VBS3 propagates is provided to the internal wiring layer 820-(k) adjacent to the internal wiring layer 820-(k+1) out of the plurality of internal wiring layers 820, the wiring line Wcb3 through which the drive signal COMB3 input to the print head 23-3 supplied with the reference voltage signal VBS3 propagates is provided to the internal wiring layer 820-(k+2) adjacent to the internal wiring layer 820-(k+1) out of the plurality of internal wiring layers 820, and the wiring line Wvb3, and the wiring line Wca3 and the wiring line Wcb3 at least partially overlap each other when viewing the base substrate B1 in the normal direction of the surface 801 of the base substrate B1 and along the X2 axis.

That is, the wiring lines Wvb1 to Wvb3 through which the reference voltage signals VBS1 to VBS3 to be output via the capacitors 190-1 to 190-3 located away from the connector CN2 respectively propagate are located adjacent to the wiring lines Wca1 to Wca3 through which the corresponding drive signals COMA1 to COMA3 respectively propagate and the wiring lines Wcb1 to Wcb3 through which the corresponding drive signals COMB1 to COMB3 respectively propagate.

On the other hand, the wiring line Wvb4 which electrically couples the capacitor 190-4 located in the vicinity of the connector CN2 and the connector CN2 to each other and which propagates the reference voltage signal VBS4 is provided to the surface wiring layer 812 formed on the surface 802 on which the capacitor 190-4 is disposed, the wiring line Wvb5 which electrically couples the capacitor 190-5 located in the vicinity of the connector CN2 and the connector CN2 to each other and which propagates the reference voltage signal VBS5 is provided to the surface wiring layer 812 formed on the surface 802 on which the capacitor 190-5 is disposed, and the wiring line Wvb6 which electrically couples the capacitor 190-6 located in the vicinity of the connector CN2 and the connector CN2 to each other and which propagates the reference voltage signal VBS6 is provided to the surface wiring layer 812 formed on the surface 802 on which the capacitor 190-6 is disposed.

Further, the wiring line Wvhv through which the voltage signal VHV propagates is disposed on the surface wiring layer 812 on which the wiring lines Wvb4 to Wvb6 which electrically couple the capacitors 190-4 to 190-6 located in the vicinity of the connector CN2 and the connector CN2 to each other, respectively, and which respectively propagate the reference voltage signals VBS4 to VBS6 are disposed.

Here, the base substrate B1 is an example of a wiring substrate, the amplifier circuit 550 and the demodulator circuit 560 are an example of an output circuit, and the integrated circuit 500 is an example of a drive control circuit. At least one of the drive signals COMA, COMB, and COMC is an example of a drive signal, and the drive signal VOUT obtained by selecting or deselecting the drive signals COMA, COMB, and COMC is also an example of the drive signal. Further, the voltage signal VDC is an example of a power supply voltage, the voltage signal VHV is an example of a first drive voltage, and the voltage signal VDD is an example of a second drive voltage.

### 4. Functions and Advantages

In the liquid ejection apparatus 1 according to the present embodiment configured as described above, the drive unit 10 provided to the head unit 5 includes the first step-down circuit 150a that steps down the voltage of the voltage signal VDC supplied from the outside to thereby output the voltage signal VHV, and the second step-down circuit 150b that steps down the voltage of the voltage signal VDC supplied from the outside to thereby output the voltage signal VDD. Further, the amplifier circuit 550 and the demodulation circuit 560 provided to the drive circuit 52 output the drive signal COM corresponding to the voltage signal VHV stepped down by the first step-down circuit 150a, and the integrated circuit 500 provided to the drive circuit 52 outputs the amplification control signals Hgd, Lgd in accordance with the voltage signal VDD stepped down by the second step-down circuit 150b to thereby control the drive of the amplifier circuit 550.

In such a head unit 5, since the voltage signal VHV is generated by stepping down the voltage signal VDC input from the outside in the drive unit 10 provided to the head unit 5, even when a fluctuation occurs in the voltage value of the voltage signal VDC in the propagation path of the voltage signal VDC input to the head unit 5, it is possible to improve the accuracy of the voltage signal VHV input to the amplifier circuit 550 and the demodulation circuit 560 provided to the drive circuit 52. Therefore, even when the propagation path of the voltage signal VDC input to the head unit 5 becomes longer due to an increase in size of the liquid ejection apparatus 1, and the voltage value of the voltage signal VDC input to the head unit 5 fluctuates, the possibility that the variation in the voltage value contributes to the signal waveforms of the drive signals COM output by the amplifier circuit 550 and the demodulation circuit 560 provided to the drive circuit 52 is reduced, and the accuracy of the signal waveforms of the drive signals COM output by the amplifier circuit 550 and the demodulation circuit 560 provided to the drive circuit 52 is improved. As a result, even when the liquid ejection apparatus 1 is increased in size, the possibility that the ejection accuracy of the ink from the ejection unit 20 that ejects the ink in accordance the drive signal VOUT based on the drive signals COM deteriorates is reduced.

Further, in the liquid ejection apparatus 1 according to the present embodiment, even when the liquid ejection apparatus 1 grows in size, the possibility that the ejection accuracy of the ink from the ejection unit 20 which ejects the ink in accordance with the drive signal VOUT based on the drive signals COM deteriorates is reduced, and therefore, even when the liquid ejection apparatus 1 is so large in size that the wiring length of the cable for coupling the control unit 2 and the head unit 5 to each other is 2 m or more, or even when the liquid ejection apparatus 1 is a line printer, the possibility that the ejection accuracy of the ink from the ejection unit 20 deteriorates is reduced.

Further, in the liquid ejection apparatus 1 according to the present embodiment, the integrated circuit 500 provided to the drive unit 10 controls whether to output the voltage signal VHV obtained by stepping down the voltage of the voltage signal VDC by the first step-down circuit 150a. That is, the supply of the voltage signal VHV to the head unit 5 is controlled independently of the control unit 2. Accordingly, even when the liquid ejection apparatus 1 includes the plurality of head units 5 due to an increase in size of the liquid ejection apparatus 1, the supply of the voltage signal VHV, the drive signals COM, and the reference voltage signal VBS to the ejection unit 20 can be controlled at an appropriate timing and in a short time.

Further, in the liquid ejection apparatus 1 according to the present embodiment, the first step-down circuit 150a has the soft start function of gradually increasing the voltage value of the voltage signal VHV to be output at the start of outputting the voltage signal VHV obtained by stepping down the voltage value of the voltage signal VDC. Thus, when the first step-down circuit 150a starts outputting the voltage signal VHV obtained by stepping down the voltage value of the voltage signal VDC, the possibility that the inrush current occurs is reduced. Therefore, even in the configuration in which the head unit 5 includes the first step-down circuit 150a that steps down the voltage value of the voltage signal VDC supplied from the outside to thereby output the voltage signal VHV, it is not necessary to provide a circuit as a measure against the inrush current to the head unit 5, and thus, a reduction in size of the head unit 5 can be achieved.

Further, in the head unit 5 of the liquid ejection apparatus 1 according to the present embodiment, the drive signal VOUT based on the drive signals COMA1, COMB1, COMC1 output by the drive circuits 52a1, 52b1, and 52cl is supplied to one end of the piezoelectric element 60 provided to the print head 23-1, and the reference voltage signal VBS1 outputted by the reference voltage signal output circuit 460 is supplied to the other end of the piezoelectric element 60 provided to the print head 23-1. In such a liquid ejection apparatus 1, the current flowing when the piezoelectric element 60 provided to the print head 23-1 is driven is output from the drive circuits 52a1, 52b1, and 52cl, passes through the piezoelectric element 60 and one end of the capacitor 190-1, and returns to the drive circuits 52a1, 52b1, and 52cl via the other end of the capacitor 190-1 supplied with the ground signal.

In the liquid ejection apparatus 1 according to the present embodiment, in the drive unit 10 including the drive circuits 52a1, 52b1, and 52cl and the capacitor 190-1, by disposing the capacitor 190-1 having one end supplied with the reference voltage signal VBS1 and the other end supplied with the ground signal so that the one end supplied with the reference voltage signal VBS1 is located at the connector CN2 side, and the other end supplied with the ground signal is located at the connector CN3b-1 side between the connector CN3b-1 to which the drive circuits 52a1, 52b1, and 52cl are coupled and the connector CN2 which is electrically coupled to the print head 23-1, it is possible to shorten the feedback path in which the current flowing when the piezoelectric element 60 provided to the print head 23-1 is driven is fed back to the drive circuits 52a1, 52b1, and 52cl from the other end of the capacitor 190-1 via the wiring pattern through which the ground signal propagates. This reduces the inductance component caused by the current flowing when the piezoelectric element 60 is driven. Therefore, the possibility that the distortion occurs in the waveforms of the drive signals COMA1, COMB1, and COMC1 for driving the piezoelectric element 60 due to the inductance component generated by the current flowing when the piezoelectric element 60 is driven is reduced. As a result, the waveform accuracy of the drive signal VOUT corresponding to the drive signals COMA1, COMB1, and COMC1 for driving the piezoelectric element 60 is improved.

On this occasion, by one end and the other end of the capacitor 190-1 being located along the Z2 axis connecting the side 821 and the side 822, it is possible to further shorten the feedback path in which the current flowing when the piezoelectric element 60 provided to the print head 23-1 is driven is fed back to the drive circuits 52a1, 52b1, and 52cl from the other end of the capacitor 190-1 through the wiring pattern through which the ground signal propagates. This further reduces the inductance component caused by the current flowing when the piezoelectric element 60 is driven, and further reduces the possibility that the distortion occurs in the signal waveforms of the drive signals COMA1, COMB1, and COMC1 for driving the piezoelectric element 60 due to the inductance component caused by the current flowing when the piezoelectric element 60 is driven. As a result, the waveform accuracy of the drive signal VOUT corresponding to the drive signals COMA1, COMB1, and COMC1 for driving the piezoelectric element 60 is further improved.

Further, as shown in the liquid ejection apparatus 1 according to the present embodiment, when the head unit 5 includes the print heads 23-2 to 23-6 in addition to the print head 23-1, by arranging the capacitors 190-2 to 190-6 such that one ends of the capacitors 190-2 to 190-6 to which the corresponding reference voltage signals VBS2 to VBS6 are respectively supplied are located closer to the connector CN2 electrically coupled to the print heads 23-2 to 23-6, and one ends of the capacitors 190-2 to 190-6 to which the ground signal is supplied are located closer to the corresponding connectors CN3b-2 to CN3b-6, it is possible to shorten the feedback paths through which the currents flowing when the piezoelectric elements 60 respectively provided to the print heads 23-2 to 23-6 are driven are fed back.

This reduces the inductance components caused by the currents flowing when the piezoelectric elements 60 respectively provided to the print heads 23-2 to 23-6 are driven. As a result, the possibility that the distortion occurs in the signal waveforms of the drive signals COMA2 to COMA6, COMB2 to COMB6, and COMC2 to COMC6 for driving the piezoelectric elements 60 respectively provided to the print heads 23-2 to 23-6 is also reduced.

Further, the head unit 5 provided to the liquid ejection apparatus 1 according to the present embodiment includes the print 23-1 head which includes the piezoelectric element 60 one end of which is supplied with the drive signal VOUT based on the drive signals COMA1, COMB1, and COMC1 and the other end of which is supplied with the reference voltage signal VBS1 constant in voltage value, and which ejects the ink in accordance with the drive of that piezoelectric element 60, the print head 23-4 which includes the piezoelectric element 60 one end of which is supplied with the drive signal VOUT based on the drive signals COMA4, COMB4, and COMC4 and the other end of which is supplied with the reference voltage signal VBS4 constant in voltage value, and which ejects the ink in accordance with the drive of that piezoelectric element 60, and the drive unit 10 which supplies the drive signals COMA1, COMB1, and COMC1 and the reference voltage signal VBS1 to the print head 23-1 and outputs the drive signals COMA4, COMB4, and COMC4, and the reference voltage signal VBS4 to the print head 23-4, the drive unit 10 includes the drive circuits 52a1, 52b1, and 52cl which output the drive signals COMA1, COMB1, and COMC1, the reference voltage signal output circuit 460 provided to the drive signal output circuit 50-1 which outputs the reference voltage signal VBS1, the capacitor 190-1 one end of which is supplied with the reference voltage signal VBS1 and the other end of which is supplied with the ground signal, the drive circuits 52a4, 52b4, and 52c4 which output the drive signals COMA4, COMB4, and COMC4, the reference voltage signal output circuit 460 provided to the drive signal output circuit 50-4 which outputs the reference voltage signal VBS4, the capacitor 190-4 one end of which is supplied with the reference voltage signal VBS4 and the other end of which is supplied with the ground signal, the connector CN2 to be electrically coupled to the print head 23-1 and the print head 23-4, the base substrate B1 to which the connector CN2 is provided, and through which the drive signals COMA1, COMB1, COMC1, COMA4, COMB4, and COMC4, and the reference voltage signals VBS1, VBS4 propagate.

In the base substrate B1 provided to such a head unit 5, the wiring line Wvb1 which electrically couples the capacitor 190-1 located at a distance from the connector CN2 and the connector CN2 to each other and through which the reference voltage signal VBS1 to be supplied to the print head 23-1 propagates is provided to the internal wiring layer 820-(k+1), the wiring line Wca1 through which the drive signal COMA1 to be supplied to the print head 23-1 propagates is provided to the internal wiring layer 820-k adjacent to the internal wiring layer 820-(k+1), and the wiring line Wcb1 through which the drive signal COMB1 to be supplied to the print head 23-1 propagates is provided to the internal wiring layer 820-(k+2) adjacent to the internal wiring layer 820-(k+1). Further, the wiring line Wvb1, the wiring line Wca1, and the wiring line Wcb1 are located so as to at least partially overlap each other when viewed from the normal direction of the surface 801 of the base substrate B1.

As described above, the current flowing when the piezoelectric element 60 provided to the print head 23-1 is driven is output from the drive circuits 52a1, 52b1, and 52cl, passes through the piezoelectric element 60 and the one end of the capacitor 190-1, and is fed back to the drive circuits 52a1, 52b1, and 52cl via the other end of the capacitor 190-1 supplied with the ground signal. On this occasion, the direction of the current flowing through the wiring line Wvb1 is opposite to the direction of the current flowing through the wiring line Wca1 and the wiring line Wcb1. Therefore, the magnetic fields generated by the current flowing when the piezoelectric elements 60 provided to the print head 23-1 is driven are canceled out each other. Accordingly, the influence of the inductance component on the drive signals COMA1, COMB1 supplied to the print head 23-1 is reduced. As a result, the possibility that the distortion occurs in the signal waveforms of the drive signals COMA1, COMB1 supplied to the print head 23-1 is reduced.

On the other hand, the wiring line Wvb4 which electrically couples the capacitor 190-4 located in the vicinity of the connector CN2 and the connector CN2 to each other, and through which the reference voltage signal VBS4 supplied to the print head 23-4 propagates is disposed in the surface wiring layer 812 formed on the surface 802 where the capacitor 190-4 is disposed. Thus, the number of vias provided on the propagation path through which the reference voltage signal VBS4 propagates can be reduced. In the vicinity of the connector CN2, wiring lines of signals propagated via the connector CN2 are concentrated. When vias are supposedly provided in the vicinity of the connector CN2 where such wiring lines are concentrated, there arises a necessity of laying around the wiring pattern through which the signals to be input to the connector CN2 propagate, and as a result, there is a possibility that the reduction in size of the base substrate B1 is hindered, and at the same time, the arrangement of the wiring pattern becomes complicated, and as a result, a possibility that noise or the like is superimposed on the signals to be input to the connecter CN2 increases. That is, in the head unit 5 in the present embodiment, by providing the wiring line Wvb4 which electrically couples the capacitor 190-4 located in the vicinity of the connector CN2 to the connector CN2, and through which the reference voltage signal VBS4 supplied to the print head 23-4 propagates to the surface wiring layer 812 formed on the surface 802 on which the capacitor 190-4 is disposed, the number of vias provided to the propagation path through which the reference voltage signal VBS4 propagates is reduced, and as a result, the reduction in size of the base substrate B1 can be achieved, and the possibility that the noise or the like is superimposed on the signals to be input to the connector CN2 is reduced.

As described above, in the head unit 5 in the present embodiment, by disposing the wiring line Wvb1 which electrically couples the capacitor 190-1 located at a distance from the connector CN2 and the connector CN2 to each other, and through which the reference voltage signal VBS1 to be supplied to the print head 23-1 propagates in the wiring layer adjacent to the wiring layer of the wiring line Wca1 through which the drive signal COMA1 to be supplied to the print head 23-1 propagates and the wiring layer of the wiring line Wcb1 through which the drive signal COMB1 propagates so as to at least partially overlap the wiring lines Wca1, Wcb1 when views from the normal direction of the surface 801 of the base substrate B1, and by disposing the wiring line Wvb4 which electrically couples the capacitor located in the vicinity of the connector CN2 and the connector CN2 to each other, and through which the reference voltage signal VBS4 to be supplied to the print head 23-4 propagates in the same wiring layer as the wiring layer on which the capacitor 190-4 is disposed, it is possible to realize both the reduction in size of the base substrate B1 and the improvement of the accuracy of the signals.

### 5. Modified Examples

In the liquid ejection apparatus 1 and the head unit 5 according to the present embodiment described above, the drive unit 10 may include a capacitor 190-1a coupled in parallel to the capacitor 190-1, a capacitor 190-2a coupled in parallel to the capacitor 190-2, a capacitor 190-3a coupled in parallel to the capacitor 190-3, a capacitor 190-4a coupled in parallel to the capacitor 190-4, a capacitor 190-5a coupled in parallel to the capacitor 190-5, and a capacitor 190-6a coupled in parallel to the capacitor 190-6.

That is, the drive unit 10 may include the capacitor 190-1a having one end as a positive terminal supplied with the reference voltage signal VBS1 and the other end as a negative terminal supplied with the ground signal, the capacitor 190-2a having one end as a positive terminal supplied with the reference voltage signal VBS2 and the other end as a negative terminal supplied with the ground signal, the capacitor 190-3a having one end as a positive terminal supplied with the reference voltage signal VBS3 and the other end as a negative terminal supplied with the ground signal, the capacitor 190-4a having one end as a positive terminal supplied with the reference voltage signal VBS4 and the other end as a negative terminal supplied with the ground signal, the capacitor 190-5a having one end as a positive terminal supplied with the reference voltage signal VBS5 and the other end as a negative terminal supplied with the ground signal, and the capacitor 190-6a having one end as a positive terminal supplied with the reference voltage signal VBS6 and the other end as a negative terminal supplied with the ground signal.

In this case, when the base substrate B1 is viewed along the X2 axis, the capacitor 190-1a coupled in parallel to the capacitor 190-1 is disposed on the base substrate B1 so that the capacitor 190-1a is located between the connector CN2 and the connector CN3b-1 and between the connector CN2 and the electrode where the connector CN3b-1 is electrically coupled to the base substrate B1, the shortest distance between the connector CN2 and one end of the capacitor 190-la as a positive terminal supplied with the reference voltage signal VBS1 is shorter than the shortest distance between the connector CN2 and the other end of the capacitor 190-1a as a negative terminal supplied with the ground signal, and the shortest distance between the connector CN3b-1 and the one end of the capacitor 190-la as the positive terminal supplied with the reference voltage signal VBS1 is longer than the shortest distance between the connector CN3b-1 and the other end of the capacitor 190-la as the negative terminal supplied with the ground signal.

Similarly, when the base substrate B1 is viewed along the X2 axis, the capacitor 190-2a coupled in parallel to the capacitor 190-2 is disposed on the base substrate B1 so that the capacitor 190-2a is located between the connector CN2 and the connector CN3b-2 and between the connector CN2 and the electrode where the connector CN3b-2 is electrically coupled to the base substrate B1, the shortest distance between the connector CN2 and one end of the capacitor 190-2a as a positive terminal supplied with the reference voltage signal VBS2 is shorter than the shortest distance between the connector CN2 and the other end of the capacitor 190-2a as a negative terminal supplied with the ground signal, and the shortest distance between the connector CN3b-2 and the one end of the capacitor 190-2a as the positive terminal supplied with the reference voltage signal VBS2 is longer than the shortest distance between the connector CN3b-2 and the other end of the capacitor 190-2a as the negative terminal supplied with the ground signal.

Similarly, when the base substrate B1 is viewed along the X2 axis, the capacitor 190-3a coupled in parallel to the capacitor 190-3 is disposed on the base substrate B1 so that the capacitor 190-3a is located between the connector CN2 and the connector CN3b-3 and between the connector CN2 and the electrode where the connector CN3b-3 is electrically coupled to the base substrate B1, the shortest distance between the connector CN2 and one end of the capacitor 190-3a as a positive terminal supplied with the reference voltage signal VBS3 is shorter than the shortest distance between the connector CN2 and the other end of the capacitor 190-3a as a negative terminal supplied with the ground signal, and the shortest distance between the connector CN3b-3 and the one end of the capacitor 190-3a as the positive terminal supplied with the reference voltage signal VBS3 is longer than the shortest distance between the connector CN3b-3 and the other end of the capacitor 190-3a as the negative terminal supplied with the ground signal.

Similarly, when the base substrate B1 is viewed along the X2 axis, the capacitor 190-4a coupled in parallel to the capacitor 190-4 is disposed on the base substrate B1 so that the capacitor 190-4a is located between the connector CN2 and the connector CN3b-4 and between the connector CN2 and the electrode where the connector CN3b-4 is electrically coupled to the base substrate B1, the shortest distance between the connector CN2 and one end of the capacitor 190-4a as a positive terminal supplied with the reference voltage signal VBS4 is shorter than the shortest distance between the connector CN2 and the other end of the capacitor 190-4a as a negative terminal supplied with the ground signal, and the shortest distance between the connector CN3b-4 and the one end of the capacitor 190-4a as the positive terminal supplied with the reference voltage signal VBS4 is longer than the shortest distance between the connector CN3b-4 and the other end of the capacitor 190-4a as the negative terminal supplied with the ground signal.

Similarly, the capacitor 190-5a coupled in parallel to the capacitor 190-5 is disposed on the base substrate B1 so that the capacitor 190-5a is located between the connector CN2 and the connector CN3b-5 and between the connector CN2 and the electrode where the connector CN3b-5 is electrically coupled to the base substrate B1, the shortest distance between the connector CN2 and one end of the capacitor 190-5a as a positive terminal supplied with the reference voltage signal VBS5 is shorter than the shortest distance between the connector CN2 and the other end of the capacitor 190-5a as a negative terminal supplied with the ground signal, and the shortest distance between the connector CN3b-5 and the one end of the capacitor 190-5a as the positive terminal supplied with the reference voltage signal VBS5 is longer than the shortest distance between the connector CN3b-5 and the other end of the capacitor 190-5a as the negative terminal supplied with the ground signal.

Similarly, the capacitor 190-6a coupled in parallel to the capacitor 190-6 is disposed on the base substrate B1 so that the capacitor 190-6a is located between the connector CN2 and the connector CN3b-6 and between the connector CN2 and the electrode where the connector CN3b-6 is electrically coupled to the base substrate B1, the shortest distance between the connector CN2 and one end of the capacitor 190-6a as a positive terminal supplied with the reference voltage signal VBS6 is shorter than the shortest distance between the connector CN2 and the other end of the capacitor 190-6a as a negative terminal supplied with the ground signal, and the shortest distance between the connector CN3b-6 and the one end of the capacitor 190-6a as the positive terminal supplied with the reference voltage signal VBS6 is longer than the shortest distance between the connector CN3b-6 and the other end of the capacitor 190-6a as the negative terminal supplied with the ground signal.

The liquid ejection apparatus 1 and the head unit 5 configured as described above can achieve substantially the same functions and advantages as those of the embodiment described above.

Further, in the liquid ejection apparatus 1 and the head unit 5 according to the present embodiment described above, it is assumed that the drive circuit modules DRV1 to DRV6 generate the drive signals COMA1 to COMA6, COMB1 to COMB6, and COMC1 to COMC6, and the reference voltage signals VBS1 to VBS6, and then supply these signals to the base substrate B1 via the BtoB connector, but the drive signal output circuits 50-1 to 50-6 which generates and then outputs the drive signals COMA1 to COMA6, COMB1 to COMB6, and COMC1 to COMC6, and the reference voltage signals VBS1 to VBS6 may be mounted on the surface 801 of the base substrate B1.

Even in this case, substantially the same functions and advantages as those of the embodiment described above can be achieved.

Although the embodiment and the modified examples are hereinabove described, the present disclosure is not limited to these embodiment and modified examples and can be implemented in various aspects without departing from the gist thereof. For example, the embodiment and the modified examples described above can appropriately be combined.

The present disclosure includes substantially the same configurations (e.g., configurations having the same functions, methods, and results, and configurations having the same purposes and advantages) as the configurations described in the embodiment. Further, the present disclosure includes configurations obtained by replacing non-essential portions of the configurations described in the embodiment. Furthermore, the present disclosure includes configurations that exert the same functions and advantages or configurations that can achieve the same objects as those of the configurations described in the embodiment. Further, the present disclosure includes configurations obtained by adding a known technique to the configurations described in the embodiment.

The following configurations are derived from the embodiment described above.

An aspect of a head unit includes:
an ejection unit configured to eject a liquid in accordance with a drive signal; and
a drive unit supplied with a power supply voltage from outside and configured to output the drive signal, wherein the drive unit includes
a first step-down circuit configured to step down the power supply voltage to output a first drive voltage,
a second step-down circuit configured to step down the power supply voltage to output a second drive voltage,
an output circuit supplied with the first drive voltage and configured to output the drive signal according to the first drive voltage, and
a drive control circuit supplied with the second drive voltage and configured to control drive of the output circuit in accordance with the second drive voltage.

In this head unit, since the drive unit includes the first step-down circuit that steps down the power supply voltage supplied from the outside to output the first drive voltage, the voltage value of the first drive voltage is stabilized even when the voltage value of the power supply voltage supplied to the drive unit fluctuates. This reduces the possibility that the fluctuation of the voltage value of the power supply voltage makes a contribution to the signal waveform of the drive signal output by the output circuit in accordance with the first drive voltage, and thus improves the accuracy of the signal waveform of the drive signal. As a result, the ejection accuracy of the liquid from the ejection unit that ejects the liquid in accordance with the drive signal is improved. That is, even when the voltage value of the power supply voltage supplied to the head unit fluctuates due to an increase in size of an apparatus in which the head unit is used, a possibility that the ejection accuracy of the liquid deteriorates is reduced.

In one aspect of the head unit, the drive unit may be supplied with the power supply voltage via a cable.

In one aspect of the head unit, a length of the cable may be equal to or longer than 2 m.

In this head unit, since the possibility that the ejection accuracy of the liquid deteriorates is reduced even when the voltage value of the power supply voltage supplied to the head unit fluctuates due to an increase in size of the apparatus in which the head unit is used, the possibility accuracy of the liquid deteriorates is reduced even when the length of the cable which supplies the head unit with the power supply voltage is equal to or longer than 2 m.

In one aspect of the head unit,
the drive control circuit may control whether to output the first drive voltage from the first step-down circuit.

In one aspect of the head unit,
the first step-down circuit may have a soft start function of gradually increasing a voltage value of the first drive voltage when starting to output the first drive voltage.

In this head unit, it is not necessary to individually provide a circuit as a measure against an inrush current that limits a current value of the inrush current that may be generated due to the supply of the first drive voltage, and thus, the reduction in size of the drive unit can be realized.

In one aspect of the head unit,
the drive unit may include a wiring substrate provided with the first step-down circuit, and
the wiring substrate may be located between the first step-down circuit and the output circuit.

According to this head unit, the reduction in size of the head unit can be realized.

An aspect of a liquid ejection apparatus includes:
a conveyance unit configured to convey a medium;
an ejection unit configured to eject a liquid to the medium in accordance with a drive signal; and
a drive unit supplied with a power supply voltage generated from a commercial AC voltage signal and configured to output the drive signal, wherein
the drive unit includes
a first step-down circuit configured to step down the power supply voltage to output a first drive voltage,
a second step-down circuit configured to step down the power supply voltage to output a second drive voltage,
an output circuit supplied with the first drive voltage and configured to output the drive signal according to the first drive voltage, and
a drive control circuit supplied with the second drive voltage and configured to control drive of the output circuit in accordance with the second drive voltage.

In this liquid ejection apparatus, since the drive unit includes the first step-down circuit that steps down the power supply voltage to output the first drive voltage, the voltage value of the first drive voltage is stabilized even when the voltage value of the power supply voltage supplied to the drive unit fluctuates. This reduces the possibility that the fluctuation of the voltage value of the power supply voltage makes a contribution to the signal waveform of the drive signal output by the output circuit in accordance with the first drive voltage, and thus improves the accuracy of the signal waveform of the drive signal. As a result, the ejection accuracy of the liquid from the ejection unit that ejects the liquid in accordance with the drive signal is improved. That is, even when the voltage value of the power supply voltage supplied to the head unit fluctuates due to an increase in size of the liquid ejection apparatus, a possibility that the ejection accuracy of the liquid deteriorates is reduced.

In one aspect of the liquid ejection apparatus, the drive unit may be supplied with the power supply voltage via a cable.

In one aspect of the liquid ejection apparatus, a length of the cable may be equal to or longer than 2 m.

In this liquid ejection apparatus, since the possibility that the ejection accuracy of the liquid deteriorates is reduced even when the voltage value of the power supply voltage supplied to the drive unit fluctuates due to an increase in size of the liquid ejection apparatus, the possibility that the ejection accuracy of the liquid deteriorates is reduced even when the length of the cable which supplies the drive unit with the power supply voltage is equal to or longer than 2 m.

In one aspect of the liquid ejection apparatus, the drive control circuit may control whether to output the first drive voltage from the first step-down circuit.

In one aspect of the liquid ejection apparatus, the first step-down circuit may have a soft start function of gradually increasing a voltage value of the first drive voltage when starting to output the first drive voltage.

In this liquid ejection apparatus, it is not necessary to individually provide a circuit as a measure against an inrush current that limits a current value of the inrush current that may be generated due to the supply of the first drive voltage, and thus, the reduction in size of the drive unit can be realized.

In one aspect of the liquid ejection apparatus,
the drive unit may include a wiring substrate provided with the first step-down circuit, and
the wiring substrate may be located between the first step-down circuit and the output circuit.

In this liquid ejection apparatus, the reduction in size of the drive unit can be realized.

An aspect of the liquid ejection apparatus may be a line printer.

What is claimed is:

1. A head unit comprising:
an ejection unit configured to eject a liquid in accordance with a drive signal; and
a drive unit supplied with a power supply voltage from outside and configured to output the drive signal, wherein
the drive unit includes
a first step-down circuit configured to step down the power supply voltage to output a first drive voltage,
a second step-down circuit configured to step down the power supply voltage to output a second drive voltage,
an output circuit supplied with the first drive voltage and configured to output the drive signal according to the first drive voltage, and
a drive control circuit supplied with the second drive voltage and configured to control drive of the output circuit in accordance with the second drive voltage.

2. The head unit according to claim 1, wherein
the drive unit is supplied with the power supply voltage via a cable.

3. The head unit according to claim 2, wherein
a length of the cable is equal to or longer than 2 m.

4. The head unit according to claim 1, wherein
the drive control circuit controls whether to output the first drive voltage from the first step-down circuit.

5. The head unit according to claim 4, wherein
the first step-down circuit has a soft start function of gradually increasing a voltage value of the first drive voltage when starting to output the first drive voltage.

6. The head unit according to claim 1, wherein
the drive unit includes a wiring substrate provided with the first step-down circuit, and
the wiring substrate is located between the first step-down circuit and the output circuit.

7. A liquid ejection apparatus comprising:
a conveyance unit configured to convey a medium;
an ejection unit configured to eject a liquid to the medium in accordance with a drive signal; and
a drive unit supplied with a power supply voltage generated from a commercial AC voltage signal and configured to output the drive signal, wherein
the drive unit includes
a first step-down circuit configured to step down the power supply voltage to output a first drive voltage,
a second step-down circuit configured to step down the power supply voltage to output a second drive voltage,
an output circuit supplied with the first drive voltage and configured to output the drive signal according to the first drive voltage, and
a drive control circuit supplied with the second drive voltage and configured to control drive of the output circuit in accordance with the second drive voltage.

8. The liquid ejection apparatus according to claim 7, wherein
the drive unit is supplied with the power supply voltage via a cable.

9. The liquid ejection apparatus according to claim 8, wherein
a length of the cable is equal to or longer than 2 m.

10. The liquid ejection apparatus according to claim 7, wherein
the drive control circuit controls whether to output the first drive voltage from the first step-down circuit.

11. The liquid ejection apparatus according to claim 10, wherein
the first step-down circuit has a soft start function of gradually increasing a voltage value of the first drive voltage when starting to output the first drive voltage.

12. The liquid ejection apparatus according to claim 7, wherein
the drive unit includes a wiring substrate provided with the first step-down circuit, and
the wiring substrate is located between the first step-down circuit and the output circuit.

13. The liquid ejection apparatus according to claim 7, wherein
the liquid ejection apparatus is a line printer.
